(19) United States
(12) Patent Application Publication
(10) Pub. No.: US 2026/0032236 A1
(43) Pub. Date: Jan. 29, 2026

(54) ENCODING METHOD, DECODING METHOD, ENCODER, DECODER, BITSTREAM AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/345,967

(22) Filed: Sep. 30, 2025

Related U.S. Application Data
(63) Continuation of application No. PCT/CN2023/087038, filed on Apr. 7, 2023.

(51) Int. Cl. H04N 19/105; H04N 19/169; H04N 19/172; H04N 19/96

(52) U.S. Cl. CPC H04N 19/105; H04N 19/172; H04N 19/1883; H04N 19/96

(57) ABSTRACT

Provided are an encoding method and a decoding method. Regarding a node to be processed in a LOD M in a current frame, a codec can determine a reference point from a prediction point set of a reference frame for the current frame according to first Morton code information corresponding to the node to be processed, M being an integer greater than 1, and an index of a point in the prediction point set of the reference frame being determined based on Morton code information of the point; determine a search range based on second Morton code information corresponding to the reference point, and determine a nearest neighbor node corresponding to the node to be processed according to the search range; and determine a predicted attribute value corresponding to the node to be processed on the basis of a reconstruction value of the nearest neighbor node.

### CROSS-REFERENCE TO RELATED APPLICATION

This application is a continuation application of International Patent Application No. PCT/CN2023/087038 filed on Apr. 7, 2023, the entire contents of which are incorporated herein by reference.

### TECHNICAL FIELD

Embodiments of the present disclosure relate to the technical field of point cloud compression, and more particularly to, encoding and decoding methods, an encoder, a decoder, a bitstream and a storage medium.

### BACKGROUND

In a Geometry-based Point Cloud Compression (G-PCC) codec framework or a Video-based Point Cloud Compression (V-PCC) codec framework provided by the Moving Picture Experts Group (MPEG), geometric information and attribute information of a point cloud are encoded separately. When an inter prediction is performed on the attribute information, a nearest-neighbor search may be performed using a Morton code, and the Morton code corresponding to each point in the point cloud may be obtained from geometric coordinates of the point.

However, in the process of obtaining the nearest neighbor points using a block-based fast search algorithm, the prediction effect for the attribute information is often affected because the optimal nearest neighbor point is unable to be accurately found, thereby reducing the codec efficiency and performance.

### SUMMARY

Embodiments of the present disclosure provide encoding and decoding methods, an encoder, a decoder, a bitstream and a storage medium, which can improve prediction effect for attribute information and improve the codec efficiency and performance.

The technical solution of the embodiments of the present disclosure may be implemented as follows.

In a first aspect, an embodiment of the present disclosure provides a decoding method applied to a decoder. The method includes following operations.

For a node to be processed in an M-th Level of Detail (LOD) level (LOD M) of a current frame, a reference point is determined from a prediction point set of a reference frame for the current frame according to first Morton code information corresponding to the node to be processed, where M is an integer greater than 1, and an index of a point in the prediction point set of the reference frame is determined based on Morton code information of the point.

A search range is determined based on second Morton code information corresponding to the reference point, and a nearest neighbor node corresponding to the node to be processed is determined according to the search range.

A predicted attribute value corresponding to the node to be processed is determined based on a reconstructed value of the nearest neighbor node.

In a second aspect, an embodiment of the present disclosure provides an encoding method applied to an encoder. The method includes following operations.

For a node to be processed in a LOD M of a current frame, a reference point is determined from a prediction set of a reference frame for the current frame according to first Morton code information corresponding to the node to be processed, where M is an integer greater than 1, and an index of a point in the prediction point set of the reference frame is determined based on Morton code information of the point.

A search range is determined based on second Morton code information corresponding to the reference point, and a nearest neighbor node corresponding to the node to be processed is determined according to the search range.

A predicted attribute value corresponding to the node to be processed is determined based on a reconstructed value of the nearest neighbor node.

In a third aspect, an embodiment of the present disclosure provides an encoder including a first determination unit.

The first determination unit is configured to: for a node to be processed in a LOD M of a current frame, determine a reference point from a prediction point set of a reference frame for the current frame according to first Morton code information corresponding to the node to be processed, where M is an integer greater than 1, and an index of a point in the prediction point set of the reference frame is determined based on Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node.

In a fourth aspect, an embodiment of the present disclosure provides an encoder including a first memory and a first processor.

The first memory is configured to store a computer program executable on the first processor.

The first processor is configured to, when executing the computer program, perform the method of the second aspect.

In a fifth aspect, an embodiment of the present disclosure provides a decoder including a second determination unit.

The second determination unit is configured to: for a node to be processed in an M-th LOD level of a current frame, determine a reference point from a prediction point set of a reference frame for the current frame according to first Morton code information corresponding to the node to be processed, where M is an integer greater than 1, and an index of a point in the prediction point set of the reference frame is determined based on Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node.

In a sixth aspect, an embodiment of the present disclosure provides a decoder including a second memory and a second processor.

The second memory is configured to store a computer program executable on the second processor.

The second processor is configured to, when executing the computer program, perform the method of the first aspect.

In a seventh aspect, an embodiment of the present disclosure provides a bitstream generated through bit encoding according to information to be encoded, the information to be encoded at least including a prediction residual.

In an eighth aspect, an embodiment of the present disclosure provides a computer storage medium having stored a computer program that, when executed, implements the method of the first aspect or the method of the second aspect.

The embodiments of the present disclosure provide the encoding and decoding methods, the encoder, the decoder, the bitstream and the storage medium. For a node to be processed in the M-th LOD level (LOD M) of a current frame, the encoder and the decoder may determine a reference point from a prediction point set of a reference frame for the current frame according to first Morton code information corresponding to the node to be processed, where M is the integer greater than 1, and an index of a point in the prediction point set of the reference frame is determined based on the Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node. As can be seen that, in the embodiments of the present disclosure, each of the encoder and the decoder needs to determine the reference point from the prediction point set of the reference frame in the process of performing the inter prediction on the attribute information, the index of each point in the prediction point set of the reference frame is determined based on the Morton code information of the point, i.e., the index of the point in the prediction point set of the reference frame is the Morton code of the point, so that the corresponding reference point may be searched by using the Morton code, thereby ensuring that the nearest neighbor node is obtained using the Morton code in the subsequent nearest-neighbor search process based on the reference point. That is to say, in the embodiments of the present disclosure, it is possible to ensure that the optimal nearest neighbor point can be accurately found by ensuring that the index of each point in the prediction point set of the reference frame is the Morton code of the point, thereby improving the prediction effect for the attribute information and improving the codec efficiency and performance.

### BRIEF DESCRIPTION OF THE DRAWINGS

FIG. 1A is a schematic diagram of a Three-Dimensional (3D) point cloud picture according to an embodiment of the present disclosure.

FIG. 1B is a schematic diagram of a partial enlarged view of the three-dimensional point cloud picture according to an embodiment of the present disclosure.

FIG. 2A is a schematic diagram of a point cloud picture at different viewing angles according to an embodiment of the present disclosure.

FIG. 2B is a schematic diagram of a data storage format corresponding to FIG. 2A according to an embodiment of the present disclosure.

FIG. 3 is a schematic diagram of a network architecture of point cloud codec according to an embodiment of the present disclosure.

FIG. 4A is a schematic diagram of a composition framework of a G-PCC encoder according to an embodiment of the present disclosure.

FIG. 4B is a schematic diagram of a composition framework of a G-PCC decoder according to an embodiment of the present disclosure.

FIG. 5A is a schematic diagram of a lower plane position in a Z-axis direction according to an embodiment of the present disclosure.

FIG. 5B is a schematic diagram of an upper plane position in a Z-axis direction according to an embodiment of the present disclosure.

FIG. 6 is a schematic diagram of an encoding order of nodes according to an embodiment of the present disclosure.

FIG. 7A is a first schematic diagram of planar mode information according to an embodiment of the present disclosure.

FIG. 7B is a second schematic diagram of planar mode information according to an embodiment of the present disclosure.

FIG. 8 is a schematic diagram of sibling nodes of a current node according to an embodiment of the present disclosure.

FIG. 9 is a schematic diagram of intersection between a lidar and nodes according to an embodiment of the present disclosure.

FIG. 10 is a schematic diagram of neighborhood nodes at a same partitioning depth and having same coordinates as a current node.

FIG. 11 is a schematic diagram of a current node being located at a lower plane position of a parent node.

FIG. 12 is a schematic diagram of a current node being located at an upper plane position of a parent node.

FIG. 13 is a schematic diagram of predictive encoding of plane position information of a lidar point cloud.

FIG. 14 provides a schematic diagram of inferred direct encoding mode encoding.

FIG. 15 is a schematic diagram of coordinate transform of a point cloud obtained by a rotating lidar.

FIG. 16 is a schematic diagram of predictive encoding.

FIG. 17 is a first schematic diagram of angle prediction based on a horizontal azimuthal angle.

FIG. 18 is a second schematic diagram of angle prediction based on a horizontal azimuthal angle.

FIG. 19 is a schematic diagram of predictive encoding on X axis or Y axis;

FIG. 20 is a schematic diagram of geometric information reconstruction in a sub-block.

FIG. 21 is a schematic diagram of a distance-based LOD construction.

FIG. 22 is a visualization result of a LOD.

FIG. 23 is a flowchart of G-PCC attribute prediction.

FIG. 24 is a schematic diagram of LOD partitioning.

FIG. 25 is a first schematic diagram of inter-level nearest-neighbor search.

FIG. 26 is a second schematic diagram of inter-level nearest-neighbor search.

FIG. 27 is a first schematic diagram of a spatial relationship.

FIG. 28 is a second schematic diagram of a spatial relationship.

FIG. 29 is a first schematic diagram of a fast search algorithm.

FIG. 30 is a schematic diagram of attribute intra-level nearest-neighbor search.

FIG. 31 is a second schematic diagram of a fast search algorithm.

FIG. 32 is a third schematic diagram of a fast search algorithm.

FIG. 33 is a fourth schematic diagram of a fast search algorithm.

FIG. 34 is a flowchart of lifting transform.

FIG. 35 is a second schematic diagram of RAHT transform along three directions x, y and z.

FIG. 36 is a schematic diagram of RAHT transform.

FIG. 37 is a schematic diagram of RAHT transform.

FIG. 38 is a schematic diagram of inverse RAHT transform.

FIG. 39 is a flowchart of a decoding method according to an embodiment of the present disclosure.

FIG. 40 is a schematic diagram of a search region according to an embodiment of the present disclosure.

FIG. 41 is a flowchart of an encoding method according to an embodiment of the present disclosure.

FIG. 42 is a first schematic diagram of a composition structure of an encoder.

FIG. 43 is a second schematic diagram of a composition structure of an encoder.

FIG. 44 is a first schematic diagram of a composition structure of a decoder.

FIG. 45 is a second schematic diagram of a composition structure of a decoder.

### DETAILED DESCRIPTION

In order to enable a more detailed understanding of the features and technical contents of the embodiments of the present disclosure, implementations of the embodiments of the present disclosure will be described in detail below in conjunction with the accompanying drawings, which are provided for illustration only and are not intended to limit the embodiments of the present disclosure.

Unless otherwise defined, all technical and scientific terms used herein have the same meaning as commonly understood by those skilled in the technical field of the present disclosure. The terms used herein is only for the purpose of describing the present disclosure, and is not intended to limit the present disclosure.

In the following description, “some embodiments” describe a subset of all possible embodiments, but it is to be understood that “some embodiments” may be the same subset or different subsets of all possible embodiments, and may be composited with each other without conflict.

It is to be noted that the term “first\ second\ third” involved in embodiments of the present disclosure is used for distinguishing similar objects and not representing a specific sequence or sequential order. It is to be understood that the term “first\ second\ third” may be interchangeable under an appropriate circumstance, so that the embodiments of the present disclosure described herein are, for example, capable of being implemented in a sequence other than those illustrated or described herein.

A point cloud is a three-dimensional representation of a surface of an object. The point cloud (data) on the surface of the object may be acquired through acquisition devices, such as, a photoelectric radar, a lidar, a laser scanner, multi-view camera, or the like.

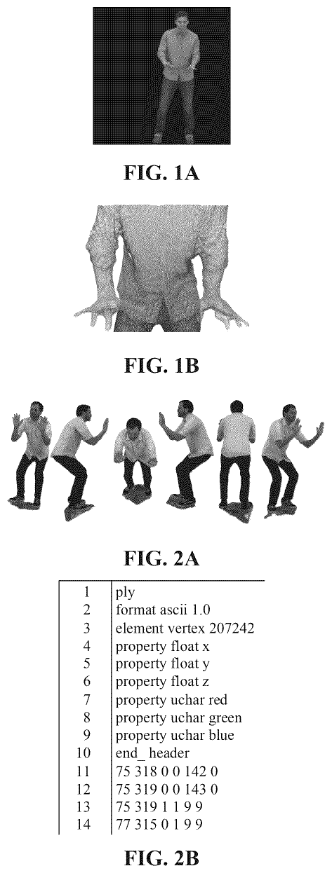

A point cloud is a set of discrete points irregularly distributed in the space and expressing the spatial structure and surface attributes of a three-dimensional object or scene. FIG. 1A shows a three-dimensional point cloud picture and FIG. 1B shows a partial enlarged view of the three-dimensional point cloud picture. As can be seen that the surface of the point cloud is composed of densely distributed points.

For a Two-Dimensional (2D) picture, each pixel has information presentation and pixels are regularly distributed, so it is not necessary to additionally record position information of each pixel. However, the distribution of points in a point cloud in three-dimensional space is random and irregular, so it is necessary to record a position of each point in the space, so as to completely express the point cloud. Similar to a two-dimensional picture, in an acquisition process, each position has corresponding attribute information that usually is a RGB color value reflecting a color of an object. For a point cloud, in addition to the color information, the attribute information corresponding to each point commonly includes a reflectance value that reflects a surface material of the object. Therefore, point cloud data usually includes: geometric information including three-dimensional position information, and attribute information including three-dimensional color information and one-dimensional reflectance information. A point in the point cloud may include position information of the point and attribute information of the point. For example, the position information of the point may be three-dimensional coordinate information (x, y, z) of the point. The position information of the point may also be referred to as the geometric information of the point. For example, the attribute information of the point may include color information (three-dimensional color information) and/or a reflectance (one-dimensional reflectance information r), and the like. For example, the color information may be any kind of information in a color space. For example, the color information may be RGB information. Here, R represents Red, G represents Green, and B represents Blue. For another example, the color information may be represented as luma-chroma information (YCbCr, YUV). Here, Y represents luma, Cb (U) represents blue-difference chroma, and Cr (V) represents red-difference chroma.

For a point cloud obtained according to a principle of a laser measurement, each point in the point cloud may include three-dimensional coordinate information of the point and a reflectance value of the point. For another example, for a point cloud obtained according to a principle of photogrammetry, each point in the point cloud may include three-dimensional coordinate information of the point and three-dimensional color information of the point. For yet another example, for a point cloud obtained by combining the principles of Laser measurement and the photogrammetry, each point in the point cloud may include three-dimensional coordinate information of the point, a reflectance value of the point, and three-dimensional color information of the point.

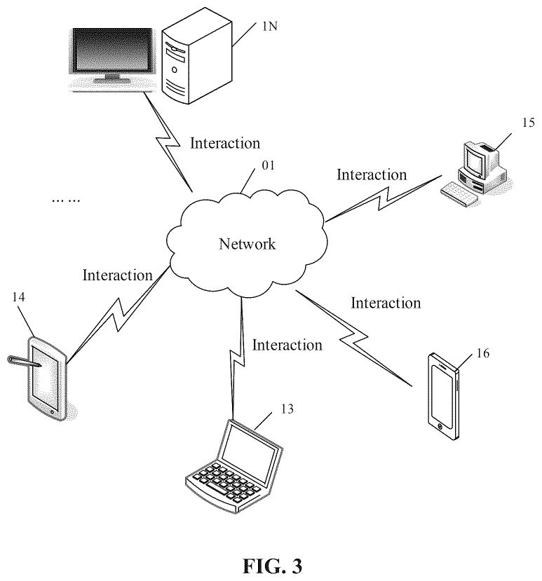

FIG. 2A and FIG. 2B show a point cloud picture and a data storage format corresponding to the point cloud picture. Here, FIG. 2A provides six viewing angles for the point cloud picture, and FIG. 2B includes a file header information section and a data section. The header information includes a data format, a data representation type, a total number of points in the point cloud, and the content represented by the point cloud. For example, the point cloud is in a “ply” format, represented by ASCII code, with a total number of points being 207242, and each point has three-dimensional coordinate information (x, y, z) and three-dimensional color information (r, g, b).

According to the way for obtaining point clouds, the point clouds may be categorized as: a static point cloud, a dynamic point cloud, and dynamically captured point cloud.

For the static point cloud, an object is stationary, and a device for capturing the point cloud is also stationary.

For the dynamic point cloud, an object is in motion, but a device for capturing the point cloud is stationary.

For the dynamically captured point cloud, a device for capturing the point cloud is in motion.

For example, according to usage of point clouds, the point clouds are categorized as two broad categories.

Category 1 is a machine-perception point cloud which may be used in scenarios, such as autonomous navigation systems, real-time inspection systems, geographic information systems, visual sorting robots, emergency rescue and disaster relief robots, etc.

Category 2 is a human eye-perception point cloud which may be used in point cloud application scenarios, such as digital cultural heritage, free viewpoint broadcasting, three-dimensional immersive communication, and three-dimensional immersive interaction, etc.

A point cloud can flexibly and conveniently express the spatial structure and surface attributes of a three-dimensional object or scene; and since the point cloud may be obtained by directly sampling a real object, it is possible to provide a strong sense of realism on the premise of ensuring accuracy. Therefore, the point cloud is used in a wide range of applications, including virtual reality gaming, computer-assistance design, geographic information systems, automatic navigation systems, digital cultural heritage, free viewpoint broadcasting, three-dimensional immersive telepresence, three-dimensional reconstruction of biological tissues and organs, etc.

Point cloud capture is primarily accomplished through three approaches: computer generation, 3D laser scanning, 3D photogrammetry, etc. A computer can generate a point cloud of a virtual three-dimensional object and scene; 3D laser scanning can capture a point cloud of a three-dimensional object or scene in the static real world, delivering millions of points per second; and 3D photogrammetry can capture a point cloud of a three-dimensional object or scene in the dynamic real world, yielding tens of millions of points per second. These technologies reduce the cost and time period of obtaining point cloud data, and improve the accuracy of data. The evolution of acquisition of point cloud data makes it possible to obtain a large amount of point cloud data. However, with a growth of demands of applications, processing such massive 3D point cloud data faces the bottleneck imposed by storage capacity and transmission bandwidth.

Exemplarily, taking a point cloud video with a frame rate of 30 fps (frames per second) as an example, the number of points in each frame of a point cloud is 700,000, and each point has coordinate information xyz (float) and color information RGB (uchar). The data amount of a 10 seconds (10 s) point cloud video is about 0.7 million×(4 Byte×3+1 Byte×3)×30 fps×10 s=3.15 GB, where 1 Byte is equal to 8 bits. However, for a 2D video with a resolution of 1280×720 having a YUV sampling format of 4:2:0 and a frame rate of 24 fps, the data amount of such 10 s 2D video is about 1280×720×12 bit×24 fps×10 s≈0.33 GB. In this case, the data amount of a 10 s 3D video having two views is about 0.33×2=0.66 GB. As can be seen that the data amount of a point cloud video far exceeds the data amount of a two-dimensional video and a three-dimensional video when the point cloud video has a duration as same as the two-dimensional video and three-dimensional video. Therefore, in order to better realize data management, save the storage space of a server, and reduce transmission traffic and transmission time between a server and a client, point cloud compression has become a key to promote the development of point cloud industry.

That is to say, since a point cloud is a set of massive points, storing the point cloud not only consumes a large amount of memory, but also is not conducive to transmission, and there is no such large bandwidth to support the direct transmission of the point cloud in the network layer without compression, so it is necessary to compress the point cloud.

At present, a point cloud encoding framework that may compress a point cloud may be a Geometry-based Point Cloud Compression (G-PCC) codec framework or a Video Point Cloud Compression (V-PCC) codec framework provided by the Moving Picture Experts Group (MPEG), or may also be an Audio Video Standard (AVS)-PCC codec framework provided by the AVS. The G-PCC codec framework may be used for performing compression on the first category of static point cloud and the third category of dynamically captured point cloud, and the V-PCC codec framework may be used for performing compression on the second category of dynamic point cloud. The G-PCC codec framework is also referred to as a point cloud codec TMC13, and the V-PCC codec framework is also referred to as a point cloud codec TMC2.

An embodiment of the present disclosure provides a network architecture of a point cloud codec system including a decoding method and an encoding method. FIG. 3 is a schematic diagram of a network architecture of point cloud codec according to an embodiment of the present disclosure. As shown in FIG. 3, the network architecture includes one or more electronic devices 13 to 1N and a communication network 01. The electronic devices 13 to 1N may perform video interaction with each other through the communication network 01. In the process of implementation, the electronic devices may be various types of devices having point cloud codec functions. For example, the electronic devices may include a phone, a tablet computer, a personal computer, a personal digital assistant, a navigator, a digital phone, a video phone, a television, a sensing device, a server, and the like, which is not limited in the embodiments of the present disclosure. Here, the decoder or the encoder described in the embodiments of the present disclosure may be the aforementioned electronic devices.

Here, the electronic devices in the embodiments of the present disclosure have functions of point cloud codec, and generally include a point cloud encoder (i.e., an encoder) and a point cloud decoder (i.e., a decoder).

The G-PCC codec framework is taken as an example to explain the point cloud compression technology.

It is to be understood that in the point cloud G-PCC codec framework, the point cloud data to be encoded is firstly partitioned into multiple slices by slice partitioning. In each slice, the geometric information of a point cloud and the attribute information corresponding to each point cloud are encoded separately.

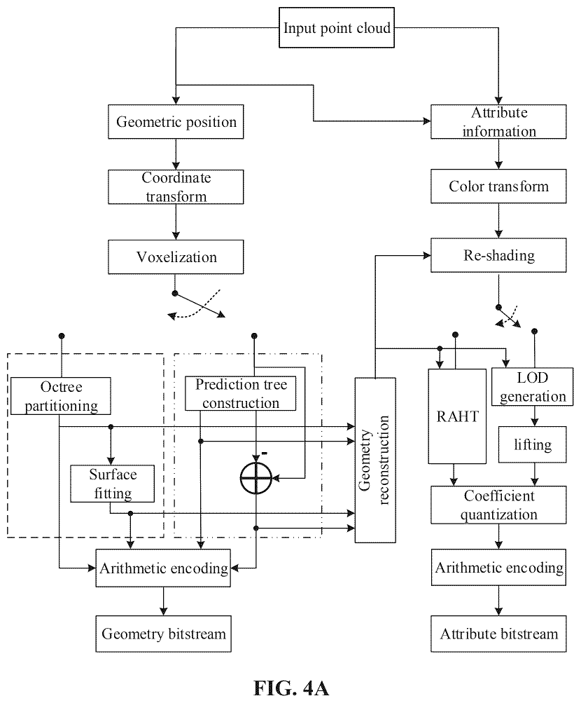

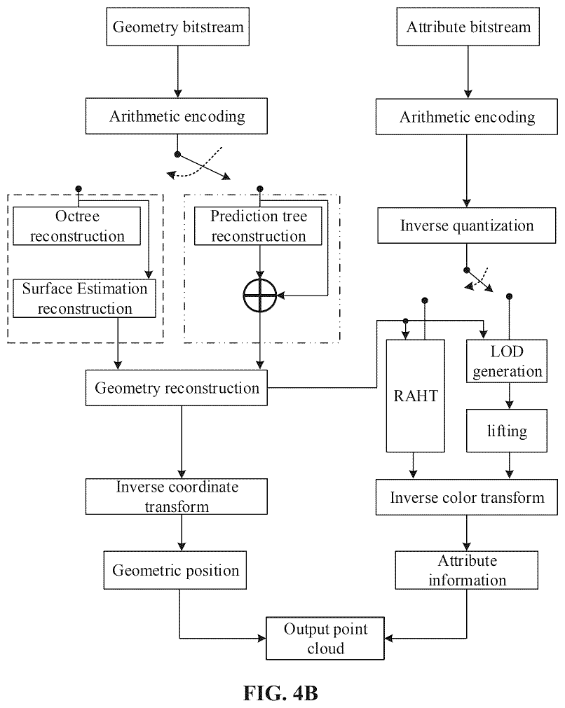

FIG. 4A shows a composition framework of a G-PCC encoder according to an embodiment of the present disclosure. As shown in FIG. 4A, in a process of geometric encoding, coordinate transform is performed on geometric information, so that a point cloud is completely contained in a bounding box, and then quantization is performed. The quantization mainly plays a role of scaling. Since the quantization and rounding causes geometric information of a part of the point cloud to be identical, it is then determined, based on parameters, whether to remove duplicate points. The process of quantization and removing duplicate points is also called a voxelization process. Then octree partitioning or Prediction tree construction is performed on the bounding box. In this process, arithmetic encoding is performed on points in leaf nodes to generate a binary geometry bitstream, or arithmetic encoding is performed on vertexes (i.e., a surface fitting is performed based on vertexes) to generate a binary geometry bitstream. In the process of attribute encoding, geometric encoding is completed. After geometric information is reconstructed, color transform is performed, and color information (i.e., attribute information) is transformed from the RGB color space to the YUV color space. Then, the point cloud is re-shaded using the reconstructed geometric information, so that un-encoded attribute information corresponds to the reconstructed geometric information. The attribute encoding is mainly performed for color information. In the process of color information encoding, two transform methods exist: one is a distance-based lifting transform depending on LOD partitioning, and another is a directly performed Region Adaptive Hierarchical Transform (RAHT). In both two methods, color information will be transformed from a spatial domain to a frequency domain, high frequency coefficients and low frequency coefficients will be obtained through the transform, and then the coefficients are quantized. Finally, the arithmetic encoding is performed on quantized coefficients to generate a binary attribute bitstream.

FIG. 4B shows a schematic diagram of a composition framework of a G-PCC decoder according to an embodiment of the present disclosure. As shown in FIG. 4B, for the obtained binary bitstream, firstly, the geometry bitstream and the attribute bitstream in the binary bitstream are decoded separately. When the geometry bitstream is decoded, the geometric information of the point obtained by cloud is arithmetic decoding-Octree reconstruction/Prediction tree reconstruction-geometry reconstruction-inverse coordinate transform. When the attribute bitstream is decoded, the attribute information of the point cloud is obtained by arithmetic decoding-dequantization-LOD partitioning/RAHT-inverse color transform. The point cloud data to be encoded is restored based on the geometric information and the attribute information.

It is to be noted that, as shown in FIG. 4A or FIG. 4B, current G-PCC geometric codec may be classified into: octree geometric codec (identified by a dashed line box), and prediction tree geometric codec (identified by a dotted line box).

The octree geometric encoding (denoted as OctGeomEnc) includes: firstly coordinate transform is performed on geometric information so that a point cloud is included in one bounding box; then, quantization is performed, which is mainly for scaling; since the quantization and rounding causes geometric information of a part of the points to be identical, it is then determined, according to parameters, whether to remove duplicate points, where in the process of quantization and removing duplicate points is also called voxelization; next, tree partitioning (such as octree, quadtree, binary tree, etc.) is performed continuously on the bounding box in a breadth-first traversal order, and the placeholder code of each node is encoded. In the related art, a company proposes an implicit geometric partitioning method, including that: firstly, the bounding box (2^{d}^{ₓ}, 2^{d}^{_{y}}, 2^{d}^{_{z}}) of a point cloud is calculated, and it is assumed that dₓ>d_{y}>d_{z}, the bounding box is a cuboid; when geometric partitioning is performed, firstly, binary tree partitioning is performed continuously based on the x-axis to obtain two child nodes until the following condition is satisfied: dₓ=d_{y}>d_{z}, then quadtree partitioning is performed continuously based on the x-axis and y-axis to obtain four child nodes until the following condition is finally satisfied: dₓ=d_{y}=d_{z}, and then octree partitioning is performed continuously until the leaf nodes obtained by partitioning are unit cubes each with a size of 1×1×1; and encoding is performed on points in the leaf nodes to generate a binary bitstream. In the process of binary tree/quadtree/octree partitioning, two parameters: K and M are introduced. The parameter K indicates the maximum number of times of binary tree/quadtree partitioning allowed before octree partitioning; and the parameter M is used to indicate a side length of a minimum block corresponding to the binary tree/quadtree partitioning. K and M are required to simultaneously satisfy the following condition: assuming dₘₐₓ=max (dₓ, d_{y}, d_{z}), dₘᵢₙ=min (dₓ, d_{y}, d_{z}), the parameter K satisfies: K>=dₘₐₓ−dₘᵢₙ, and the parameter M satisfies: M>=dₘᵢₙ. The reason why the parameters K and M satisfy the above condition is that in the current process of implicit geometric partitioning of G-PCC, the priority order of partitioning is: binary tree, quadtree and octree. When a block size of a node does not satisfy the condition of the binary tree/quadtree, octree partitioning is performed continuously on the node until the leaf node has the minimum unit of 1×1×1. The octree geometric information-based encoding mode can effectively encode the geometric information of the point cloud by using the correlation between adjacent points in the space, but for some flat nodes or nodes with plane characteristics, the encoding efficiency for the geometric information of the point cloud can be further improved by using the planar encoding mode.

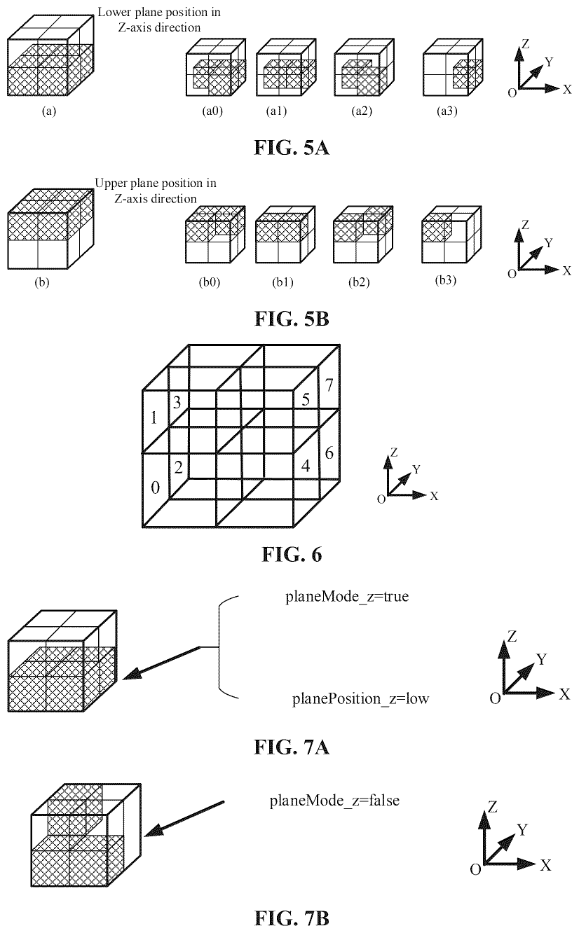

Exemplarily, FIG. 5A and FIG. 5B provide schematic diagrams of plane positions. FIG. 5A shows a schematic diagram of a lower plane position in the Z-axis direction; and FIG. 5B shows a schematic diagram of an upper plane position in the Z-axis direction. As shown in FIG. 5A, (a), (a0), (a1), (a2), and (a3) all belong to the lower plane position in the Z-axis direction. (a) is taken as an example, as can be seen that the occupied four child nodes in the current node are all located at the lower plane position of the current node in the Z-axis direction. Therefore, it can be considered that the current node belongs to a Z plane and is a lower plane in the Z-axis direction. Similarly, as shown in FIG. 5B, (b), (b0), (b1), (b2), and (b3) all belong to the upper plane position in the Z-axis direction. (b) is taken as an example, as can be seen that the occupied four child nodes in the current node are all located at the upper plane position of the current node in the Z-axis direction. Therefore, it can be considered that the current node belongs to the Z plane and is an upper plane in the Z-axis direction.

Furthermore, the efficiency of octree encoding is compared with the efficiency of planar encoding. FIG. 6 provides a schematic diagram of an encoding order of nodes, i.e., encoding is performed on the nodes in the order of 0, 1, 2, 3, 4, 5, 6, and 7 as shown in FIG. 6. If the octree encoding method is adopted for (a) in FIG. 5A, the placeholder information of the current node is expressed as: 11001100. However, if the planar encoding method is adopted, firstly, an identifier is required to be encoded to represent that the current node is a plane in the Z-axis direction; secondly, if the current node is a plane in the Z-axis direction, the plane position of the current node is required to be represented; and next, only the placeholder information of nodes (i.e., the placeholder information of the four child nodes 0, 2, 4, and 6) in the lower plane in the Z-axis direction is required to be encoded. Therefore, only 6 bits are required to be encoded when the current node is encoded based on the planar encoding method, which can reduce the representation of 2 bits compared with the octree encoding in the related art. Based on this analysis, planar encoding has obviously improved encoding efficiency compared with the octree encoding. Therefore, for an occupied node, if the planar encoding is used for encoding in a certain dimension, firstly, planar identifier (denoted as planarMode) information and plane position (denoted as PlanePos) information of the current node in this dimension are required to be represented, and secondly, the placeholder information of the current node is required to be encoded based on the plane information of the current node. Exemplarily, FIG. 7A shows a first schematic diagram of planar mode information. As shown in FIG. 7A, a lower plane in the Z-axis direction is shown. Correspondingly, the value of the planar mode information is true or 1, i.e., planarMode_Z=true; and the plane position information is a lower plane (denoted as low), i.e., PlanePosition_Z=low. FIG. 7B shows a second schematic diagram of another piece of planar mode information. As shown in FIG. 7B, there is no plane in the Z-axis direction. Correspondingly, the value of the planar mode information is false or 0, i.e., planarMode_Z=false.

It is to be noted that for PlaneMode_i: 0 represents that the current node is not a plane in the i-axis direction, and 1 represents that the current node is a plane in the i-axis direction. If the current node is a plane in the i-axis direction, then for PlanePosition_i: 0 represents that the current node is a lower plane in the i-axis direction, and 1 represents that the current node is an upper plane in the i-axis direction. Here, i represents a coordinate dimension, which may be the X-axis direction, the Y-axis direction, or the Z-axis direction, therefore, i=0, 1, 2.

In the G-PCC standard, it is determined whether a node satisfies the condition of the planar encoding and when the node satisfies the condition of the planar encoding, the predictive encoding is required to be performed on the planar mode information and plane position information of the node.

In the current G-PCC standard, there are three kinds of conditions for determining whether a node satisfies the planar encoding, which are described in detail below.

First, determination is performed based on a plane probability of a node in each dimension.
(1) A local region density (denoted as local_node_density) of the current node is determined; and
(2) A probability Prob (i) of the current node in each dimension is determined.

When the local region density of the node is less than a threshold Th (e.g., Th=3), the plane probabilities Prob (i) of the current node in three coordinate dimensions are compared with thresholds Th0, Th1, and Th2, where Th0<Th1<Th2 (e.g., Th0-0.6, Th1=0.77, Th2=0.88). Here, Eligiblei (i=0, 1, 2) may be used to indicate whether the planar encoding is initiated in each dimension:

$$Eligiblei = Prob ( i ) > = threshold .$$

It is to be noted that the threshold is adaptively changed. For example, when Prob (0)>Prob (1)>Prob (2), Eligiblei is set as follows:

$$E l i g i b l {e}_{0} = P r o b ( 0 ) >= Th 0 ; \\ {Eligible}_{{}^{1}} = Prob ( 1 ) >= Th 1 ; \\ and \\ {Eligible}_{{}^{2}} = Prob ( 2 ) >= Th 2.$$

When Prob (1)>Prob (0)>Prob (2), then Eligiblei is set as follows:

$$Elig i b l {e}_{0} = P r o b ( 0 ) >= Th 1 ; \\ {Eligible}_{{}^{1}} = Prob ( 1 ) >= Th 0 ; \\ and \\ {Eligible}_{{}^{2}} = Prob ( 2 ) >= Th 2.$$

Here, Prob (i) is updated as follows:

$$Prob {( i )}_{n e w} = ( L \times Prob ( i ) + δ ( encoded node ) ) / L + 1. \qquad ( 1 )$$

Here, L=255. In addition, if a encoded node is a plane, then δ (encoded node) is 1; otherwise, δ (encoded node) is 0.

Here, the local_node_density is updated as follows:

$$local\_node {\_density}_{n e w} = local\_node \_density + 4 \times numSiblings . \qquad ( 2 )$$

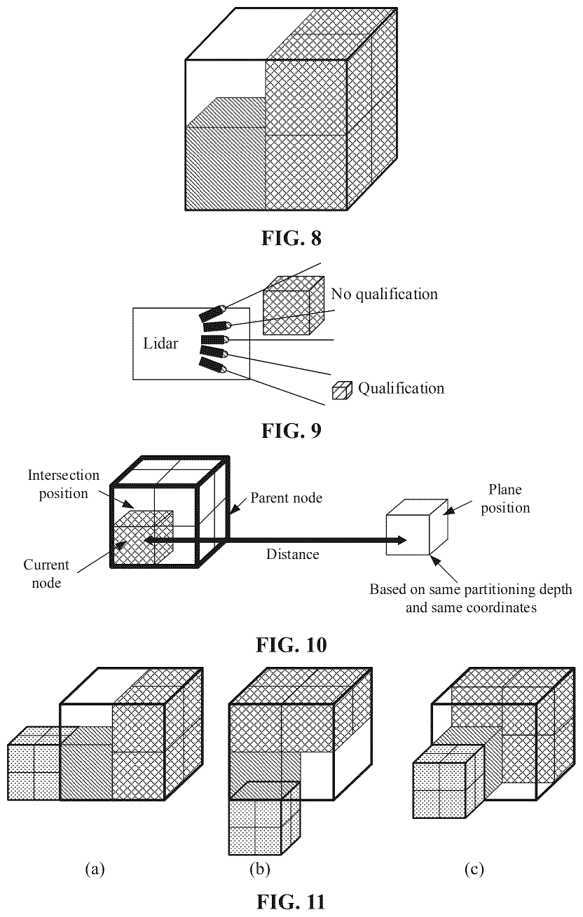

Here, local_node_density is initialized to be 4, and numSiblings is the number of sibling nodes of this node. Exemplarily, FIG. 8 is a schematic diagram of sibling nodes of a current node according to an embodiment of the present disclosure. As shown in FIG. 8, the current node is a node filled with slash lines, and nodes filled with a grid are sibling nodes. The number of sibling nodes of the current node is 5 (including the current node itself).

Second, based on the point cloud density of the current layer, it is determined whether the node of the current layer satisfies the planar encoding.

According to the density of points of the current layer, it is determined whether the planar encoding is performed on a node of the current layer. It is assumed that the number of points in the current point cloud to be encoded is pointCount, and the number of points that have been reconstructed after Infer Direct Mode Coding (IDCM) is numPointCountRecon, and because the octree encoding is performed in breadth-first traversal order, it can be obtained that the number of nodes to be encoded on the current layer is assumed to be nodeCount, and then determining whether the planar encoding is started to be performed on the current layer is assumed as planarEligibleKOctreeDepth, specifically: lanarEligibleKOctreeDepth=(pointCount-numPointCountRecon)<nodeCount×1.3.

If (pointCount-numPointCountRecon) is less than nodeCount×1.3, then planarEligibleKOctreeDepth is true. If (pointCount-numPointCountRecon) is not less than nodeCount×1.3, then planarEligibleKOctreeDepth is false. In this way, when planarEligibleKOctreeDepth is true, the planar encoding is performed on all nodes of the current layer; otherwise, the planar encoding is not performed on any of nodes of the current layer, but only the octree encoding is performed.

Third, based on acquisition parameters of a lidar point cloud, it is determined whether a node of the current layer satisfies the planar encoding.

FIG. 9 is a schematic diagram of intersection between a lidar and nodes according to an embodiment of the present disclosure. As shown in FIG. 9, a node filled with a grid is simultaneously passed through by two lasers, therefore, the current node is not a plane in the Z-axis vertical direction. A node filled with slash lines is too small to be simultaneously passed through by two lasers, therefore, it is possible that the green node is a plane in the Z-axis vertical direction.

Furthermore, for a node satisfying the planar encoding condition, predictive encoding may be performed on the planar mode information and the plane position information of the node.

The first is predictive encoding of the planar mode information.

Here, only three pieces of context information are used for encoding, i.e., context design is separately performed on the planar modes in all coordinate dimensions.

The second is predictive encoding of the plane position information.

It is to be understood that for the encoding of the plane position information of the non-LIDAR point cloud, the reference context information existed in the related art may include followings.

(a) Placeholder information of a neighborhood node is used for prediction to obtain that the plane position information of a current node is the following three elements: predicted as a lower plane, predicted as a high plane and unpredictable.

(b) A spatial distance between the current node and a node having the same partitioning depth and the same coordinates as the current node is: “near” and “far”.

(c) If the node having the same partitioning depth and the same coordinates as the current node is a plane, the plane position of the node is determined.

(d) Coordinate dimensions (i=0, 1, 2).

Exemplarily, FIG. 10 is a schematic diagram of a neighborhood node at a same partitioning depth and having same coordinates as a current node. As shown in FIG. 10, the current node is a small cube filled with a grid, the neighborhood node which is searched for at the same octree partitioning depth and the same vertical coordinates is a small cube filled with white, and the distance between the two nodes is determined as “near” and “far” with referring to the plane position of the node.

In an embodiment of the present disclosure, FIG. 11 is a schematic diagram of a current node being located at a lower plane position of a parent node. As shown in FIG. 11, (a), (b), (c) show three examples of the current node being located at a lower plane position of the parent node, which is specifically explained as follows.

(1) If any one of the child node 4 to child node 7 of the node filled with dots is occupied and none of the nodes filled with a grid is occupied, it is highly likely that a plane exists in the current node (filled with slashes) and the plane has a lower position.

(2) If none of the child node 4 to child node 7 of the node filled with dots is occupied and each of the nodes filled with a grid is occupied, it is highly likely that a plane exists in the current node (filled with slashes) and the plane has an upper position.

(3) If each of the child node 4 to child node 7 of the node filled with dots is a null node and each of the nodes filled with a grid is a null node, the plane position cannot be inferred, therefore, unknown is marked.

(4) If any one of the child node 4 to child node 7 of the node filled with dots is occupied and any one of the nodes filled with a grid is occupied, the plane position cannot be inferred, therefore, unknown is marked.

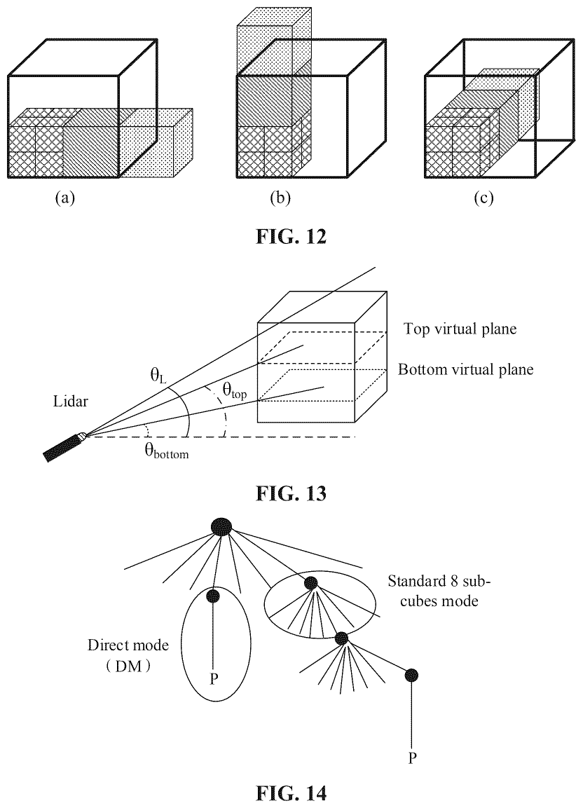

In an embodiment of the present disclosure, FIG. 12 is a schematic diagram of a current node being located at an upper plane position of a parent node. As shown in FIG. 12, (a), (b), (c) show three examples of the current node being located at an upper plane position of the parent node, which is specifically explained as follows.

(1) If any one of the child node 4 to child node 7 of the node filled with a grid is occupied and the node filled with dots is not occupied, it is highly likely that a plane exists in the current node (filled with slashes) and the plane has a lower position.

(2) If none of the child node 4 to child node 7 of the node filled with a grid is occupied and the node filled with dots is occupied, it is highly likely that a plane exists in the current node (filled with slashes) and the plane has an upper position.

(3) If each of the child node 4 to child node 7 of the node filled with a grid is not occupied and the node filled with dots is not occupied, the plane position cannot be inferred, therefore, unknown is marked.

(4) If one of the child node 4 to child node 7 of the node filled with a grid is occupied and the node filled with dots is occupied, the plane position cannot be inferred, therefore, unknown is marked.

It is to be understood that for the encoding of plane position information of a lidar point cloud, FIG. 13 is a schematic diagram of predictive encoding of plane position information of a lidar point cloud. As shown in FIG. 13, when an emission angle of lidar is θ_{bottom}, it may be mapped to a lower plane (Bottom virtual plane). When an emission angle of the radar is @top, it may be mapped to an upper plane (Top virtual plane).

That is to say, the plane position of the current node is predicted by using parameters acquired by lidar, and the position is quantified into multiple intervals based on the position where the current node intersects with the laser, and the multiple intervals are finally used as context information of the plane position of the current node. The specific calculation process is as follows: it is assumed that the coordinates of lidar are (x_{Lidar}, y_{Lidar}, z_{Lidar}), the geometric coordinates of the current node are (x, y, z), then the vertical tangent value tan θ of the current node relative to the lidar is firstly calculated, the calculation formula is as follows:

$$tan θ = \frac{z - {z}_{Lidar}}{\sqrt{{( x - {x}_{Lidar} )}^{2} + {( y - {y}_{Lidar} )}^{2}}} \qquad ( 3 )$$

Furthermore, since each laser has a certain offset angle relative to the lidar, it is also necessary to calculate a relative tangent value tan θ_{corr,L} of the current node relative to the laser, the specific calculation is as follows:

$$tan {θ}_{c orr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 4 )$$

The relative tangent value tan θ_{corr,L} of the current node may eventually be used to predict the plane position of the current node, as follows: it is assumed that the tangent value of the bottom boundary of the current node is tan θ_{bottom}, the tangent value of the top boundary of the current node is tan θₜₒₚ, according to tan θ_{corr,L}, the plane position is quantized into four quantization intervals, i.e., the context information of the plane position is determined.

However, the octree geometric information encoding mode has an efficient compression rate for only the points which have a correlation with each other in the space. For the points at isolated positions in the geometry space, the use of Direct Coding Model (DCM) can greatly reduce the complexity. For all nodes in the octree, the use of DCM is not represented by flag bit information, but inferred by a parent node and neighbor information of a current node. There are three methods to determine whether a current node has a DCM encoding qualification, which are explained as follows.

(1) A current node has no sibling child nodes, i.e., the parent node of the current node has only one child node, and the parent node of the parent node of the current node has only two occupied child nodes, i.e., the current node has only one neighbor node at most.

(2) The parent node of the current node has only one occupied child node, i.e., the current node, and six neighbor nodes that share one surface with the current node are all null nodes.

(3) The number of sibling nodes of the current node is greater than 1.

FIG. 14 provides a schematic diagram of IDCM encoding. As shown in FIG. 14, if a current node is not qualified for DCM encoding, octree partitioning is performed on the current node. If the current node is qualified for DCM encoding, the number of points included in the node may be further determined. When the number of points is less than a threshold (for example, 2), then the DCM encoding is performed on the node; otherwise, the octree partitioning may be continued to be performed. When the DCM encoding mode is applied, it is first necessary to encode whether the current node is a real isolated point, i.e., IDCM_flag. When the IDCM_flag is true, the DCM encoding is adopted for the current node; otherwise, the octree encoding is still adopted. When the current node satisfies the DCM encoding, it is necessary to encode the DCM encoding mode of the current node. At present, there are two DCM modes, namely: (a) only one point exists (or multiple points exist, but they are duplicate points); (b) there are two points. Finally, it is necessary to encode the geometric information of each point. It is assumed that the side length of the node is 2^{d}, d bits are required when each component of the geometric coordinates of the node is encoded, and the bit information is directly encoded into a bitstream. It is to be noted that when the lidar point cloud is encoded, by using the parameters acquired by lidar to perform the predictive encoding on the coordinate information in three dimensions, the encoding efficiency for geometric information can be further improved.

Then, the process of the IDCM encoding is introduced in detail.

When a current node satisfies the DCM, the number of points (numPoints) of the current node is firstly encoded, and the numPoints of the current node is encoded according to different DirectModes.

If the current node does not satisfy the requirements of the DCM node (i.e. the number of points is greater than 2, and the points are not duplicate points), it exits directly from the encoding process.

If the number of points (numPoints) included in the current node is less than or equal to 2, the encoding process is as follows.

1) Firstly, it is encoded whether the numPoints of the current node is greater than 1.

2) If the current node has only one point and the geometric encoding environment is geometry lossless encoding, it is necessary to encode the second point of the current node as a non-duplicate point.

If the number of points (numPoints) included in the current node is greater than 2, the encoding process is as follows.

3) Firstly, it is encoded that the numPoints of the current node is less than or equal to 1.

4) Secondly, it is encoded the second point of the current node as a duplicate point, and then, it is encoded whether the number of duplicate points of the current node is greater than 1. When the number of duplicate points is greater than 1, exponential Columbus decoding is required to be performed on the number of remaining duplicate points.

After the number of points of the current node is encoded, coordinate information of the points included in the current node is encoded. The following will separately introduce a lidar point cloud and a human eye-oriented point cloud.

### Human Eye-Oriented Point Cloud

1) If a current node includes only one point, direct encoding (bypass encoding) may be performed on geometric information of the point in the three dimensional directions.

2) If the current node includes two points, the priority-encoded coordinate axis dirextAxis may be obtained firstly by using the geometric coordinates of the points. It is to be noted that the coordinate axes currently compared include only the x axis and y axis without the z axis. It is assumed that the geometric coordinates of the current node are nodePos, the determination method is as follows:

$$dirextAxis = \text{!(} nodePos [ 0 ] < nodePos [ 1 ] )$$

That is to say, the axis with a smaller geometric coordinate position of a node is used as the priority-encoded coordinate axis dirextAxis, and secondly, the geometric information of the priority-encoded coordinate axis dirextAxis is firstly encoded as follows: it is assumed that the geometry bit to be encoded which corresponds to the priority-encoded axis has a depth of nodeSizeLog2, and it is assumed that the coordinates of the two points are pointPos[0] and pointPos[1], respectively.

```
    Bool sameBit=true;
    while (nodeSizeLog2&& sameBit){
      int mask=1<< nodeSizeLog2;
      −−nodeSizeLog2;
      bool bit0=!!( pointPos[0]& mask)
  bool bit1=!!( pointPos[1]& mask)
      sameBits=bit0==bit1;
      entropyCodeSameBit(sameBits); ///<entropy encoding
      if (sameBits)
        encodePosBit(bit0); ///<Bypass encoding
}
```

After the priority-encoded axis dirextAxis is encoded, the bypass encoding is performed on the geometric coordinates of the current point. It is assumed that the remaining bit to be encoded of each point has a depth of nodeSizeLog2, the specific encoding process is as follows:

```
for(int axisIdx=0; axisIdx<3; ++axisIdx)
  for(int mask=(1<< nodeSizeLog2[axisIdx])>>1; mask; mask>>1)
    encodePosBit(!!(pointPos[axisIdx]&mask));
```

### Lidar-Oriented Point Cloud

1) If a current node includes two points, the priority-encoded coordinate axis dirextAxis may be obtained firstly using the geometric coordinates of the points. It is assumed that the geometric coordinates of the current node are nodePos, the determination method is as follows:

$$dirextAxis = \text{!(} nodePos [ 0 ] < nodePos [ 1 ] ) .$$

That is to say, the axis with a smaller geometric coordinate position of a node (nodePos) is used as the priority-encoded coordinate axis dirextAxis. It is to be noted that the coordinate axes currently compared include only the x axis and y axis without the z axis. Secondly, the geometric information of the priority-encoded coordinate axis dirextAxis is firstly encoded as follows: it is assumed that the geometry bit to be encoded which corresponds to the priority-encoded axis has a depth of nodeSizeLog2, and it is assumed that the coordinates of the two points are pointPos[0] and pointPos[1], respectively.
Bool sameBit=true;

```
    while(nodeSizeLog2&& sameBit){
      int mask=1<< nodeSizeLog2;
      −−nodeSizeLog2;
      bool bit0=!!( pointPos[0]& mask)
  bool bit1=!!( pointPos[1]& mask)
      sameBits=bit0==bit1;
      entropyCodeSameBit(sameBits);
      if(sameBits)
        encodePosBit(bit0);
}
```

After the priority-encoded axis dirextAxis is encoded, encoding is performed on the geometric coordinates of the current point.

Since a lidar point cloud may obtain the acquisition parameters of lidar point cloud, the geometry coordinate information of a current node may be predicted by using the acquisition parameters, thereby improving the encoding efficiency for the geometric information of the point cloud. Similarly, firstly, the geometric information nodePos of the current node is used to obtain a bypass encoded main axis direction, and secondly, the geometric information of the encoded direction is used to perform predictive encoding on geometric information of another dimension. Similarly, it is assumed that the bypass encoded axis direction is directAxis, and it is assumed that the bit to be encoded in the bypass encoding has a depth of nodeSizeLog2, the encoding method is as follows:

for (int mask=(1<< nodeSizeLog2)>>1; mask; mask>>1)
encodePosBit(!!(pointPos[directAxis]&mask));

It is to be noted that all the geometry precision information of the directAxis direction may be encoded herein.

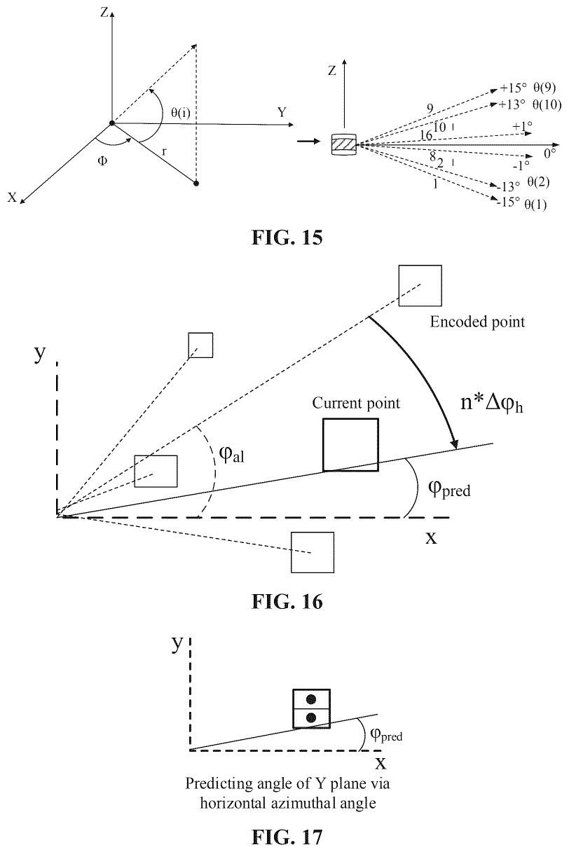

FIG. 15 is a schematic diagram of coordinate transform of a point cloud obtained by a rotating lidar. After encoding all the precision of the coordinate direction directAxis, the LaserIdx corresponding to a current point, such as the pointLaserIdx in FIG. 15, is firstly calculated; and the LaserIdx of a current node, i.e., nodeLaserIdx, is calculated. Then, predictive encoding may be performed on the LaserIdx of a point, i.e., pointLaserIdx, by using the LaserIdx of the node, i.e., nodeLaserIdx. Here, the calculation method of LaserIdx of a node or the LaserIdx of a point is as follows: it is assumed that the geometric coordinates of the point is pointPos and the starting coordinates of Laser is LidarOrigin, and it is assumed that the number of lasers is LaserNum, the tangent value of each laser is tan θi, and the offset position of each laser in the vertical direction is Zᵢ, then:

```
      Int bestLaserIdx=0;
      Int Distoration=INT_MAX;
  For(int LaserIdx=0; LaserIdx<numLaser;++ LaserIdx){
        int radius =
\sqrt{(pointPos[0] − LidarOrigin[0])2 +}
\sqrt{(pointPos[1] − LidarOrigin[1])2}
      int invRadius=1/ radius
      int Z=pointPos[2]+ Zᵢ
      int tan Theta= Z×invRadius
      if(std::abs(tanTheta−tanθᵢ)< Distoration){
      Distoration= std::abs(tanTheta−tanθᵢ);
      bestLaserIdx= LaserIdx;
    }
  }
```

After the LaserIdx of the current node is calculated, predictive encoding is performed on the LaserIdx of a point, i.e., pointLaserIdx, by using the LaserIdx of the current node. After the LaserIdx of the current point is encoded, predictive encoding is performed on the three-dimensional geometric information of the current point by using the acquisition parameters of lidar.

For the predictive encoding, FIG. 16 is a schematic diagram of predictive encoding. As shown in FIG. 16, firstly, a predicted value, i.e., φ_{pred}, of a corresponding horizontal azimuthal angle is obtained by using the LaserIdx corresponding to a current point. Secondly, a horizontal azimuthal angle φ_{node} corresponding to a node is obtained by using the geometric information of the node corresponding to the current point. Here, the calculation method between the horizontal azimuthal angle φ and the geometric information of the node is as follows, herein, it is assumed that the geometric coordinates of the node are nodePos, then:

$$φ = arctan ( nodePos [ 1 ] / nodePos [ x ] ) . \qquad ( 5 )$$

By using the acquisition parameters of lidar, the number of rotation points (numPoints) of each laser may be obtained, which represents the number of points obtained by rotating each laser once, and the rotation angular velocity deltaPhi of each laser may be calculated using the number of rotation points of each laser, i.e.:

$$deltaPhi = \frac{2 π}{n u m P o i n t s} . \qquad ( 6 )$$

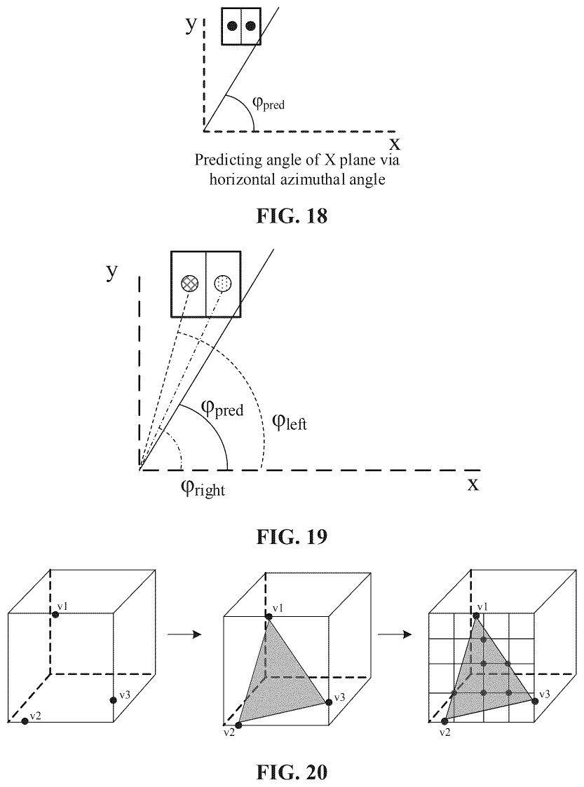

The horizontal azimuthal angle φ_{pred} of the node and the horizontal azimuthal angle φ_{pred} of the previous encoded point of Laser corresponding to the current point are used to calculate to obtain the predicted value φ_{predPoint} of the horizontal azimuthal angle corresponding to the current point. FIG. 17 is a first schematic diagram of angle prediction based on a horizontal azimuthal angle. FIG. 18 is a second schematic diagram of angle prediction based on a horizontal azimuthal angle. As shown in FIG. 17 and FIG. 18, an angle of the X plane or an angle of Y plane may be predicted by a horizontal azimuthal angle. The calculation method is as follows:

$${φ}_{p r e d P o i n t} = \frac{φ pred - φ node}{deltaPhi} \times deltaPhi + φ pred . \qquad ( 7 )$$

FIG. 19 is a schematic diagram of predictive encoding on the X axis or Y axis. As shown in FIG. 19, the predictive encoding is performed on the geometric information of a current node using the predicted value φ_{predPoint} of a horizontal azimuthal angle, the horizontal azimuthal angle left of the ground plane of the current node and the horizontal azimuthal angle φ_{right} of the top plane of the current node.

The calculation method is specifically as follows.

$$int angLe l = {φ}_{left} - {φ}_{p r e d} \\ int angLe R = {φ}_{r i g h t} - {φ}_{p r e d} \\ int context = ( angLel \geq 0 \&\& angLeR \geq 0 ) \vert \vert ( angLel < 0 \&\& angLeR < 0 ) ? 0 : 2 \\ int minAngle = std \text{::} min ( abs ( angLel ) , abs ( angLeR ) ) \\ int maxAngle = std \text{::} max ( abs ( angLel ) , abs ( angLeR ) ) \\ context += maxAngle > minAngle ? 0 : 1 \\ context += maxAngle > minAngle ? 0 : 4$$

After the LaserIdx of a point is encoded, predictive encoding may be performed on the current point in the Z-axis direction by using the LaserIdx corresponding to the current point. That is to say, the depth information radius of a cylindrical coordinate system is calculated by using the x-axis and y-axis geometric information of the current point, and the tangent value of the current point and the offset of the current point in the vertical direction are obtained using the laser LaserIdx of the current point, so that the predicted value of the current point in the Z-axis direction, i.e., Z_pred, may be obtained:

$$int radius = \sqrt{( pointPos [ 0 ] - LidarOrigin [ 0 ] ) 2 + ( pointPos [ 1 ] - LidarOrigin [ 1 ] ) 2} \\ int tan Theta = tan {θ}_{laserIdx} \\ int zOffset = {Z}_{laserIdx} \\ Z\_pred = radius \times tan Theta - zOffset .$$

Finally, predictive encoding is performed on the geometric information of the current point in the Z-axis direction by using the Z_pred to obtain a prediction residual Z_res. Finally, Z_res is encoded.

It is also to be noted that when node partitioning is performed to a leaf node, the number of duplicate points in the leaf node is required to be encoded in the case of lossless geometric encoding. Finally, the placeholder information of all nodes is encoded to generate a binary bitstream. In addition, a planar encoding mode is currently introduced into the G-PCC. During geometric partitioning, it may be determined whether the child nodes of a current node are located in the same plane. If the child nodes of the current node are in the same plane, the plane may be used to represent the child nodes of the current node.

For octree geometric decoding, before the placeholder information of each node is decoded in breadth-first traversal order, the decoding end may firstly determine based on reconstructed geometric information whether to perform planar decoding or IDCM decoding on a current node. If the current node satisfies the planar decoding condition, the planar mode information and plane position information of the current node may be firstly decoded, and then the placeholder information of the current node is decoded based on the plane information. If the current node satisfies the IDCM decoding condition, it may be firstly parsed whether the current node is a true IDCM node, and if the current node is a true IDCM node, parsing may be continued to obtain the DCM decoding mode of the current node; secondly, the number of points in the current DCM node may be obtained, and finally the geometric information of each point may be decoded. For a node that satisfies neither planar decoding nor DCM decoding, decoding may be performed for the placeholder information of the current node. Parsing is performed continuously in this way to obtain a placeholder code of each node, and node partitioning continues in sequence until a unit cube with a size of 1×1×1 is obtained by such partitioning, the number of points included in each leaf node is obtained by such parsing, and finally the geometric synthesis information of the point cloud is recovered.

Hereafter, the process of IDCM decoding is introduced in detail.

The same as the encoding process, firstly, prior information is used to determine whether IDCM is started for a node, i.e., the starting conditions for IDCM are as follows.

(1) A current node has no sibling child nodes, i.e., the parent node of the current node has only one child node, and the parent node of the parent node of the current node has only two occupied child nodes, i.e., the current node has only one neighbor node at most.

(2) The parent node of the current node has only one occupied child node, i.e., the current node, and six neighbor nodes that share one surface with the current node are all null nodes.

(3) The number of sibling nodes of the current node is greater than 1.

When the node satisfies the DCM encoding condition, it is necessary to firstly decoded whether the current node is a true DCM node, i.e., IDCM_flag. When IDCM_flag is true, DCM encoding is adopted for the current node; otherwise, octree encoding is still adopted.

Secondly, the number of points (numPoints) of the current node is decoded. The specific decoding method is as follows.

1) Firstly, it is decoded whether the numPoints of the current node is greater than 1.

2) If the numPoints of the current node obtained by decoding is greater than 1, the decoding is continued to obtain whether a second point is a duplicate point. If the second point is not a duplicate point, it may be implicitly inferred that the current node satisfies the second type of DCM mode and includes only two points.

3) If the numPoints of the current node obtained by decoding is less than or equal to 1, the decoding is continued to obtain whether a second point is a duplicate point. If the second point is not a duplicate point, it may be implicitly inferred that the current node satisfies the second type of DCM mode and includes only one point. If it is determined by decoding that the second point is a duplicate point, it may be inferred that the current node satisfies the third type of DCM mode and includes multiple points that are duplicate points; then the decoding (entropy decoding) is continued to determine whether the number of the duplicate points is greater than 1. If the number of the duplicate points is greater than 1, the decoding (by using exponential Columbus) is continued to obtain the number of remaining duplicate points.

If the current node does not satisfy the requirements of the DCM mode, it exits directly (i.e. the number of points is greater than 2, and the points are not duplicate points) from decoding.

After the number of points of the current node is decoded, coordinate information of the points included in the current node is decoded. The following will separately introduce a lidar point cloud and a human eye-oriented point cloud.

### Human Eye-Oriented Point Cloud

1) If a current node includes only one point, direct encoding (bypass encoding) may be performed on the three-dimensional geometric information of the point.

2) If the current node includes two points, the priority-decoded coordinate axis dirextAxis may be obtained firstly by using the geometric coordinates of the points. It is to be noted herein that the coordinate axes currently in comparison include only the x axis and y axis without the z axis. It is assumed that the geometric coordinates of the current node are nodePos, the determination method is as follows.

$$dirextAxis = ! ( nodePos [ 0 ] < nodePos [ 1 ] ) .$$

That is to say, the axis with a smaller geometric coordinate position of a node is used as the priority-decoded coordinate axis dirextAxis, and secondly, the geometric information of the priority-decoded coordinate axis dirextAxis is firstly decoded as follows: it is assumed that the geometry bit to be decoded corresponding to the priority-encoded axis has a depth of nodeSizeLog2, and it is assumed that the coordinates of the two points are pointPos[0] and pointPos[1], respectively.

```
Bool sameBit=true;
while(nodeSizeLog2&& sameBit){
  pointPos[0][ dirextAxis]<<1;
  pointPos[1][ dirextAxis]<<1;
  −−nodeSizeLog2;
  int bit=0;
  deEntropyCodeSameBit(sameBits); ///<entropy encoding
  if(sameBits){
    bit =decodePosBit( );///<Bypass encoding
    pointPos[0][ dirextAxis]|= bit
    pointPos[1][ dirextAxis]|= bit
  }else
      pointPos[1][ dirextAxis]|= 1///< The reason is that:
  during encoding, two points are sorted in the priority-
  encoded axis direction, so it may be ensured that
  pointPos[0][dirextAxis]<pointPos[1][dirextAxis].
  Therefore, during decoding, if the pieces of bit
  information of two points are different, it may be inferred
  that the bit of the first point is 0 and the bit of the second
  point is 1.
}
```

After the priority-decoded axis dirextAxis is decoded, bypass decoding is performed on the geometric coordinates of the current point. It is assumed that the remaining bit to be encoded of each point has a depth of nodeSizeLog2, the specific decoding process is as follows and it is assumed that the coordinate information of the point is pointPos:

```
for(int axisIdx=0; axisIdx<3; ++axisIdx)
  for(int idx= nodeSizeLog2[axisIdx]; idx; idx−−){
    pointPos[axisIdx]<<1;
    pointPos[axisIdx]|=decodePosBit( );
  }
```

### Lidar-Oriented Point Cloud

1) If a current node includes two points, the priority-decoded coordinate axis dirextAxis may be obtained firstly using the geometric coordinates of the points. It is assumed that the geometric coordinates of the current node are nodePos, the determination method is as follows:

$$dirextAxis = ! ( nodePos [ 0 ] < nodePos [ 1 ] ) .$$

That is to say, the axis with a smaller geometric coordinate position of a node (nodePos) is used as the priority-decoded coordinate axis dirextAxis. It is to be noted that the coordinate axes currently compared include only the x axis and y axis without the z axis. Secondly, the geometric information of the priority-decoded coordinate axis dirextAxis is firstly decoded as follows: it is assumed that the geometry bit to be encoded corresponding to the priority-deencoded axis has a depth of nodeSizeLog2, and it is assumed that the coordinates of the two points are pointPos[0] and pointPos[1], respectively.

```
Bool sameBit=true;
while(nodeSizeLog2&& sameBit){
  pointPos[0][ dirextAxis]<<1;
  pointPos[1][ dirextAxis]<<1;
  −−nodeSizeLog2;
  int bit=0;
  deEntropyCodeSameBit(sameBits); ///<entropy encoding
  if(sameBits){
    bit =decodePosBit( );///<Bypass encoding
    pointPos[0][ dirextAxis]|= bit
    pointPos[1][ dirextAxis]|= bit
  }else
      pointPos[1][ dirextAxis]|= 1///< The reason is that:
  uring encoding, two points are sorted in the priority-
  encoded direction, so it may be ensured that
  pointPos[0][dirextAxis]<pointPos[1][dirextAxis].
  Therefore, during decoding, if the pieces of bit
  information of two points are different, it may be inferred
  that the bit of the first point is 0 and the bit of the second
  point is 1.
}
```

After the priority-decoded axis dirextAxis is decoded, bypass decoding is performed on the geometric coordinates of the current point.

Similarly, firstly, the geometric information nodePos of the current node is used to obtain a bypass decoded main axis direction, and secondly, the geometric information of the decoded direction is used to decode the geometric information of another dimension. Similarly, it is assumed that the bypass decoded axis direction is directAxis, and it is assumed that the bit to be decoded in the bypass decoding has a depth of nodeSizeLog2, the decoding method is as follows:

```
For(int idx= nodeSizeLog2[directAxis]; idx; idx−−){
  pointPos[directAxis]<<1;
  pointPos[directAxis]|=decodePosBit( );
}
```

It is to be noted that all the geometry precision information of the directAxis direction may be decoded.

After all the precision of the coordinate direction directAxis is decoded, the LaserIdx of a current node, i.e., nodeLaserIdx, is calculated. Secondly, predication decoding may be performed on the LaserIdx of a point, i.e., pointLaserIdx, by using the LaserIdx of the node, i.e., nodeLaserIdx. Here, the calculation method of LaserIdx of the node or the LaserIdx of the point is as those at the encoding end. Finally, decoding is performed on the prediction residual information of LaserIdx of the current point and the LaserIdx of the node to obtain ResLaserIdx, then

$$PointLaserIdx = nodeLaserIdx + ResLaserIdx \qquad ( 8 )$$

After the LaserIdx of the current point is decoded, prediction decoding is performed on the three-dimensional geometric information of the current point using the acquisition parameters of lidar.

For the prediction decoding, as shown in FIG. 16, firstly, a predicted value, i.e., φ_{pred}, of a corresponding horizontal azimuthal angle is obtained by using the LaserIdx corresponding to a current point. Secondly, a horizontal azimuthal angle φ_{node} corresponding to a node is obtained by using the geometric information of the node corresponding to the current point. Here, the calculation method between the horizontal azimuthal angle φ and the geometric information of the node is as follows.

It is assumed that the geometric coordinates of the node are nodePos, the horizontal azimuthal angle φ is calculated according to formula (5).

By using the acquisition parameters of lidar, the number of rotation points (numPoints) of each laser may be obtained, which represents the number of points obtained by rotating each laser once, and the rotation angular velocity deltaPhi of each laser may be calculated by using the number of rotation points of each laser, i.e.: the aforementioned formula (6).

The horizontal azimuthal angle φ_{node} of the node and the horizontal azimuthal angle φ_{pred} of the previous encoded point of Laser corresponding to the current point are used to calculate to obtain the predicted value φ_{predPoint} of the horizontal azimuthal angle corresponding to the current point, i.e., as shown in FIG. 17 and FIG. 18, the angle of the X plane or Y plane may be predicted by the horizontal azimuthal angle. The calculation method is as shown in formula (7).

As shown in FIG. 19, predictive encoding is performed on the geometric information of a current node by finally using the predicted value φ_{predPoint} of a horizontal azimuthal angle, the horizontal azimuthal angle φ_{left} of the ground plane of the current node and the horizontal azimuthal angle φ_{right} of the top plane of the current node,

The calculation method is specifically as follows.

$$int angLel = {φ}_{left} - {φ}_{pred}$$

$$int angLeR = {φ}_{right} - {φ}_{pred}$$

$$int context = ( angLel \geq 0 \&\& angLeR \geq 0 ) ‖ ( angLel < 0 \&\& angLeR < 0 ) ? 0 : 2$$

$$int min Angle = std : : min ( abs ( angLel ) , abs ( angLeR ) )$$

$$int max Angle = std : : max ( abs ( angLel ) , abs ( angLeR ) )$$

$$context += max Angle > min Angle ? 0 : 1$$

$$context += max Angle > min Angle ? 0 : 4$$

After the LaserIdx of a point is decoded, prediction decoding may be performed on the current point in the Z-axis direction by using the LaserIdx corresponding to the current point. That is to say, the depth information radius of a cylindrical coordinate system is firstly calculated by using the x-axis and y-axis geometric information of the current point, and secondly, the tangent value of the current point and the offset of the current point in the vertical direction are obtained using the laser LaserIdx of the current point, so that the predicted value of the current point in the Z-axis direction, i.e., Z_pred, can be obtained.

$$int radius = \sqrt{( pointPos [ 0 ] - LidarOrigin [ 0 ] ) 2 + ( pointPos [ 1 ] - LidarOrigin [ 1 ] ) 2}$$

$$int tan Theta = tan {θ}_{laserIdx}$$

$$int zOffset = {Z}_{laserIdx}$$

$$Z\_pred = radius \times tan Theta - zOffset$$

Finally, Z_res and Z_pred obtained by decoding are used to reconstruct and restore the geometric information of the current point in the Z-axis direction.

For the triangle soup (trisoup)-based geometric information encoding, in the trisoup-based geometric information encoding framework, geometric partitioning is also performed firstly, but different from the binary tree/quadtree/octree-based geometric information encoding, the trisoup-based geometric information encoding does not need to progressively partition a point cloud into unit cubes each with the size of 1×1×1, but stops the partitioning when an edge length of a block (sub-block) is W. Based on a surface formed by distribution of the point cloud in each block, at most twelve vertexes generated by the surface and twelve edges of the block are obtained. The vertex coordinates of each block are encoded in turn to generate a binary bitstream.

For trisoup-based point cloud geometric information reconstruction, when point cloud geometric information reconstruction is performed at the decoding end, vertex coordinates are firstly decoded to complete the triangle soup reconstruction, and the process is shown in FIG. 20. Here, there are three vertexes (v1, v2, v3) in the block, and a triangle soup formed by these three vertexes in a certain order is called triangle soup, i.e., trisoup. Then, sampling is performed on the triangle soup, and the obtained sampling points are used as the reconstructed point cloud in the block.

For predictive geometric encoding (denoted as PredGeom Tree), the PredGeom Tree includes: sorting input point clouds. Currently used sorting methods include: no order, Morton order, azimuth order, or radial distance order. At the encoding end, the prediction tree structure is established in two different manners including: k-dimensional tree (KD-Tree) (that is a high-delay slow mode) and a low-delay fast mode (which uses lidar calibration information). When the lidar calibration information is used, all points are partitioned onto different lasers, and a prediction structure is established based on different lasers. Then, based on the structure of the prediction tree, all nodes in the prediction tree are traversed; and the geometric position information of each node is predicted by selecting different prediction modes to obtain prediction residuals, and the geometric prediction residuals are quantized by quantization parameters. Finally, the prediction residual, prediction tree structure and quantization parameters of node position information in prediction tree are encoded through continuous iteration to generate a binary bitstream.

For the predictive geometric encoding, the decoding end reconstructs the prediction tree structure by continuously parsing the bitstream, and then obtains prediction residual information and quantization parameters of the geometric position of each prediction node through the parsing. The inverse quantization is performed on the prediction residual to recover and obtain the synthesis geometric position information of each node, and finally the geometric synthesis is completed at the decoding end.

After the geometric encoding is completed, the geometric information is required to be reconstructed. At present, attribute encoding is mainly for color information. Firstly, color information is transformed from RGB space to YUV space. Then, a point cloud is re-shaded by using reconstructed geometric information, so that un-encoded attribute information corresponds to the reconstructed geometric information. In the process of color information encoding, two transform methods exist: one is a distance-based lifting transform depending on LOD partitioning, and another is a direct RAHT transform. In both two methods, color information will be transformed from a spatial domain to a frequency domain, high frequency coefficients and low frequency coefficients will be obtained through the transform, and then the coefficients are quantized and encoded to generate a binary bitstream, as shown in FIG. 4A and FIG. 4B for details.

When prediction is performed on attribute information based on geometric information, nearest-neighbor search may be performed by using Morton codes, and the Morton code corresponding to each point in a point cloud may be obtained from geometric coordinates of the point. The specific method of calculating Morton codes is described as follows. For 3D coordinates where each component is represented by a d-bit binary number, three components thereof are represented as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} . \qquad ( 9 )$$

Here, [symbol] ∈{0,1} are binary numbers respectively corresponding to the highest bit ( [symbol] =1) to the lowest bit ( [symbol] =d) of x, y, and z. In the Morton code M, starting from the highest bit of x, y, and z, [symbol] are arranged alternately in turn to the lowest bit. The calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 10 )$$

Here, [symbol] ∈{0,1} are values from the highest bit ( [symbol] ′=1) of M to the lowest bit ( [symbol] ′=3d) of M, respectively. After the Morton code M of each point in the point cloud is obtained, the points in the point cloud are arranged according to the Morton codes in an ascending order, and the weight value w of each point is set to be 1.

It is also to be understood that for the G-PCC codec framework, the common test conditions are as follows.

(1) There are 4 kinds of test conditions:
Condition 1: limited lossy for geometric position, and lossy for attribute;
Condition 2: lossless for geometric position and lossy for attribute;
Condition 3: lossless for geometric position and limited lossy for attribute; and
Condition 4: lossless for geometric position and lossless for attribute.

(2) The common test sequence includes four categories: Cat1A, Cat1B, Cat3-fused, and Cat3-frame. The Cat2-frame point cloud includes only reflectance attribute information, the Cat1A point cloud and Cat1B point cloud include only color attribute information, and the Cat3-fused point cloud includes both color and reflectance attribute information.

(3) For the technology roadmaps, there are two types in total, which are distinguished by algorithms used in geometry compression.

### Technology Roadmap 1: Octree Encoding Branch

At the encoding end, a bounding box is partitioned in sequence to obtain sub-cubes, and non-empty sub-cubes (including points in a point cloud) are continuously partitioned until partitioned leaf nodes become unit cubes each with a size of 1×1×1. In the case of geometry lossless encoding, the number of points included in the leaf nodes is required to be encoded, and finally the geometry octree encoding is completed to generate a binary bitstream.

At the decoding end, according to the breadth-first traversal order, the decoding end continuously performs parsing to obtain the placeholder code of each node, and node partitioning is continuously performed in sequence until a unit cube with a size of 1×1×1 is obtained by the partitioning. In the case of lossless geometric decoding, it is necessary to obtain the number of points included in each leaf node by the parsing, and finally geometric synthesis information of the point cloud is recovered.

### Technology Roadmap 2: Prediction Tree Encoding Branch

At the encoding end, the prediction tree structure is established in two different manners including: a manner of depending on k-dimensional tree (KD-Tree) (which is a high-delay slow mode) and a manner of using lidar calibration information (which is a low-delay fast mode). By using the lidar calibration information, all points are partitioned onto different lasers, and the prediction structure is established according to different lasers. Then, based on the structure of the prediction tree, all nodes in the prediction tree are traversed; and the geometric position information of each node is predicted by selecting different prediction modes to obtain prediction residuals, and the geometric prediction residuals are quantized by quantization parameters. Finally, the prediction residual, prediction tree structure and quantization parameters of node position information in prediction tree are encoded through continuous iteration to generate a binary bitstream.

At the decoding end, the decoding end reconstructs the prediction tree structure by continuously parsing the bitstream, and then obtains prediction residual information and quantization parameters of the geometric position of each prediction node through the parsing. The inverse quantization is performed on the prediction residual to recover and obtain the synthesis geometric position information of each node, and finally the geometric synthesis is completed at the decoding end.

For the attribute information encoding, the current G-PCC encoding framework includes three attribute encoding methods: a Predicting Transform (PT), lifting transform (LT) and an RAHT. The PT and LT depend on the generation order of LOD to perform predictive encoding on a point cloud, while the RAHT performs adaptive transform on attribute information from bottom to top based on the construction levels of octree. These three point cloud attribute encoding methods will be described below, respectively.

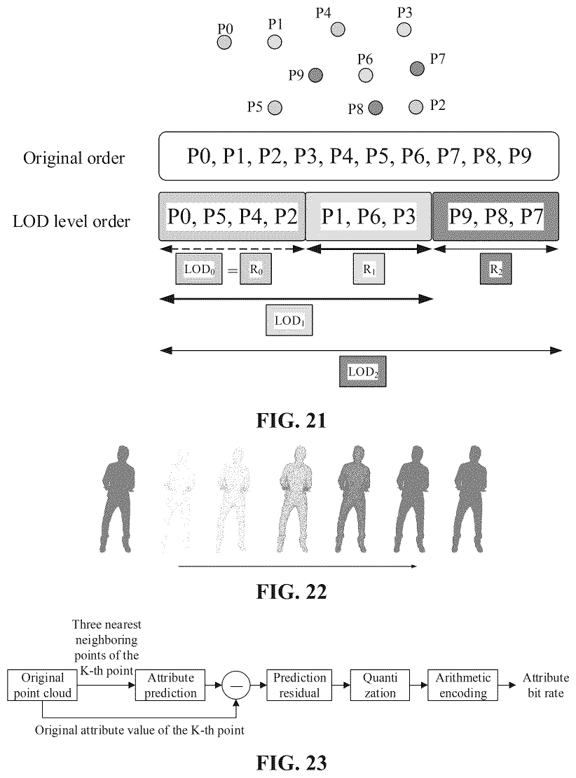

For the predictive encoding of the attribute information of a point cloud, the current attribute prediction module of the G-PCC adopts the nearest neighbor attribute predictive encoding scheme of LOD structure. The LOD construction scheme includes: a distance-based LOD construction scheme, a fixed sampling rate-based LOD construction scheme, and an octree-based LOD construction scheme, etc. In the distance threshold-based LOD construction scheme, before LOD is constructed, Morton sorting is performed on a point cloud to ensure strong attribute correlation between adjacent points. FIG. 21 shows an example of a distance-based LOD construction process, the point cloud is partitioned into L different levels of detail of the point cloud (Rl), where l=0, 1, . . . . L−1, according to L Manhattan distances (dl), where l=0, 1, . . . . L−1 and dl satisfies dl<dl−1, that is preset in advance. An LOD construction process include following four operations: (1) all points in the point cloud are marked as “un-accessed”, and a set V is established to store the accessed points; (2) for each iteration 1, the points in the point cloud are traversed; if the current point has been accessed, the current point is ignored; otherwise, the minimum distance D from the current point to the point set V is calculated, and the current point is ignored if D<dl; otherwise, the current point is marked as accessed and the current point is added into the detailed level Rl and the point set V; (3) the points in LOD1 are composed of points in the detailed levels R0, R1, R2 . . . . Rl; and (4) the above steps are repeated continuously until all points are marked as accessed.

On the basis of the structure of LOD, the attribute value of each point is obtained by performing linear weighted prediction by using the reconstructed attribute value of the points in the same LOD or a higher LOD. The maximum number of referred neighbors is determined by a high layer syntax element of an encoder. For the attribute of each point, at the encoding end, the attributes of searched N nearest neighbor points selected by using the rate-distortion optimization algorithm may be used to perform weighted prediction, or an attribute of a selected single nearest neighbor point may be used to perform the prediction. The selected prediction mode and prediction residual are encoded.

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} A t t {r}_{m} ) . \qquad ( 11 )$$

N represents the number of prediction points in the nearest neighbor point set of point i, Pi represents a set of N nearest neighbor points of the point i, Dm represents the spatial geometric distance from the nearest neighbor point m to the current point i, Attrm represents the reconstructed attribute value of the nearest neighbor point m, Attrᵢ′ represents the predicted attribute value of the current point i, and the number N of points is a preset value in advance.

In order to balance the attribute encoding efficiency and the parallel processing between different LODs, a switch is introduced into the high layer syntax element of the encoder to control whether to introduce intra LOD prediction. If the switch is turned on, intra LOD prediction is started, and the prediction may be performed by using the points in the same LOD. It is to be noted that the intra LOD prediction is always used when the number of the LODs is 1.

FIG. 22 is a visualization result of LOD. As shown in FIG. 22, the points in the first level are an outer contour representing a point cloud. With the increase of LODs, the detailed description of a point cloud gradually becomes clear.

FIG. 23 is a flowchart of G-PCC attribute prediction. In the process of selecting an optimal predicted value, after LOD construction is completed, according to the generation order of LODs, the three nearest neighbor points of the current point to be encoded are firstly found from the encoded data points. The reconstructed attribute values of the three nearest neighbor points are used as candidate predicted values of the current point to be encoded. Then, the optimal predicted value is selected from the candidate predicted values according to the Rate-Distortion Optimization (RDO). For example, when the attribute value of the point P2 in FIG. 18 is encoded, the predictor index of the attribute value of the first nearest neighbor point P4 is set to be 1; the predictor indexes of the attributes of the second nearest neighbor point P5 and the third nearest neighbor point P0 are set to be 2 and 3, respectively; and the predictor index of the weighted average of the point P0, point P5, and point P4 is set to be 0, as shown in Table 1.

| Prediction | |
|---|---|
| Mode | Predicted value |
| 0 | weighted average of attributes of three nearest neighbor points |
| 1 | P4 (attribute value of the first nearest neighbor point) |
| 2 | P5 (attribute value of the second nearest neighbor point) |
| 3 | P0 (attribute value of the third nearest neighbor point) |

Finally, the optimal prediction variable is selected by using the RDO. The formula of the weighted average is as follows:

$${\hat{a}}_{i} = Round ( {\sum }_{j = 0}^{2} \frac{{\tilde{w}}_{i j}}{{\sum }_{j = 0}^{2} {\tilde{w}}_{i j}} {\tilde{a}}_{j} ) , \qquad ( 12 )$$

where \tilde{w}ᵢⱼ represents a spatial geometry weight from the nearest neighbor point j to the current point i:

$${\tilde{w}}_{i j} = \frac{1}{{( {x}_{i} - {x}_{i j} )}^{2} + {( {y}_{i} - {y}_{i j} )}^{2} + {( {z}_{i} - {z}_{i j} )}^{2}} , \qquad ( 13 )$$

where âᵢ represents a predicted attribute value of the current point, j represents the indexes of the three neighbor points, ãⱼ represents a reconstructed attribute value of the nearest neighbor point, xᵢ, yᵢ, zᵢ represent geometric position coordinates of the current point, and xᵢⱼ, yᵢⱼ, zᵢⱼ represent geometric coordinates of the nearest neighbor point j.

In the process of attribute prediction residual and quantization, the predicted attribute value (âᵢ)_{i∈0 . . . k-1} (k is the total number of points in a point cloud) of the current point i is obtained by the above prediction, and i. (aᵢ)_{i∈0 . . . k-1} is set as the initial attribute value of the current point, then the attribute residual (rᵢ)_{i∈0 . . . k-1} is denoted as:

$${r}_{i} = {a}_{i} - {\hat{a}}_{i} . \qquad ( 14 )$$

The prediction residuals are further quantified:

$${Q}_{i} = \frac{{r}_{i}}{Qs} , \qquad ( 15 )$$

where Qᵢ represents the quantized attribute residual of the current point i, Qs is the quantization step (Qs) that may be calculated by quantization parameters (QP) specified by the Common Test Condition (CTC).

For reconstruction of attribute values at the encoding end, the purpose of the reconstruction at the encoding end is for prediction of subsequent points. Before an attribute value is reconstructed, inverse quantization is required to be performed on a residual, and the inverse quantized residual is denoted as \hat{r}ᵢ:

$${\hat{r}}_{i} = {Q}_{i} \times Q s \qquad ( 16 )$$

\hat{r}ᵢ is added to the predicted value âᵢ to obtain the reconstructed value ãᵢ of the point i:

$${\tilde{a}}_{i} = {\hat{r}}_{i} + {\hat{a}}_{i} \qquad ( 17 )$$

At present, there are two categories of algorithms for attribute nearest-neighbor search based on LOD partitioning: intra nearest-neighbor search and inter nearest-neighbor search. Here, intra nearest-neighbor search is classified into two algorithms: inter-level nearest-neighbor search and intra-level nearest-neighbor search.

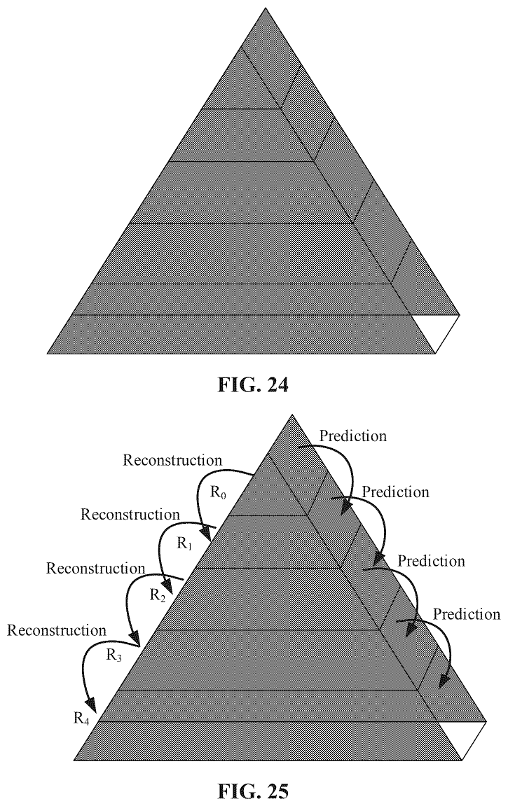

FIG. 24 is a schematic diagram of LOD partitioning. As shown in FIG. 24, after LOD partitioning, a structure similar to a pyramid structure is obtained.

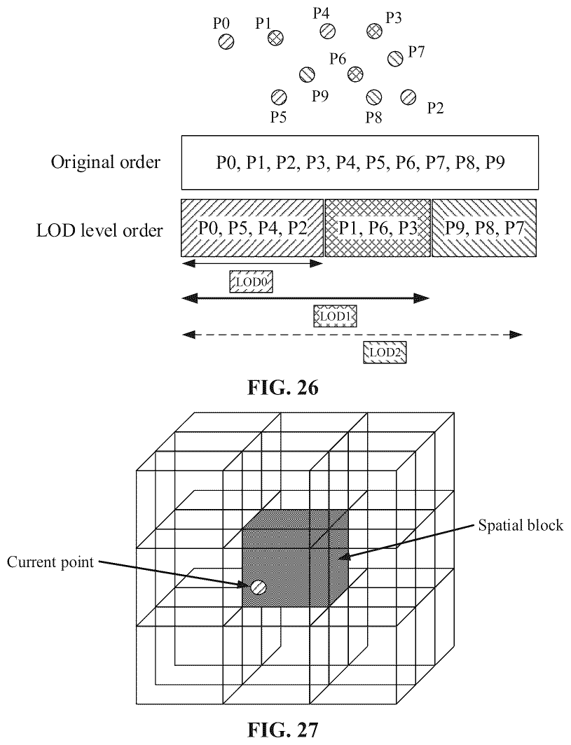

FIG. 25 is a first schematic diagram of inter-level nearest-neighbor search. FIG. 26 is a second schematic diagram of inter-level nearest-neighbor search. As shown in FIG. 25 and FIG. 26, in the process of performing inter-level nearest-neighbor search, partitioning is performed based on geometric information to obtain different LOD levels which are LOD0, LOD1 and LOD2. Then, the points in the LOD0 may be used to predict the attributes of the points in the next LOD level.

The whole process of intra nearest-neighbor search may be introduced in detail below.

It is to be understood that, in the entire LOD partitioning, there are three sets, O(k), L(k) and I(k). Here, k is an index of a LOD level in the LOD partitioning, I(k) is an input point set for partitioning the current LOD level. After the LOD partitioning, the set O(k) and the set L(k) are obtained, the set O(k) stores a set of sampling nodes, and L(k) is a point set of the current LOD level. That is to say, the whole process of LOD partitioning is as follows:
(1) Initialization
if k=0, (k)←{ }, otherwise (k)←L(k−1)
O(k)←{ }
(2) using the LOD partitioning algorithm to store the sampling points into O(k) and partition the remaining points into L(k)
(3) Next iteration: I←O(k)

It is to be noted that since the entire LOD partitioning is performed based on Morton codes, O(k), L(k) and I(k) store the indexes of Morton codes corresponding to points.

When inter-level nearest-neighbor search is performed, the nearest-neighbor search is performed on the set O(k) for the points in the set L(k). The specific search algorithm is as follows.

The nearest-neighbor search is performed based on a spatial relationship. FIG. 27 is a schematic diagram of a spatial relationship. As shown in FIG. 27, when the current point P is predicted, the neighbor search is performed by using the parent block (i.e., the block B) corresponding to the point P, and the points in the neighbor block that is coplanar and collinear with the current parent block are searched for to perform attribute prediction.

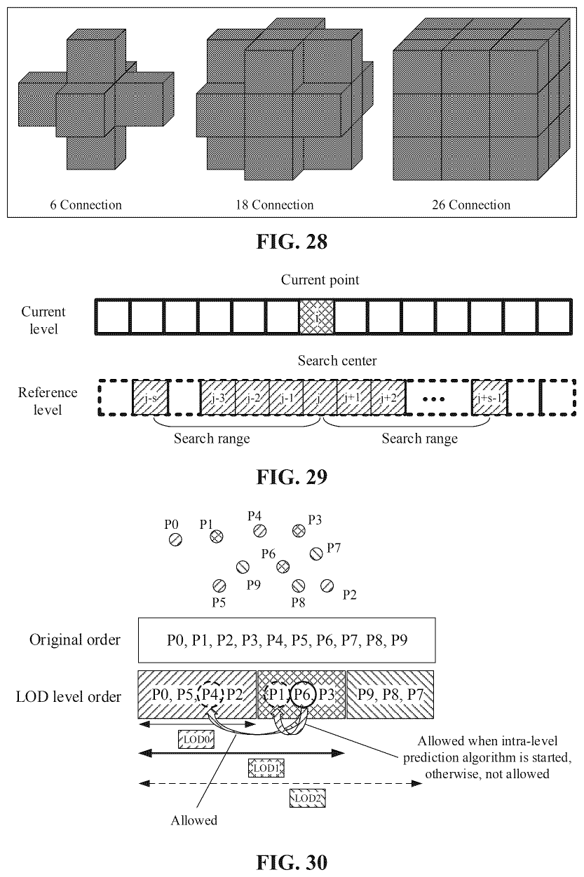

FIG. 28 is a second schematic diagram of a spatial relationship. As shown in FIG. 28, there are 6 coplanar neighbor points of the current point, 18 collinear neighbor points of the current point, and 26 co-point neighbor points of the current point.

Firstly, a corresponding spatial block is obtained by using the coordinates of the current point, and secondly, the nearest-neighbor search is performed on the previously encoded LOD level, and the spatial block that is coplanar, co-linear and co-point with the current block is searched for to obtain the N nearest neighbor points of the current point.

When the N nearest neighbor points of the current point are still not obtained after the coplanar, collinear and co-point nearest-neighbor search, the N nearest neighbor points of the current point may be obtained based on the fast search algorithm. FIG. 29 is a first schematic diagram of a fast search algorithm. As shown in FIG. 29, when attribute inter-level prediction is performed, firstly, the Morton code corresponding to a current point is obtained by using the geometric coordinates of the current point to be encoded; secondly, the first reference point (j) larger than the Morton code of the current point is found from a reference frame based on the Morton code of the current point; and then, the nearest-neighbor search is performed within the range of [j−searchRange, j+searchRange].

Other specific algorithms for updating a nearest neighbor point are consistent with the inter nearest-neighbor search algorithm, and the specific algorithm may be mentioned in the inter nearest-neighbor search algorithm.

FIG. 30 is a schematic diagram of attribute intra-level nearest-neighbor search. As shown in FIG. 30, for the intra-level nearest-neighbor search, when the intra-level prediction algorithm is started, the nearest-neighbor search may be performed in a encoded point set in the same LOD level to obtain the N nearest neighbor points of the current point (in this case, the inter-level nearest-neighbor search is also performed).

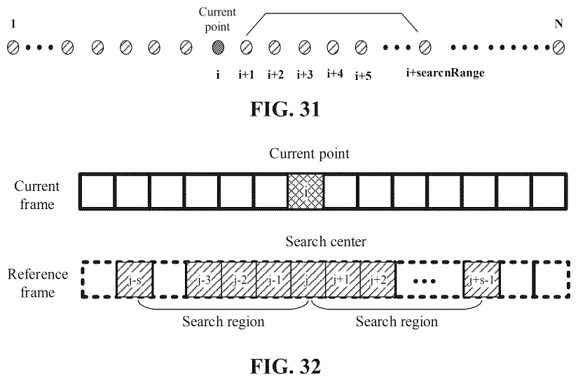

When attribute intra-level prediction is performed, the nearest-neighbor search may be performed based on the fast search algorithm. FIG. 31 is a second schematic diagram of a fast search algorithm. As shown in FIG. 31, it is assumed that the index of the Morton code of a current point is i, the nearest-neighbor search may be performed in a range of [i+1, i+searchRange]. The specific nearest-neighbor search algorithm matches with the inter-block based fast search algorithm.

Furthermore, for the inter nearest-neighbor search, FIG. 32 is a third schematic diagram of a fast search algorithm. As shown in FIG. 32, when attribute inter prediction is performed, firstly, the Morton code corresponding to a current point is obtained by using the geometric coordinates of the current point to be encoded; secondly, the first reference point (j) larger than the Morton code of the current point is found from a reference frame based on the Morton code of the current point; and then, the nearest-neighbor search is performed within the range of [j−searchRange, j+searchRange].

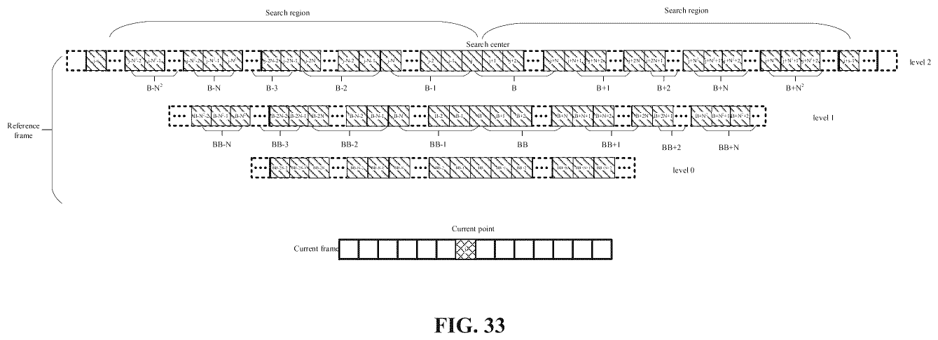

When the current intra nearest-neighbor search and the inter nearest-neighbor search are performed, the neighborhood search is performed based on blocks. FIG. 33 is a fourth schematic diagram of a fast search algorithm. As shown in FIG. 33, when the neighborhood search is performed for a current point (having the index i of the Morton code), the points in a reference frame are firstly partitioned into N (N=3) levels based on the Morton codes. The specific partitioning algorithm is as follows:
For a first level, it is assumed that the points in the reference frame is numPoints, and every M (M=2⁵=32) points among the points in the reference frame may be firstly partitioned into one block.
For a second level, based the first level, similarly, every M (M=2⁵=32) blocks among the blocks of the first level are also partitioned into one block in the order of Morton codes.
For a third level, based the second level, similarly, every M (M=2⁵=32) blocks among the blocks of the first level are also partitioned into one block in the order of Morton codes.

Finally, the prediction structure shown in FIG. 33 is obtained. Then, attribute prediction is performed based on the prediction structure as shown in FIG. 33. It is assumed that the index of the Morton code of a current point to be encoded is i, firstly, the first point greater than or equal to the Morton code of the current point is obtained from a reference frame, and has the index j. Secondly, the block index of the reference point is calculated based on j, and the specific calculation method is as follows:
For the first level, BucketSize_0−2⁵=32.
For the second level, BucketSize_1=2⁵=32×BucketSize_0=1024.
For the third level, BucketSize_2=2⁵=32×BucketSize_1=32768.

It is assumed that the reference range in the prediction picture of the current point is [j−searchRange, j+searchRange], the starting index of the third level is calculated by j−searchRange, and the termination index of the third level is calculated by j+searchRange. Secondly, it is firstly determined whether the nearest-neighbor search is required to be performed on the blocks of the third level for some blocks of the second level; and secondly, at the second level, it is determined whether the search is required to be performed for each block of the first level. If the nearest-neighbor search is required to be performed for some blocks of the first level, the determination may be performed on each point in the some blocks of the first level to update the nearest neighbor points.

For the algorithm of calculating a block based on an index, it is assumed that the Morton code index corresponding to the current point is index, then the index of the corresponding block in the third level is:

$$idx\_ 2 = index / BucketSize\_ 2$$

After the index idx_2 of the block of the third level is obtained, the starting index and the end index of the block corresponding to the current block in the second level may be obtained by using idx_2:

$$startIdx 1 = idx\_ 2 \times BucketSize\_ 1 ; and$$

$$endIdx = idx\_ 2 \times BucketSize\_ 1 + BucketSize\_ 1 - 1.$$

Similarly, based on the same algorithm, the index of block of the first level is obtained based on the index of the block of the second level.

When nearest-neighbor search is performed based on blocks, it may be firstly determined whether the nearest-neighbor search is required to be performed for a current block, i.e., the nearest-neighbor search of the block is filtered. Each spatial block may be obtained by two variables: minPos and maxPos. minPos represents the minimum value of the block, and maxPos represents the maximum value of the block.

It is assumed that the farthest point among the searched N nearest neighbor points has a distance Dist from the current point, the coordinates of a point to be encoded are (x, y, z), and a current block is expressed as (minPos, maxPos), where minPos is the minimum value of the bounding box in three dimensions and maxPos is the maximum value of the bounding box in three dimensions, then, the distance D between the current point and the bounding box is calculated as follows:

$$int dx = int ( std \text{::} max ( std \text{::} max ( min Pos [ 0 ] - point [ 0 ] , 0 , point [ 0 ] - max Pos [ 0 ] ) ) ;$$

$$int dy = int ( std \text{::} max ( std \text{::} max ( min Pos [ 1 ] - point [ 1 ] , 0 ) , point [ 1 ] - max Pos [ 1 ] ) ) ;$$

$$int dz = int ( std \text{::} max ( std \text{::} max ( min Pos [ 2 ] - point [ 2 ] , 0 ) , point [ 2 ] - max Pos [ 0 ] ) ) ;$$

$$D = dx + dy + dz ;$$

When D is less than or equal to Dist, the points in the current block will be traversed.

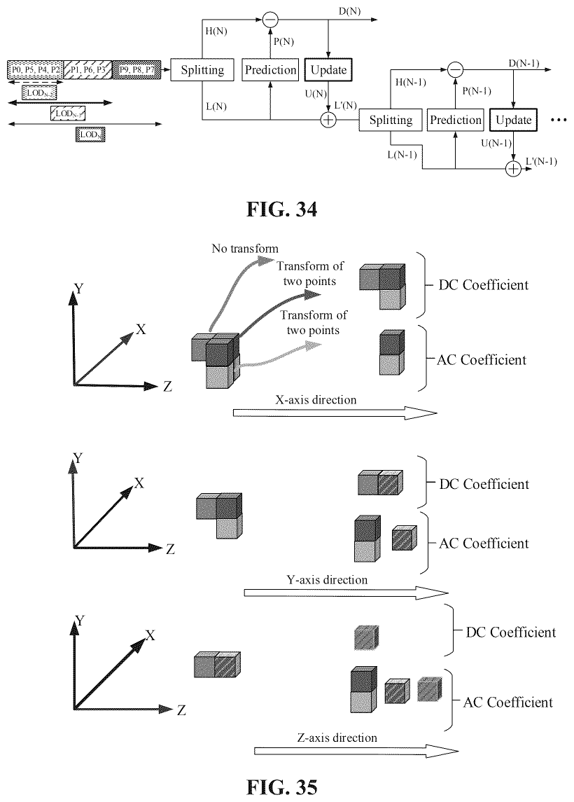

FIG. 34 is a flowchart of lifting transform. As shown in FIG. 34, in the lifting transform, predictive encoding is also performed on point-cloud attributes based on LOD hierarchy. The lifting transform is different from the predictive transform in that LOD is firstly partitioned into high levels and low levels, prediction proceeds in the inverse order of LOD generation, and an update operator is injected during the prediction to update quantization weights of points in low LOD, thereby improving the prediction accuracy. This is because the attribute values of the points in low LOD will be frequently used to predict the attribute values of the points in high LOD, and the points in low LOD should have greater influence.

### Step 1: Splitting

Splitting is to partition a full LOD stack into low LOD L(N) and high LOD H(N). If a point cloud has a three-level LOD, i.e., (LODₗ)_{l=0,1,2}, after splitting, LOD₂ as high LOD is denoted as H(N), and (LODₗ)_{l=0,1} as low LOD is denoted as L(N).

### Step 2: Prediction

For a point in the high LOD, the attribute information of the nearest neighbor point selected from the low LOD is used as the predicted attribute value P(N) of the current point to be encoded, and the prediction residual D(N) is denoted as:

$$D ( N ) = H ( N ) - P ( N ) . \qquad ( 18 )$$

### Step 3: Updating

The attribute prediction residual D(N) of the high LOD is updated to obtain U(N), and the attribute value of the point in the low LOD may be lifted by using U(N), as shown in the following formula:

$${L}^{′} ( N ) = L ( N ) + U ( N ) . \qquad ( 19 )$$

The above process may be iterated down to the lowest LOD in the order of LOD levels from high to low.

Because the LOD-based prediction scheme makes the points in the low LOD have greater influence, in the lifting wavelet transform-based transform scheme, the quantization weight is introduced; and a prediction residual is updated according to the prediction residual D(N) and the distance between a point to be predicted and a neighbor point; and finally, the quantization weight in the transform process is used to adaptively quantize the prediction residual. It is to be noted that the quantization weight value of each point may be determined by geometric synthesis at the decoding end, therefore, the quantization weight is not required to be encoded.

The RAHT is a kind of Haar wavelet transform, which may transform the attribute information of a point cloud from the spatial domain to the frequency domain, thereby reducing the correlation between attributes of the point cloud. FIG. 35 is a schematic diagram of a process of RAHT transform along three directions x, y and z. As shown in FIG. 35, according to the octree structure, the transform is performed, in a manner from bottom to top, on the nodes in each level respectively in three dimensions x, y and z, until the transform is iterated to the root node of the octree.

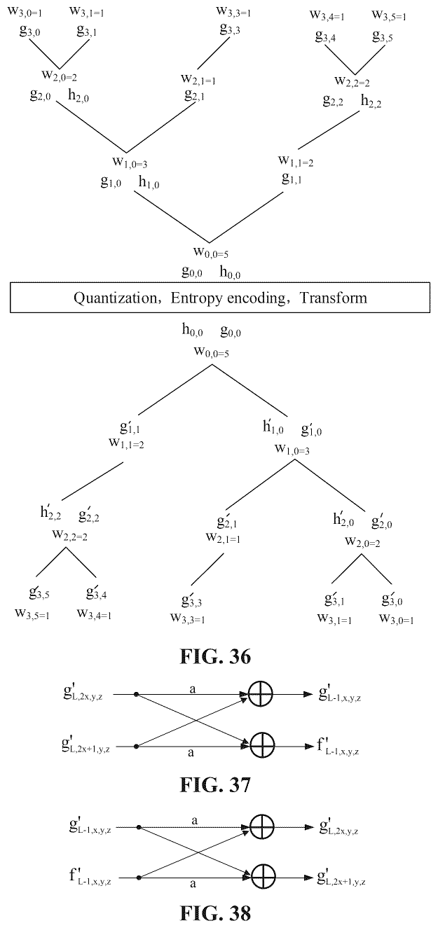

FIG. 36 is a schematic diagram of RAHT transform. As shown in FIG. 36, in the RAHT, wavelet transform is performed based on the hierarchical structure of the octree; attribute information is associated with octree node, recursive transform is performed, in the manner from bottom to top, on the attributes of occupied nodes in the same parent node; and transform is performed on the nodes in each level respectively in three dimensions x, y and z, until the transform is performed on the root node of the octree. In the process of hierarchical transform, the low-pass (DC) coefficients obtained after the transform performed on the nodes in the same level are transported to the nodes in the next level to continue to perform the transform, while all the high-pass (AC) coefficients are encoded by an arithmetic encoder.

During the transform process, the transformed DC coefficients (i.e., the direct current (DC) component) of the nodes in same level may be transported to the upper level to continue to perform the transform, and the transformed AC coefficient (i.e., the Alternating Current (AC) component) of each level will be quantized and encoded. The main transform process is described below.

FIG. 37 is a schematic diagram of RAHT transform. FIG. 38 is a schematic diagram of inverse RAHT transform. As shown in FIG. 37 and FIG. 38, it is assumed that

$${g}_{L , 2 x , y , z}^{′} and {g}_{L , 2 x + 1 , y , z}^{′}$$

are two attribute DC coefficients of nearest adjacent points in the L level. After the linear transform, the information of L−1 level is AC coefficient

$${f}_{L - 1 , x , y , z}^{′}$$

and DC coefficient

$${g}_{L - 1 , x , y , z}^{′} .$$

### Then,

$${f}_{L - 1 , x , y , z}^{′}$$

is no longer transformed, and is directly quantized and encoded. For the g′_{L-1,x,y,z}, search for the nearest neighbor point is continued to perform the transform. If the nearest neighbor point cannot be found,

$${g}_{L - 1 , x , y , z}^{′}$$

will be directly transported to the L−2 level. That is to say, the RAHT transform is valid for only nodes having a neighbor point, and nodes without a neighbor point will be directly transported to the upper layer. During the above transform process, weights (the number of non-empty child nodes in the node) corresponding to

$${g}_{L , 2 x , y , z}^{′} and {g}_{L , 2 x + 2 , y , z}^{′}$$

are

$${w}_{L , 2 x , y , z}^{′} and {w}_{L , 2 x + 1 , y , z}^{′}$$

(shorted as

$${w}_{0}^{′} and {w}_{1}^{′} ) ,$$

respectively. The common transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] , \qquad ( 20 )$$

where T_{w0,w1} is a transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 21 )$$

The transform matrix may be updated adaptively as the corresponding weight of each point. The above process will be iteratively updated according to the partitioning structure of the octree until reaching to the root node of the octree.

At present, in the G-PCC, in the process of attribute inter prediction, a block-based fast search algorithm is adopted to obtain the nearest neighbor point of each point from a reference frame. In this process, after the nearest-neighbor search is performed for each level, the current G-PCC will update the set storing the indexes of the Morton codes of inter points, update the index of the Morton code corresponding of each point into the index of the point, i.e., the index of the set is updated from the Morton code of the point to the index of the point. Based on this algorithm, in the subsequent nearest-neighbor search, the problem that the searched index of the nearest neighbor point is the index of the point rather than the index of the Morton code corresponding to the nearest neighbor point may be cased, which often causes the found nearest neighbor point to not be the real neighbor point, thereby finally reducing the attribute codec efficiency.

That is to say, the common attribute codec method has a problem that the optimal nearest neighbor point cannot be accurately found, which affects the prediction effect for the attribute information and reduces the codec efficiency and performance.

In order to solve the above problem, in the embodiments of the present disclosure, when the encoding/decoding end performs inter prediction on an attribute of a point cloud, it is ensured that when the nearest-neighbor search is performed on each LOD level, it can be ensured that the index of the neighborhood point found for each point is an index of a Morton code. The specific reason is that in the process of nearest-neighbor search performed by existing G-PCC for attributes, the nearest-neighbor search is performed based on Morton codes. Therefore, if it is ensured that the nearest-neighbor search is performed based on the index of a Morton code point set in the subsequent nearest-neighbor search, the nearest neighbor point can be accurately found when the inter attribute prediction is performed, and the encoding efficiency for the attributes of the point cloud can be improved.

An embodiment of the present disclosure provides a encoding and a decoding method. For a node to be processed in a LOD M of a current frame, an encoder and a decoder may determine a reference point from a prediction point set of a reference frame for the current frame according to first Morton code information corresponding to the node to be processed, where M is an integer greater than 1, and an index of a point in the prediction point set of the reference frame is determined based on Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node. As can be seen that, in the embodiments of the present disclosure, each of the encoder and the decoder needs to determine the reference point from the prediction point set of the reference frame in the process of performing inter prediction on the attribute information, the index of each point in the prediction point set of the reference frame is determined based on the Morton code information of the point, i.e., the index of the point in the prediction point set of the reference frame is the Morton code of the point, so that the corresponding reference point may be found by using the Morton code, thereby ensuring that the nearest neighbor node is obtained by using the Morton code in the subsequent nearest-neighbor search process based on the reference point. That is to say, in the embodiments of the present disclosure, it is possible to ensure that the optimal nearest neighbor point can be accurately found by ensuring that the index of each point in the prediction point set of the reference frame is the Morton code of the point, thereby improving the prediction effect for the attribute information and improving the codec efficiency and performance.

The prediction effect for attribute information can be improved and the codec efficiency and performance can be improved.

Hereafter, various embodiments of the present disclosure will be described in detail with reference to the accompanying drawings.

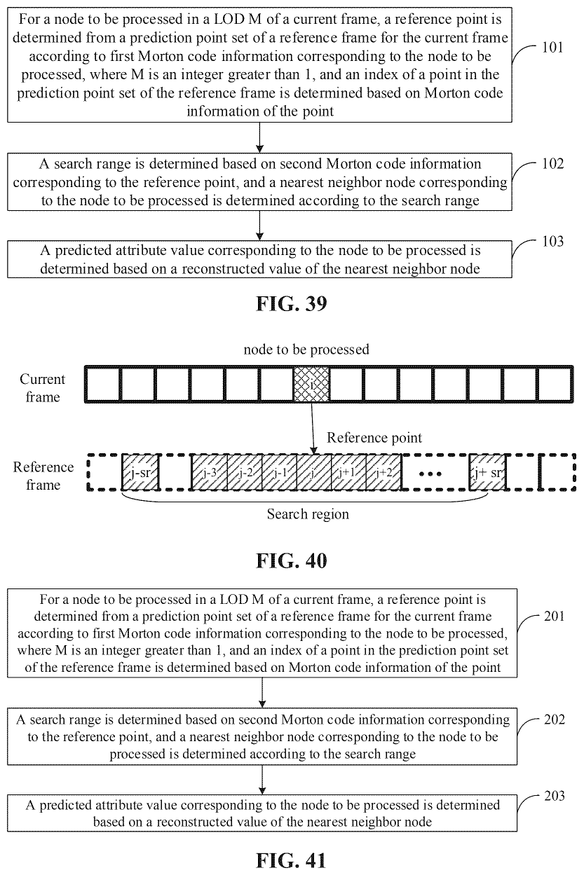

In an embodiment of the present disclosure, with reference to FIG. 39, a flowchart of a decoding method according to an embodiment of the present disclosure is shown. As shown in FIG. 39, the method may include operation S101 to operation 103.

In operation S101, for a node to be processed in an M-th LOD level (LOD M) of a current frame, a reference point is determined from a prediction point set of a reference frame for the current frame according to first Morton code information corresponding to the node to be processed, where M is an integer greater than 1, and an index of a point in the prediction point set of the reference frame is determined based on Morton code information of the point.

In the embodiments of the present disclosure, when inter prediction is performed for attribute information, for the node to be processed in the LOD M of the current frame, the reference point may be determined from the prediction point set of the reference frame for the current frame according to first Morton code information corresponding to the node to be processed.

It is to be noted that the decoding method according to the embodiments of the present disclosure specifically refers to a point cloud decoding method, and the method may be applied to a point cloud decoder (also referred to as a “decoder” for short).

Accordingly, in the embodiments of the present disclosure, the current frame may be a video frame to be decoded, and the reference frame may be a decoded neighbor frame.

Furthermore, in the embodiments of the present disclosure, the node to be processed corresponds to one piece of geometric information and one piece of attribute information. Here, the geometric information represents the spatial relationship of a point, and the attribute information represents the information related to the attributes of the point.

Here, the attribute information may be color information, a reflectance, or other attributes, which is not limited in the embodiments of the present disclosure. When the attribute information is color information, specifically, the attribute information may be color information of any color space. Exemplarily, the attribute information may be the color information of the RGB space, the color information of the YUV space, the color information of the YCbCr space, or the like, which is not limited in the embodiments of the present disclosure.

Furthermore, in the embodiments of the present disclosure, partitioning may be firstly performed on the current frame, and then at least one LOD level may be determined. That is to say, in the present disclosure, the current frame may be partitioned into any number of LOD levels after the partitioning is performed. The number of LOD levels of the current frame is not limited in the embodiments of the present disclosure.

It is to be noted that, in the embodiments of the present disclosure, the partitioning may be performed on the nodes in the current frame according to the Morton code information of the nodes in the current frame.

Furthermore, in the embodiments of the present disclosure, the partitioning may be firstly performed on the reference frame, and then at least one LOD level may be determined. That is to say, in the present disclosure, the current frame may be partitioned into any number of LOD levels after the partitioning is performed. The number of LOD levels in the current frame is not limited in the embodiments of the present disclosure.

It is to be noted that, in the embodiments of the present disclosure, the partitioning may be performed on the nodes in the reference frame according to the Morton code information of the nodes in the reference frame.

Furthermore, although the number of LOD levels of the current frame or of the reference frame after the partitioning is not limited in the embodiments of the present disclosure, it is necessary to ensure that the number of LOD levels of the current frame after the partitioning is the same as the number of LOD levels of the reference frame after the partitioning.

Exemplarily, in some embodiments, the current frame may be partitioned into N LOD levels based on Morton codes of nodes in the current frame. That is to say, after the partitioning is performed on the nodes in the current frame according to the Morton code information of the nodes in the current frame, N LOD levels corresponding to the current frame may be determined.

Exemplarily, in some embodiments, the reference frame may be partitioned into N LOD levels based on Morton codes of nodes in the reference frame. That is to say, after the partitioning is performed on the nodes in the reference frame according to the Morton code information of the nodes in the reference frame, N LOD levels corresponding to the reference frame may be determined.

It is to be noted that, in the embodiments of the present disclosure, for the LOD of the current frame obtained after the partitioning, the LOD may include at least one point. Here, for the at least one point in the LOD, when the decoding is performed on the LOD, the at least one node may be used as the node to be decoded in the LOD, i.e. the node to be processed.

It is to be noted that, in the embodiments of the present disclosure, M is an integer greater than 1, i.e., the value of M may be 2, 3, 4, . . . . That is to say, when the inter prediction processing is performed on the attribute information of the current frame, for each of LOD levels other than a 1^{st} LOD level (LOD 1) of the current frame, the reference point may be determined from a prediction point set of a reference frame corresponding to the LOD according to the first Morton code information corresponding to the node to be processed in the LOD.

It is to be understood that in the embodiments of the present disclosure, it is necessary to ensure that M is an integer greater than 1 and less than or equal to N.

It is to be noted that, in the embodiments of the present disclosure, the prediction point set of the reference frame may be a set for storing all or part of the points in the reference frame and used for performing the prediction processing on the current frame. That is to say, the prediction point set of the reference frame may store all the points in the reference frame, or store only some points in the reference frame.

Exemplarily, in some embodiments, the prediction point set of the reference frame may be a node set of the reference frame, and the node set may include all nodes in the reference frame.

Exemplarily, in some embodiments, the prediction point set of the reference frame may be a first set corresponding to the LOD M of the reference frame, and the input points of the LOD M of the reference frame in the LOD partitioning is stored in the first set corresponding to the LOD M.

It is to be understood that in the embodiments of the present disclosure, in the entire LOD partitioning, there are three sets, specifically including a first set I(M), a second set O(M), and a third set L(M). M is an index of a LOD level in the LOD partitioning, I(M) is an input point set for partitioning the current LOD level. After the LOD partitioning, the set O(M) and the set L(M) are obtained, the set O(M) stores a sampling node set, and L(M) is a point set of the current LOD level.

Furthermore, in the embodiments of the present disclosure, an index of a point in the prediction point set of the reference frame may be determined based on Morton code information of the point. The Morton code information of the point may be the Morton code corresponding to the point, and the Morton code may be obtained from the geometric coordinates of the point.

That is to say, in the embodiments of the present disclosure, regardless of the prediction point set of the reference frame storing all points in the reference frame or some points in the reference frame, an index of a point in the prediction point set is determined based on the Morton code information of the point. For example, the index of the point in the node set of the reference frame may be determined based on the Morton code information of the point in the node set, or, the index of the point in the first set corresponding to the LOD M of the reference frame may be determined based on the Morton code information of the point in the first set.

It is to be understood that, in the embodiments of the present disclosure, if the prediction point set of the reference frame is the node set of the reference frame, the points may be sorted according to the Morton code information of the points in the node set, and finally the indexes of the points in the node set of the reference frame can be obtained.

Exemplarily, in the embodiments of the present disclosure, it is assumed that the node set of the reference frame includes 10 nodes of P0, P1, P2, . . . , and P9, and the initial order of the 10 nodes is the initial point index, i.e., P0, P1, P2, . . . , and P9. After the sorting is performed according to the ascending order of the Morton codes of the 10 nodes, the order of P4, P1, P3, P9, P2, P0, P6, P5, P7, and P8 is finally obtained. That is to say, the indexes of the finally sorted points 0 to 9 in the node set of the reference frame may be P4, P1, P3, P9, P2, P0, P6, P5, P7 and P8.

It is to be understood that, in the embodiments of the present disclosure, if the prediction point set of the reference frame is the first set I(M) corresponding to the LOD M of the reference frame, input points of the LOD M may be sorted according to Morton code information of the points in the first set I(M) corresponding to the LOD M, and finally, indexes of points in the first set I(M) corresponding to the LOD M of the reference frame may be obtained.

Exemplarily, in the embodiments of the present disclosure, it is assumed that I(M) of the reference frame includes 6 nodes of P0, P1, P2, P3, P4 and P5, and the initial order of the 6 nodes is the initial point index, i.e., P0, P1, P2, P3, P4 and P5. After the sorting is performed according to the ascending order of the Morton codes of the 6 nodes, the order of P2, P1, P3, P5, P6 and P4 is finally obtained. That is to say, the indexes of the finally sorted points 0 to 5 in the I(M) of the reference frame may be P2, P1, P3, P5, P6 and P4.

Furthermore, in the embodiments of the present disclosure, the first Morton code information corresponding to the node to be processed may be the Morton code of the node to be processed, and the first Morton code information may be obtained from geometric coordinates of the node to be processed.

That is to say, in the embodiments of the present disclosure, the geometric coordinates of the node to be processed may be determined firstly, and then the Morton code corresponding to the node to be processed, i.e., the first Morton code information, may be determined according to the geometric coordinates of the node to be processed.

Exemplarily, in some embodiments, it is assumed that the geometric coordinates of the node to be processed are (x, y, z), each geometric component x, y, or z in the three-dimensional coordinates may be respectively represented by a d-bits binary number. Here, the highest bit of the binary number corresponding to each geometric component is 1 and the lowest bit of the binary number corresponding to each geometric component is d. Then, starting from the highest bit of the three geometric components x, y, z, bits of the binary numbers of all geometric components are arranged alternately in sequence, until reaching to the lowest bit. Finally the corresponding Morton code value, i.e., the first Morton code information, of the node to be processed, may be determined.

It is to be understood that in the embodiments of the present disclosure, since the prediction point set of the reference frame may be the node set of the reference frame or the first set corresponding to the LOD M of the reference frame, when the reference point of the node to be processed in the LOD M of the current frame is determined, the manner where the reference point is searched in the node set of the reference frame according to the first Morton code information of the node to be processed may be selected, or the manner where the first set corresponding to the LOD M of the reference frame is searched for the reference point according to the first Morton code information of the node to be processed may be selected.

Exemplarily, in some embodiments, when the reference point is determined from the prediction point set of the reference frame for the current frame according to the first Morton code information corresponding to the node to be processed, the reference point corresponding to the node to be processed may be determined from the first set corresponding to the LOD M of the reference frame according to the first Morton code information.

Exemplarily, in some embodiments, when the reference point is determined from the prediction point set of the reference frame for the current frame according to the first Morton code information corresponding to the node to be processed, the reference point corresponding to the node to be processed may be determined from the node set of the reference frame according to the first Morton code information.

It is to be understood that in the embodiments of the present disclosure, regardless of the current frame or the reference frame, during the entire LOD partitioning, the LOD M may include three sets: a first set I(M), a second set O(M), and a third set L(M). Here, the first set I(M) is an input point set for partitioning the LOD M, the second set O(M) set stores a sampling point set of the LOD M, and L(M) is a point set of the LOD M.

Exemplarily, in some embodiments, the first set corresponding to the LOD M of the current frame (i.e., I(M) of the current frame) is used to store input points corresponding to the LOD M of the current frame, and the first set corresponding to the LOD M of the reference (i.e., I(M) of the reference frame) is used to store input points corresponding to the LOD M of the reference frame.

Exemplarily, in some embodiments, the second set corresponding to the LOD M of the current frame (i.e., O(M) of the current frame) is used to store sampling points corresponding to the LOD M of the current frame, and the second set corresponding to the LOD M of the reference (i.e., O(M) of the reference frame) is used to store sampling points corresponding to the LOD M of the reference frame.

Exemplarily, in some embodiments, the third set corresponding to the LOD M of the current frame (i.e., L(M) of the current frame) is used to store points other than points in the second set in the LOD M of the current frame, and the third set corresponding to the LOD M of the reference (i.e., L(M) of the reference frame) is used to store other points than points in the second set in the LOD M of the reference frame.

Furthermore, in the embodiments of the present disclosure, when the LOD partitioning is performed on the points in the reference frame, the partitioning for the LOD M of the reference frame is performed based on the first set corresponding to the LOD M of the reference frame, to determine the second set corresponding to the LOD M of the reference frame and the third set corresponding to the LOD M of the reference frame. That is to say, the second set O(M) of reference frame and the third set L(M) of reference frame may be determined after the LOD partitioning is performed on the first set I(M) of reference frame.

Accordingly, in the embodiments of the present disclosure, when the LOD partitioning is performed on the points in the current frame, the partitioning for the LOD M of the current frame is performed based on the first set corresponding to the LOD M of the current frame, to determine the second set corresponding to the LOD M of the current frame and the third set corresponding to the LOD M of the current frame. That is to say, the second set O(M) of the current frame and the third set L(M) of the current frame may be determined after the LOD partitioning is performed on the first set I(M) of current frame.

It is to be understood that in the embodiments of the present disclosure, regardless of the current frame or the reference frame, since the second set O(M) and the third set L(M) are obtained after the first set I(M) is subjected to the LOD partitioning, and the second set O(M) stores the sampling points, the third set L(M) may store un-sampled points in the LOD M.

Exemplarily, in some embodiments, the node to be processed in the LOD M of the current frame may be a point in the third set corresponding to the LOD M of the current frame.

Furthermore, in the embodiments of the present disclosure, when the LOD partitioning is performed on the points in the reference frame, after the partitioning for the LOD M of the reference frame is performed, a first set corresponding to an (M+1)-th LOD level (LOD (M+1)) of the reference frame may be updated according to the second set corresponding to the LOD M of the reference frame.

It is to be noted that, in the embodiments of the present disclosure, after the update of the first set corresponding to the LOD (M+1) of the reference frame is completed, an index of a point in the first set corresponding to the LOD (M+1) of the reference frame is also determined based on Morton code information of the point in the first set.

It is to be noted that, in the embodiments of the present disclosure, an index of a point in each of the three sets which are the first set, the second set and the third set corresponding to each LOD level of the reference frame may be determined based on Morton code information of the point in each set.

Furthermore, in the embodiments of the present disclosure, when the LOD partitioning is performed on the points in the current frame, after the partitioning for the LOD M of the current frame is performed, a first set corresponding to a LOD (M+1) of the current frame may be updated according to the second set corresponding to the LOD M of the current frame.

It is to be noted that, in the embodiments of the present disclosure, after the update of the first set corresponding to the LOD (M+1) of the current frame is completed, an index of a point in the first set corresponding to the LOD (M+1) of the current frame is also determined based on Morton code information of the point in the first set.

It is to be noted that, in the embodiments of the present disclosure, an index of a point in each of the three sets which are the first set, the second set and the third set corresponding to each LOD level of the current frame may be determined based on Morton code information of the point in each set.

That is to say, in the embodiments of the present disclosure, regardless of the current frame or the reference frame, during the entire LOD partitioning, after the partitioning for the LOD M is completed, the first set I(M+1) corresponding to the LOD (M+1) may be updated based on the second set O(M) corresponding to the LOD M.

Exemplarily, in some embodiments, when the second set O(M) corresponding to the LOD M is used to update the first set I(M+1) corresponding to the LOD (M+1), points in the second set O(M) corresponding to the LOD M may be added into the first set I(M+1) corresponding to the LOD (M+1).

It is to be understood that, in the embodiments of the present disclosure, after the first set I(M+1) corresponding to the LOD (M+1) is updated using the second set O(M) corresponding to the M LOD, the points in the first set I(M+1) corresponding to the LOD (M+1) are still sorted according to the Morton codes of the points, so as to ensure that an index of a point in the finally determined first set I(M+1) corresponding to the LOD (M+1) is also determined based on the Morton code information of the point in the first set.

Furthermore, in the embodiments of the present disclosure, when the LOD partitioning is performed on the points in the reference frame, before the partitioning for the LOD M of the reference frame is performed, the third set corresponding to the LOD M of the reference frame may be initialized according to a third set corresponding to an (M−1)-th LOD level (LOD (M−1)) of the reference frame. Moreover, the second set corresponding to the LOD M of the reference frame is initialized as an empty set.

Accordingly, in the embodiments of the present disclosure, when the LOD partitioning is performed on the points in the current frame, before the partitioning for the LOD M of the current frame is performed, the third set corresponding to the LOD M of the current frame may be initialized according to the third set corresponding to a LOD (M−1) of the current frame. Moreover, the second set corresponding to the LOD M of the current frame is initialized as an empty set

That is to say, in the embodiments of the present disclosure, regardless of the current frame or the reference frame, during the entire LOD partitioning, after the partitioning for the LOD (M−1) is completed and before the partitioning for the LOD M is performed, the third set L(M−1) corresponding to the LOD (M−1) may be used to initialize the third set L(M) corresponding to the LOD M, and the second set corresponding to the LOD M may be initialized as the empty set { }.

Exemplarily, in some embodiments, when the third set L(M) corresponding to the LOD M is initialized by using the third set L(M−1) corresponding to the LOD (M−1), points in the third set L(M−1) corresponding to the LOD (M−1) may be added into the third set L(M) corresponding to the LOD M.

Furthermore, in the embodiments of the present disclosure, when the LOD partitioning is performed on the points in the reference frame, before partitioning for the LOD 1 of the reference frame is performed, a third set corresponding to the LOD 1 of the reference frame may be initialized as an empty set; and after the partitioning for the LOD 1 of the reference frame is performed, a first set corresponding to a 2^{nd} LOD level (LOD 2) of the reference frame may be updated according to a second set corresponding to the LOD 1 of the reference frame.

Accordingly, in the embodiments of the present disclosure, when the LOD partitioning is performed on the points in the current frame, before partitioning for the LOD 1 of the current frame is performed, a third set corresponding to the LOD 1 of the current frame may be initialized as an empty set; and after the partitioning for the LOD 1 of the current frame is performed, a first set corresponding to a 2^{nd} LOD level (LOD 2) of the current frame may be updated according to a second set corresponding to the LOD 1 of the current frame.

That is to say, in the embodiments of the present disclosure, regardless of the current frame or the reference frame, during the entire LOD partitioning, before the partitioning for the LOD 1 is performed, the third set L(1) corresponding to the LOD 1 may be initialized as the empty set { }; moreover, after the partitioning for the LOD 1 is completed, the first set I(2) corresponding to the LOD 2 may be updated according to the second set O(1) corresponding to the LOD 1.

Exemplarily, in some embodiments, regardless of the current frame or the reference frame, during the entire LOD partitioning, each set may be initialized. Before the partitioning for the LOD 1, for the third set (1) of the LOD 1, L(1) may be initialized as the empty set { }. Before the partitioning for the LOD M, i.e. if M is greater than 1, for the third set L(M) of the LOD M, L(M) may be initialized as L(M−1), while for the second set O(M) of the LOD M, O(M) may be initialized as the empty set { }.

Exemplarily, in some embodiments, regardless of the current frame or the reference frame, during the entire LOD partitioning, when each LOD level is partitioned using the LOD partitioning algorithm, sampling points may be stored in (M), the remaining points are partitioned into (M).

Exemplarily, in the embodiments of the present disclosure, regardless of the current frame or the reference frame, during the entire LOD partitioning, after the partitioning for the LOD 1 is completed, the first set I(2) corresponding to the LOD 2 may be updated by using the second set O(1) corresponding to the LOD 1; and moreover, after the partitioning for the LOD M is completed, the first set I(M+1) corresponding to the LOD (M+1) may be updated by using the second set O(M) corresponding to the LOD M.

That is to say, in the embodiments of the present disclosure, regardless of the current frame or the reference frame, the entire LOD partitioning is performed based on the Morton codes of the points, therefore, the index of each point store in each of the O(M), L(M) and I(M) is determined by the Morton code corresponding to the point in the set.

It is to be understood that, in the embodiments of the present disclosure, since the process of selecting the reference point is a process of determining the reference point from the prediction point set of the reference frames by using the first Morton code information of the node to be processed, the key issue for searching for the reference point is the Morton code information of the point. Therefore, it is necessary to ensure that the index of each point in the prediction point set is determined based on the Morton code information of the point, so that the optimal reference point can be determined, and the accuracy of selecting the nearest neighbor point can be improved.

Exemplarily, in some embodiments, it is assumed that the prediction point set of the reference frame is the first set I(M) corresponding to the LOD M of the reference frame, whether the set I(M) of the reference frame is updated or initialized, it is necessary to ensure that the index of each point in the updated or initialized set I(M) is determined based on the Morton code information of the point.

Furthermore, in the embodiments of the present disclosure, when the reference point is selected, for the node to be processed in the LOD 1 of the current frame, the reference point may be directly determined from the LOD 1 of the reference frame according to the first Morton code information corresponding to the node to be processed.

It is to be understood that, in the embodiments of the present disclosure, for the node to be processed in the LOD 1 of the current frame, when the partitioning for the LOD 1 of the corresponding reference frame is performed, the update processing may not be performed on the sets in the reference frame. Therefore, the index of each point in the set in the LOD 1 is determined by the Morton code corresponding to the point in the set.

Exemplarily, in some embodiments, when the reference point is determined from the prediction point set of the reference frame for the current frame according to the first Morton code information corresponding to the node to be processed, the points in the prediction point set may be traversed, and then a first one of the points with Morton code information greater than or equal to the first Morton code information is determined as the reference point corresponding to the node to be processed.

Exemplarily, in some embodiments, when the reference point is determined from the node set of the reference frame for the current frame according to the first Morton code information corresponding to the node to be processed, the points in the node set of the reference frame may be traversed, and then a first one of the points with Morton code information greater than or equal to the first Morton code information is determined as the reference point corresponding to the node to be processed.

Exemplarily, in some embodiments, when the reference point is determined from the first set corresponding to the LOD M of reference frame for the current frame according to the first Morton code information corresponding to the node to be processed, the points in the first set corresponding to the LOD M may be traversed, and then a first one of the points with Morton code information greater than or equal to the first Morton code information is determined as the reference point corresponding to the node to be processed.

It is to be understood that, in the embodiments of the present disclosure, since the index of each point in the prediction point set is determined based on the Morton code information of the point, the Morton code information corresponding to the reference point is the index corresponding to the reference point in the prediction point set.

That is to say, in the embodiments of the present disclosure, regardless of the node set of the current frame or the first set corresponding to the LOD M of the current frame, since the index of each point in the prediction point set is determined based on the Morton code corresponding to the point in the set, i.e., the index of the point in the set is the Morton code of the point, when the reference point is searched for, the points in the prediction point set may be sequentially traversed directly according to the Morton code of the node to be processed, and the first one of the points with a Morton code (index) greater than or equal to the Morton code of the node to be processed is determined as the corresponding reference point.

Exemplarily, in some embodiments, when the attribute inter prediction is performed, firstly, the first Morton code information corresponding to the node to be processed is obtained by using the geometric coordinates of the node to be processed. Here, it is assumed that the first Morton code information is i. Secondly, a first one of points with the Morton code information greater than or equal to the first Morton code information of the node to be processed is searched from the prediction point set of the reference frames based on i, and the first one of points is used as the reference point. Here, the Morton code of the reference point, i.e., the index of the reference point in the prediction point set, is j, and j is the index of a first point greater than or equal to i.

In operation 102, a search range is determined based on the second Morton code information corresponding to the reference point, and a nearest neighbor node corresponding to the node to be processed is determined according to the search range.

In the embodiments of the present disclosure, for the node to be processed in the LOD M of the current frame, after the reference point is determined from a prediction point set of a reference frame for the current frame according to first Morton code information corresponding to the node to be processed, the search range corresponding to the nearest-neighbor search for the node to be processed may be further determined based on the second Morton code information corresponding to the reference point, and then the nearest neighbor node corresponding to the node to be processed may be further determined based on the search range.

It is to be understood that, in the embodiments of the present disclosure, since the index of each point in the prediction point set is determined based on the Morton code information of the point, the second Morton code information corresponding to the reference point is the index corresponding to the reference point in the prediction point set.

It is to be noted that, in the embodiments of the present disclosure, when the search range is determined, a search step may be determined firstly; and then, the search range is further determined according to the second Morton code information and the search step.

Exemplarily, in some embodiments, it is assumed that the search step is searchRange and the second Morton code information corresponding to the reference point is j, i.e., the index of the reference point is j, the corresponding search range may be determined to be [j−searchRange, j+searchRange] according to the second Morton code information and the search step, and then the nearest-neighbor search may be performed within the search range of [j-searchRange, j+searchRange].

Exemplarily, in some embodiments, FIG. 40 is a schematic diagram of the search region in an embodiment of the present disclosure. As shown in FIG. 40, it is assumed that the first Morton code information corresponding to the node to be processed is i, the second Morton code information corresponding to the reference point is j, i.e., the index of the reference point is j, and the search step is sr, the corresponding search range may be determined to be [j−sr, j+sr] according to the second Morton code information and the search step, and then the nearest-neighbor search may be performed within the search range of [j−sr, j+sr].

Exemplarily, in some embodiments, when the nearest-neighbor search is performed, a block-based neighborhood search may be selected. Firstly, the points in the reference frame may be partitioned into P (P=3) levels according to the Morton codes, and the specific partitioning algorithm is as follows.
For a first level, it is assumed that the points in the reference frame are numPoints, and every Q (Q=2⁵=32) points among the points in the reference frame may be firstly partitioned into one block.
For a second level, based on the first level, similarly, every Q (Q=2⁵=32) blocks among the blocks of the first level are also partitioned into one block in the order of Morton codes.
For a third level, based on the second level, similarly, every Q (Q=2⁵=32) blocks among the blocks of the first level are also partitioned into one block in the order of Morton codes.

It is assumed that the Morton code of the node to be processed is i, firstly, the first one of the points with the Morton code greater than or equal to the Morton code of the node to be processed is obtained from the reference frame, and the index of the first one of the points is j. Secondly, the block index of the reference point is calculated based on j, and the specific calculation method is as follows:
For the first level, BucketSize_0=2⁵=32.
For the second level, BucketSize_1=2⁵=32×BucketSize_0=1024.
For the third level, BucketSize_2=2⁵=32×BucketSize_1=32768.

The reference range determined according to the index (Morton code) of the reference point is [j−searchRange, j+searchRange], the starting index of the third level is calculated by j−searchRange, and the termination index of the third level is calculated by j+searchRange. It is firstly determined whether the nearest-neighbor search is required to be performed on the blocks of the third level for some blocks of the second level; and secondly, at the second level, it is determined whether the search is required to be performed for each block of the first level. If the nearest-neighbor search is required to be performed for some blocks of the first level, the determination may be performed on each point in some blocks of the first level to update the nearest neighbor points.

For the algorithm of calculating a block based on an index, it is assumed that the Morton code index corresponding to the current point is index, then the index of the corresponding block in the third level is: idx_2=index/BucketSize_2. After the block index idx_2 of the third level is obtained, the starting index is startIdx1=idx_2×BucketSize_1 and the end index is endIdx=idx_2×BucketSize_1+BucketSize_1-1 of the block corresponding to the current block in the second level may be obtained based on idx_2. Similarly, the index of block in the first level is obtained based on the index of the block in the second level.

When nearest-neighbor search is performed based on blocks, it will firstly determine whether the nearest-neighbor search is required to be performed for the current block, i.e., the nearest-neighbor search of the block is filtered. Each spatial block may be obtained by two variables: minPos and maxPos. minPos represents the minimum value of the block, and maxPos represents the maximum value of the block.

It is assumed that the farthest point among searched nearest neighbor points has a distance Dist, the coordinates of the point to be processed are (x, y, z), and the current block is expressed as (minPos, maxPos), wherein minPos is the minimum value of the bounding box in three dimensions and maxPos is the maximum value of the bounding box in three dimensions, then, the distance D between the current point and the bounding box is calculated as follows:

$$int dx = int ( std \text{::} max ( std \text{::} max ( min Pos [ 0 ] - point [ 0 ] , 0 , point [ 0 ] - max Po s [ 0 ] ) ) ;$$

$$int dy = int ( std \text{::} max ( std \text{::} max ( inPos [ 1 ] - point [ 1 ] , 0 ) , point [ 1 ] - max Pos [ 1 ] ) ) ;$$

$$int dz = int ( std \text{::} max ( std \text{::} max ( min Pos [ 2 ] - point [ 2 ] , 0 ) , point [ 2 ] - max Pos [ 2 ] ) ) ;$$

$$D = dx + dy + dz ;$$

When D is less than or equal to Dist, the points in the current block will be traversed.

It is to be understood that in the embodiments of the present disclosure, for a node to be processed in the LOD 1 of the current frame, after the reference point is determined, the search range corresponding to the nearest-neighbor search for the node to be processed may be further determined based on the second Morton code information corresponding to the reference point, and then the nearest neighbor node corresponding to the node to be processed may be further determined based on the search range.

Furthermore, in the embodiments of the present disclosure, after the nearest-neighbor search is performed according to the search range, one or more nearest neighbor nodes corresponding to the node to be processed may be determined, i.e., the number of nearest neighbor nodes after the nearest-neighbor search may be any number, which is not limited in the present disclosure.

In operation 103, a predicted attribute value corresponding to the node to be processed is determined based on a reconstructed value of the nearest neighbor node.

In the embodiments of the present disclosure, after the search range is determined based on the second Morton code information corresponding to the reference point, and the nearest neighbor node corresponding to the node to be processed is determined according to the search range, the predicted attribute value corresponding to the node to be processed may be determined based on a reconstructed value of the nearest neighbor node.

It is to be noted that, in the embodiments of the present disclosure, after the nearest-neighbor search is performed according to the search range, since any number of nearest neighbor nodes corresponding to the node to be processed may be determined, different processing manners may be used to perform the prediction processing when the predicted attribute value corresponding to the node to be processed is determined by using the reconstructed value of the nearest neighbor node.

Exemplarily, in some embodiments, if one nearest neighbor node is obtained by searching, a reconstructed value of the one nearest neighbor node is determined as the predicted attribute value corresponding to the node to be processed.

Exemplarily, in some embodiments, if two or more nearest neighbor nodes are obtained by searching, weighted prediction processing may be performed on the reconstructed values of the two or more nearest neighbor nodes, and the result of the weighted prediction may be determined as the predicted attribute value corresponding to the node to be processed.

Exemplarily, in some embodiments, if two or more nearest neighbor nodes are obtained by searching, a target nearest neighbor node may be firstly determined from the multiple nearest neighbor nodes, and then a reconstructed value of the target nearest neighbor node may be determined as the predicted attribute value corresponding to the node to be processed.

That is to say, in the embodiments of the present disclosure, the target nearest neighbor nodes may be determined among the multiple searched nearest neighbor nodes; then the weighted prediction may be performed by using the attributes of the target nearest neighbor nodes, or the attribute of a single nearest neighbor point may be selected to perform the prediction; and finally, the predicted value of the attribute information of the node to be processed may be obtained.

Exemplarily, in some embodiments, the determination of the predicted attribute value of the node to be processed (current point) may be performed by the following formula:

$${Attr}_{i}^{′} = Round ( \frac{1}{K} {\sum }_{m ∈ {p}_{i}} \frac{\frac{1}{{D}_{m}^{2}}}{{\sum }_{m ∈ {p}_{i}} \frac{1}{{D}_{m}^{2}}} A t t {r}_{m} ) , \qquad ( 22 )$$

where K represents the number of prediction points in the nearest neighbor point set of point i, Pi represents the set of K nearest neighbor points of the point i, Dm represents the spatial geometric distance from the nearest neighbor point m to the current point i, Attrm represents the reconstructed attribute value of the nearest neighbor point m, Attrᵢ′ represents the predicted attribute value of the current point i, and the number K of points is a preset value in advance.

Furthermore, in the embodiments of the present disclosure, a bitstream is decoded to determine a prediction residual corresponding to the node to be processed; and the reconstructed attribute value of the node to be processed is determined according to the prediction residual and the predicted attribute value.

It is to be understood that, in the embodiments of the present disclosure, after the predicted attribute value corresponding to the node to be processed is determined, the reconstruction processing may be performed on the attribute information of the node to be processed by using the predicted attribute value. The reconstructed attribute value of the node to be processed is determined according to the prediction residual and the predicted attribute value corresponding to the node to be processed obtained by decoding the bitstream.

Exemplarily, in some embodiments, summation may be performed on the prediction residual and the predicted attribute value corresponding to the node to be processed, and then the reconstructed attribute value corresponding to the node to be processed may be obtained.

To sum up, in the encoding and decoding methods proposed in the embodiments of the present disclosure, when the attribute nearest-neighbor search is performed, although it is also needed to update each set storing inter prediction points after the nearest-neighbor search is performed on each level, in the set storing inter-frame points (i.e., the prediction point set, e.g. the node set of the reference frame or the first set of the LOD M), it is ensured that the index corresponding to each point is the index of a Morton code of the inter prediction point, instead of the initial index of the point. In this way, it can be ensures that the nearest neighbor point in space can be searched for each point when the subsequent nearest-neighbor search is performed, thereby effectively removing the redundancy between adjacent frames in the time domain and improving the attribute encoding efficiency.

Furthermore, in the embodiments of the present disclosure, when the attribute inter prediction is performed, it is ensured that the index of each point in the inter prediction point set is stored as an index of a Morton code, i.e., the index of the point is determined by the Morton code of the point, so that when the attribute inter prediction is performed, the subsequent nearest-neighbor search is performed based on the Morton code, the nearest neighborhood may be found within a certain inter search range, thereby improving the encoding efficiency for attributes of the point cloud.

Exemplarily, in some embodiments, when the encoding performance of the algorithm is measured, BD-rate is used as an indicator, and the test results are shown in the table, where the BD-rate is an objective metric indicator used in video compression and is used to compare the rate distortion performance or compression efficiency of two different video codecs or different settings of the same video codec within a range of bit rate or the quality value. Since the BD-rate represents the rate increase amount of the optimized algorithm compared with the original algorithm under the same objective quality of video, negative BD-rate represents that the encoding performance of the optimized algorithm is improved.

Exemplarily, as shown in Table 2, under the condition of C1_ai, for the test condition of lossless geometric position and lossy attribute, the encoding performance can be improved by −9.8%, i.e., the encoding and decoding methods proposed in the embodiments of the present disclosure effectively improve the codec performance.

| | lossless geometry, lossy attributes [all intra] | | | |
|---|---|---|---|---|
| | End-to-End BD-AttrRate [%] | | | |
| C1_ai. | Luma | Chroma Cb | Chroma Cr | Reflectance |
| Solid average | #VALUE! | #VALUE! | #VALUE! | |
| Dense average | #VALUE! | #VALUE! | #VALUE! | |
| Sparse average | #VALUE! | #VALUE! | #VALUE! | |
| Scant average | #VALUE! | #VALUE! | #VALUE! | |
| Am-fused | #VALUE! | #VALUE! | #VALUE! | #VALUE! |
| average | | | | |
| Am-frame | | | | −9.8% |
| spinning average | | | | |
| Am-frame | | | | 0.0% |
| non-spinning | | | | |
| average | | | | |
| Overall average | #VALUE! | #VALUE! | #VALUE! | #VALUE! |

| | |
|---|---|
| Avg. Enc | #NUM! |
| Time [%] | |
| Avg. Dec | #NUM! |
| Time [%] | |

Exemplarily, as shown in Table 2, under the condition of C2_ai, for the test condition of lossless geometric position and lossy attribute, the encoding performance can be improved by −12.4%, i.e., the encoding and decoding methods proposed in the embodiments of the present disclosure effectively improve the codec performance.

| | lossless geometry, lossy attributes [all intra] | | | | | |
|---|---|---|---|---|---|---|
| | End-to-End BD-AttrRate [%] | | | | Geom. BD- | |
| | | Chroma | Chroma | | TotGeomRate [%] | |
| C2_ai. | Luma | Cb | Cr | Reflectance | D1 | D2 |
| Solid average | #VALUE! | #VALUE! | #VALUE! | | #VALUE! | #VALUE! |
| Dense average | #VALUE! | #VALUE! | #VALUE! | | #VALUE! | #VALUE! |
| Sparse average | #VALUE! | #VALUE! | #VALUE! | | #VALUE! | #VALUE! |
| Scant average | #VALUE! | #VALUE! | #VALUE! | | #VALUE! | #VALUE! |
| Am-fused | #VALUE! | #VALUE! | #VALUE! | #VALUE! | #VALUE! | #VALUE! |
| average | | | | | | |
| Am-frame | | | | −12.4% | 0.0% | 0.0% |
| spinning | | | | | | |
| average | | | | | | |
| Overall | #VALUE! | #VALUE! | #VALUE! | #VALUE! | #VALUE! | #VALUE! |
| average | | | | | | |
| Avg. Enc Time | #NUM! | | | | | |
| [%] | | | | | | |
| Avg. Dec Time | #NUM! | | | | | |
| [%] | | | | | | |

As can be seen that, in the encoding and decoding methods proposed in the embodiments of the present disclosure, when the encoding end and the decoding end perform the inter prediction on an attribute of a point cloud, the whole process of performing a nearest-neighbor search on the attribute is based on a Morton code. Therefore, it is necessary to ensure that an index of a neighborhood point searched for each point is an index of a Morton code when the nearest-neighbor search is performed on each LOD level, and then it is ensured that the nearest-neighbor search is performed based on the index of the Morton code point set in the subsequent nearest-neighbor search, so that the nearest neighbor points can be accurately searched when the inter attribute prediction is performed, and the attribute codec efficiency of the point cloud can be improved.

A decoding method is provided by the embodiments of the present disclosure, for the node to be processed in the LOD M of the current frame, the decoder may determine the reference point from the prediction point set of the reference frame for the current frame according to the first Morton code information corresponding to the node to be processed, where M is the integer greater than 1, and the index of the point in the prediction point set of the reference frame is determined based on the Morton code information of the point; determine the search range based on the second Morton code information corresponding to the reference point, and determine the nearest neighbor node corresponding to the node to be processed according to the search range; and determine the predicted attribute value corresponding to the node to be processed based on the reconstructed value of the nearest neighbor node. As can be seen that, in the embodiments of the present disclosure, each of the encoder and the decoder needs to determine the reference point from the prediction point set of the reference frame in the process of performing the inter prediction on the attribute information, the index of each point in the prediction point set of the reference frame is determined based on the Morton code information of the point, i.e., the index of the point in the prediction point set of the reference frame is the Morton code of the point, so that the corresponding reference point may be found by using the Morton code, thereby ensuring that the nearest neighbor node is obtained by using the Morton code in the subsequent nearest-neighbor search process based on the reference point. That is to say, in the embodiments of the present disclosure, it is possible to ensure that the optimal nearest neighbor point can be accurately found by ensuring that the index of each point in the prediction point set of the reference frame is the Morton code of the point, thereby improving the prediction effect for the attribute information and improving the codec efficiency and performance.

In an embodiment of the present disclosure, with reference to FIG. 41, a flowchart of a encoding method according to an embodiment of the present disclosure is shown. As shown in FIG. 41, the method may include following operations.

In operation 201, for a node to be processed in a LOD M of a current frame, a reference point is determined from a prediction point set of a reference frame for the current frame according to first Morton code information corresponding to the node to be processed, where M is an integer greater than 1, and an index of a point in the prediction point set of the reference frame is determined based on Morton code information of the point.

In the embodiments of the present disclosure, when the inter prediction for the attribute information is performed, for the node to be processed in the LOD M of the current frame, the reference point may be determined from the prediction point set of a reference frame for the current frame according to first Morton code information corresponding to the node to be processed.

It is to be noted that the encoding method according to the embodiment of the present disclosure specifically refers to a point cloud encoding method, and the method may be applied to a point cloud encoder (also referred to as an “encoder” for short).

Accordingly, in the embodiments of the present disclosure, the current frame may be a video frame to be encoded, and the reference frame may be a encoded neighbor frame.

Furthermore, in the embodiments of the present disclosure, the node to be processed corresponds to one piece of geometric information and one piece of attribute information. Here, the geometric information represents a spatial relationship of a point, and the attribute information represents the information related to the attributes of the point.

Here, the attribute information may be color information, a reflectance, or other attributes, which is not limited in the embodiments of the present disclosure. Here, when the attribute information is color information, the attribute information may specifically be color information of any color space. Exemplarily, the attribute information may be the color information of the RGB space, the color information of the YUV space, the color information of the YCbCr space, or the like, which is not limited in the embodiments of the present disclosure.

Furthermore, in the embodiments of the present disclosure, partitioning may be firstly performed on the current frame, and then at least one LOD level may be determined. That is to say, in the present disclosure, the current frame may be partitioned into any number of LOD levels after the partitioning is performed. The number of LOD levels of the current frame is not limited in the embodiments of the present disclosure.

It is to be noted that, in the embodiments of the present disclosure, the partitioning may be performed on the nodes in the current frame according to the Morton code information of the nodes in the current frame.

Furthermore, in the embodiments of the present disclosure, the partitioning may be firstly performed on the reference frame, and then at least one LOD level may be determined. That is to say, in the present disclosure, the current frame may be partitioned into any number of LOD levels after the partitioning is performed. The number of LOD levels of the current frame is not limited in the embodiments of the present disclosure.

It is to be noted that, in the embodiments of the present disclosure, the partitioning may be performed on the nodes in the reference frame according to the Morton code information of the nodes in the reference frame.

Furthermore, although the number of LOD levels of the current frame or of the reference frame after the partitioning is not limited in the embodiments of the present disclosure, it is necessary to ensure that the number of LOD levels of the current frame after the partitioning is the same as the number of LOD levels of the reference frame after the partitioning.

Exemplarily, in some embodiments, the current frame may be partitioned into N LOD levels based on Morton codes of nodes in the current frame. That is to say, after the partitioning is performed on the nodes in the current frame according to the Morton code information of the nodes in the current frame, N LOD levels corresponding to the current frame may be determined.

Exemplarily, in some embodiments, the reference frame may be partitioned into N LOD levels based on Morton codes of nodes in the reference frame. That is to say, after the partitioning is performed on the nodes in the reference frame according to the Morton code information of the nodes in the reference frame, N LOD levels corresponding to the reference frame may be determined.

It is to be noted that, in the embodiments of the present disclosure, for the LOD of the current frame obtained after the partitioning, the LOD may include at least one point. Here, for the at least one point in the LOD, when the encoding is performed on the LOD, the at least one node may used as the node to be encoded in the LOD, i.e. the node to be processed.

It is to be noted that, in the embodiments of the present disclosure, M is an integer greater than 1, i.e., the value of M may be 2, 3, 4, . . . . That is to say, when the inter prediction processing is performed on the attribute information of the current frame, for each of LOD levels other than the LOD 1 of the current frame, the reference point may be determined from a prediction point set of a reference frame corresponding to the LOD according to the first Morton code information corresponding to the node to be processed in the LOD.

It is to be understood that in the embodiments of the present disclosure, it is necessary to ensure that M is an integer greater than 1 and less than or equal to N.

It is to be noted that, in the embodiments of the present disclosure, the prediction point set of the reference frame may be a set for storing all or part of the points in the reference frame and used for performing the prediction processing on the current frame. That is to say, the prediction point set of the reference frame may store all the points in the reference frame, or only some points in the reference frame.

Exemplarily, in some embodiments, the prediction point set of the reference frame may be a node set of the reference frame, and the node set may include all nodes in the reference frame.

Exemplarily, in some embodiments, the prediction point set of the reference frame may be a first set corresponding to the LOD M of the reference frame, and the input points of the LOD M of the reference frame in the LOD partitioning is stored in the first set corresponding to the LOD M.

It is to be understood that in the embodiments of the present disclosure, in the entire LOD partitioning, there are three sets, specifically including a first set I(M), a second set O(M), and a third set L(M). M is an index of a LOD in the LOD partitioning, I(M) is an input point set for partitioning the current LOD. After the LOD partitioning, the set O(M) and the set L(M) are obtained, the set O(M) stores a sampling node set, and L(M) is a point set of the current LOD.

Furthermore, in the embodiments of the present disclosure, an index of a point in the prediction point set of the reference frame may be determined based on Morton code information of the point. The Morton code information of the point may be the Morton code corresponding to the node, and the Morton code may be obtained from the geometric coordinates of the node.

That is to say, in the embodiments of the present disclosure, regardless of the prediction point set of the reference frame storing all points in the reference frame or some points in the reference frame, an index of a point in the prediction point set is determined based on the Morton code information of the point. For example, the index of the point in the node set of the reference frame may be determined based on the Morton code information of the point in the node set, or, the index of the point in the first set corresponding to the LOD M of the reference frame may be determined based on the Morton code information of the point in the first set.

It is to be understood that, in the embodiments of the present disclosure, if the prediction point set of the reference frame is the node set of the reference frame, the points may be sorted according to the Morton code information of the points in the node set, and finally the indexes of the points in the node set of the reference frame can be obtained.

Exemplarily, in the embodiments of the present disclosure, it is assumed that the node set of the reference frame includes 10 nodes of P0, P1, P2, . . . , and P9, and the initial order of the 10 nodes is the initial point index, i.e., P0, P1, P2, . . . , and P9. After the sorting is performed according to the ascending order of the Morton codes of the 10 nodes, the order of P4, P1, P3, P9, P2, P0, P6, P5, P7, and P8 is finally obtained. That is to say, the indexes of the finally sorted points 0 to 9 in the node set of the reference frame may be P4, P1, P3, P9, P2, P0, P6, P5, P7 and P8.

It is to be understood that, in the embodiments of the present disclosure, if the prediction point set of the reference frame is the first set I(M) corresponding to the LOD M of the reference frame, input points of the LOD M may be sorted according to Morton code information of the points in the first set I(M) corresponding to the LOD M, and finally, indexes of points in the first set I(M) corresponding to the LOD M of the reference frame can be obtained.

Exemplarily, in the embodiments of the present disclosure, it is assumed that I(M) of the reference frame includes 6 nodes of P0, P1, P2, P3, P4 and P5, and the initial order of the 6 nodes is the initial point index, i.e., P0, P1, P2, P3, P4 and P5. After the sorting is performed according to the ascending order of the Morton codes of the 6 nodes, the order of P2, P1, P3, P5, P6 and P4 is finally obtained. That is to say, the indexes of the finally sorted points 0 to 5 in the I(M) of the reference frame may be P2, P1, P3, P5, P6 and P4.

Furthermore, in the embodiments of the present disclosure, the first Morton code information corresponding to the node to be processed may be the Morton code of the node to be processed, and the first Morton code information may be obtained from geometric coordinates of the node to be processed.

That is to say, in the embodiments of the present disclosure, the geometric coordinates of the node to be processed may be determined firstly, and then the Morton code corresponding to the node to be processed, i.e., the first Morton code information, may be determined according to the geometric coordinates of the node to be processed.

Exemplarily, in some embodiments, it is assumed that the geometric coordinates of the node to be processed are (x, y, z), each geometric component x, y, or z in the three-dimensional coordinates may be respectively represented by a d-bit binary number. Here, the highest bit of the binary number corresponding to each geometric component is 1 and the lowest bit of the binary number corresponding to each geometric component is d. Then, starting from the highest bit of the three geometric components x, y, z, bits of the binary numbers of all geometric components are arranged alternately in sequence, until reaching to the lowest bit. Finally the corresponding Morton code value, i.e., the first Morton code information, of the node to be processed, may be determined.

It is to be understood that in the embodiments of the present disclosure, since the prediction point set of the reference frame may be the node set of the reference frame or the first set corresponding to the LOD M of the reference frame, when the reference point of the node to be processed in the LOD M of the current frame is determined, the manner where the reference point is searched in the node set of the reference frame according to the first Morton code information of the node to be processed may be selected, or the manner where the reference point is searched in the first set corresponding to the LOD M of the reference frame according to the first Morton code information of the node to be processed may be selected.

Exemplarily, in some embodiments, when the reference point is determined from the prediction point set of the reference frame for the current frame according to the first Morton code information corresponding to the node to be processed, the reference point corresponding to the node to be processed may be determined from the first set corresponding to the LOD M of the reference frame according to the first Morton code information.

Exemplarily, in some embodiments, when the reference point is determined from the prediction point set of the reference frame for the current frame according to the first Morton code information corresponding to the node to be processed, the reference point corresponding to the node to be processed may be determined from the node set of the reference frame according to the first Morton code information.

It is to be understood that in the embodiments of the present disclosure, regardless of the current frame or the reference frame, during the entire LOD partitioning, the LOD M may include three sets: a first set I(M), a second set O(M), and a third set L(M). Here, the first set I(M) is an input point set for partitioning the LOD M, the second set O(M) set stores a sampling point set of the LOD M, and L(M) is a point set in the LOD M.

Exemplarily, in some embodiments, the first set corresponding to the LOD M of the current frame (i.e., I(M) of the current frame) is used to store input points corresponding to the LOD M of the current frame, and the first set corresponding to the LOD M of the reference (i.e., I(M) of the reference frame) is used to store input points corresponding to the LOD M of the reference frame.

Exemplarily, in some embodiments, the second set corresponding to the LOD M of the current frame (i.e., O(M) of the current frame) is used to store sampling points corresponding to the LOD M of the current frame, and the second set corresponding to the LOD M of the reference (i.e., O(M) of the reference frame) is used to store sampling points corresponding to the LOD M of the reference frame.

Exemplarily, in some embodiments, the third set corresponding to the LOD M of the current frame (i.e., L(M) of the current frame) is used to store points other than the second set in the LOD M of the current frame, and the third set corresponding to the LOD M of the reference (i.e., L(M) of the reference frame) is used to store points other than the second set in the LOD M of the reference frame.

Furthermore, in the embodiments of the present disclosure, when the LOD partitioning is performed on the points in the reference frame, the partitioning for the LOD M of the reference frame is performed based on the first set corresponding to the LOD M of the reference frame, to determine the second set corresponding to the LOD M of the reference frame and the third set corresponding to the LOD M of the reference frame. That is to say, the second set O(M) of reference frame and the third set L(M) of reference frame may be determined after the LOD partitioning is performed on the first set I(M) of reference frame.

Accordingly, in the embodiments of the present disclosure, when the LOD partitioning is performed on the points in the current frame, the partitioning for the LOD M of the current frame is performed based on the first set corresponding to the LOD M of the current frame, to determine the second set corresponding to the LOD M of the current frame and the third set corresponding to the LOD M of the current frame. That is to say, the second set O(M) of the current frame and the third set L(M) of the current frame may be determined after the LOD partitioning is performed on the first set I(M) of current frame.

It is to be understood that in the embodiments of the present disclosure, regardless of the current frame or the reference frame, since the second set O(M) and the third set L(M) are obtained after the first set I(M) is subjected to the LOD partitioning, and the second set O(M) stores the sampling points, the third set L(M) may store un-sampled points in the LOD M.

Exemplarily, in some embodiments, the node to be processed in the LOD M of the current frame may be a point in the third set corresponding to the LOD M of the current frame.

Furthermore, in the embodiments of the present disclosure, when the LOD partitioning is performed on the points in the reference frame, after the partitioning for the LOD M of the reference frame is performed, a first set corresponding to a LOD (M+1) of the reference frame may be updated according to the second set corresponding to the LOD M of the reference frame.

It is to be noted that, in the embodiments of the present disclosure, after the update of the first set corresponding to the LOD (M+1) of the reference frame is completed, an index of a point in the first set corresponding to the LOD (M+1) of the reference frame is also determined based on Morton code information of the point in the first set.

It is to be noted that, in the embodiments of the present disclosure, an index of a point in each of the three sets which are the first set, the second set and the third set corresponding to each LOD of the reference frame may be determined based on Morton code information of the point in each set.

Furthermore, in the embodiments of the present disclosure, when the LOD partitioning is performed on the points in the current frame, after the partitioning for the LOD M of the current frame is performed, a first set corresponding to a LOD (M+1) of the current frame may be updated according to the second set corresponding to the LOD M of the current frame.

It is to be noted that, in the embodiments of the present disclosure, after the update of the first set corresponding to the LOD (M+1) of the current frame is completed, an index of a point in the first set corresponding to the LOD (M+1) of the current frame is also determined based on Morton code information of the point in the first set.

It is to be noted that, in the embodiments of the present disclosure, an index of a point in each of the three sets of the first set, the second set, and the third set corresponding to each LOD level of the current frame may be determined based on Morton code information of the point in each set.

That is to say, in the embodiments of the present disclosure, regardless of the current frame or the reference frame, during the entire LOD partitioning, after the partitioning for the LOD M is completed, the first set I(M+1) corresponding to the LOD (M+1) may be updated by using the second set O(M) corresponding to the LOD M.

Exemplarily, in some embodiments, when the second set O(M) corresponding to the LOD M is used to update the first set I(M+1) corresponding to the LOD (M+1), points in the second set O(M) corresponding to the LOD M may be added into the first set I(M+1) corresponding to the LOD (M+1).

It is to be understood that, in the embodiments of the present disclosure, after the first set I(M+1) corresponding to the LOD (M+1) is updated using the second set O(M) corresponding to the M LOD, the points in the first set I(M+1) corresponding to the LOD (M+1) are still sorted according to the Morton codes of the points, so as to ensure that an index of a point in the finally determined first set I(M+1) corresponding to the LOD (M+1) is also determined based on the Morton code information of the point in the first set.

Furthermore, in the embodiments of the present disclosure, when the LOD partitioning is performed on the points in the reference frame, before the partitioning for the LOD M of the reference frame is performed, the third set corresponding to the LOD M of the reference frame may be initialized according to a third set corresponding to LOD (M−1) of the reference frame. Moreover, the second set corresponding to the LOD M of the reference frame is initialized as an empty set

Accordingly, in the embodiments of the present disclosure, when the LOD partitioning is performed on the points in the current frame, before the partitioning for the LOD M of the current frame is performed, the third set corresponding to the LOD M of the current frame may be initialized according to a third set corresponding to LOD (M−1) of the current frame. Moreover, the second set corresponding to the LOD M of the current frame is initialized as an empty set

That is to say, in the embodiments of the present disclosure, regardless of the current frame or the reference frame, during the entire LOD partitioning, after the partitioning for the LOD (M−1) is completed and before the partitioning for the LOD M is performed, the third set L(M−1) corresponding to the LOD (M−1) may be used to initialize the third set L(M) corresponding to the LOD M, and the second set corresponding to the LOD M may be initialized as the empty set { }.

Exemplarily, in some embodiments, when the third set L(M) corresponding to the LOD M is initialized by using the third set L(M−1) corresponding to the LOD (M−1), points in the third set L(M−1) corresponding to the LOD (M−1) may be added into the third set L(M) corresponding to the LOD M.

Furthermore, in the embodiments of the present disclosure, when the LOD partitioning is performed on the points in the reference frame, before partitioning for the LOD 1 of the reference frame is performed, a third set corresponding to the LOD 1 of the reference frame may be initialized as an empty set; and after the partitioning for the LOD 1 of the reference frame is performed, a first set corresponding to a 2^{nd} LOD level (LOD 2) of the reference frame may be updated according to a second set corresponding to the LOD 1 of the reference frame.

Accordingly, in the embodiments of the present disclosure, when the LOD partitioning is performed on the points in the current frame, before partitioning for the LOD 1 of the current frame is performed, a third set corresponding to the LOD 1 of the current frame may be initialized as an empty set; and after the partitioning for the LOD 1 of the current frame is performed, a first set corresponding to a 2^{nd} LOD level (LOD 2) of the current frame may be updated according to a second set corresponding to the LOD 1 of the current frame.

That is to say, in the embodiments of the present disclosure, regardless of the current frame or the reference frame, during the entire LOD partitioning, before the partitioning for the LOD 1 is performed, the third set L(1) corresponding to the LOD 1 may be initialized as the empty set { }; moreover, after the partitioning for the LOD 1 is completed, the first set I(2) corresponding to the 2^{nd} LOD level (LOD 2) may be updated according to the second set O(1) corresponding to the LOD 1.

Exemplarily, in some embodiments, regardless of the current frame or the reference frame, during the entire LOD partitioning, each set may be initialized. Before the partitioning for the LOD 1, for the third set (1) of the LOD 1, L(1) may be initialized as the empty set { }. Before the partitioning for the LOD M, i.e. if M is greater than 1, for the third set L(M) of the LOD M, L(M) may be initialized as L(M−1), while for the second set O(M) of the LOD M, O(M) may be initialized as the empty set { }.

Exemplarily, in some embodiments, regardless of the current frame or the reference frame, during the entire LOD partitioning, when each LOD is partitioned using the LOD partitioning algorithm, the sampling points may be stored in (M), the remaining points are partitioned into (M).

Exemplarily, in the embodiments of the present disclosure, regardless of the current frame or the reference frame, during the entire LOD partitioning, after the partitioning for the LOD 1 is completed, the first set I(2) corresponding to the 2nd LOD level (LOD 2) may be updated by using the second set O(1) corresponding to the LOD 1; and moreover, after the partitioning for the LOD M is completed, the first set I(M+1) corresponding to the LOD (M+1) may be updated by using the second set O(M) corresponding to the LOD M.

That is to say, in the embodiments of the present disclosure, regardless of the current frame or the reference frame, the entire LOD partitioning is performed based on the Morton codes of the points, therefore, the index of each point store in the each of the O(M), L(M), and I(M) is determined by the Morton code corresponding to the point in the set.

It is to be understood that, in the embodiments of the present disclosure, since the process of selecting the reference point is performed from the prediction point set of the reference frames by using the first Morton code information of the node to be processed, the key point for searching for the reference point is the Morton code information of the point. Therefore, it is necessary to ensure that the index of each point in the prediction point set is determined based on the Morton code information of the point, so that the optimal reference point can be determined, and the accuracy of selecting the nearest neighbor point can be improved.

Exemplarily, in some embodiments, it is assumed that the prediction point set of the reference frame is the first set I(M) corresponding to the LOD M of the reference frame, whether the set I(M) of the reference frame is updated or initialized, it is necessary to ensure that the index of each point in the updated or initialized set I(M) is determined based on the Morton code information of the point.

Furthermore, in the embodiments of the present disclosure, when the reference point is selected, for the node to be processed in the LOD 1 of the current frame, the reference point may be directly determined from a LOD 1 of the reference frame according to the first Morton code information corresponding to the node to be processed.

It is to be understood that, in the embodiments of the present disclosure, for the node to be processed in the LOD 1 of the current frame, when the partitioning for the LOD 1 of the corresponding reference frame is performed, the update processing may not be performed on the sets in the reference frame. Therefore, the index of each point in the set in the LOD 1 is determined by the Morton code corresponding to the point in the set.

Exemplarily, in some embodiments, when the reference point is determined from the prediction point set of the reference frame for the current frame according to the first Morton code information corresponding to the node to be processed, the points in the prediction point set may be traversed, and then a first one of the points with Morton code information greater than or equal to the first Morton code information is determined as the reference point corresponding to the node to be processed.

Exemplarily, in some embodiments, when the reference point is determined from the node set of the reference frame for the current frame according to the first Morton code information corresponding to the node to be processed, the points in the node set of the reference frame may be traversed, and then a first one of the points with Morton code information greater than or equal to the first Morton code information is determined as the reference point corresponding to the node to be processed.

Exemplarily, in some embodiments, when the reference point is determined from the first set corresponding to the LOD M of reference frame for the current frame according to the first Morton code information corresponding to the node to be processed, the points in the first set corresponding to the LOD M may be traversed, and then a first one of the points with Morton code information greater than or equal to the first Morton code information is determined as the reference point corresponding to the node to be processed may be selected.

It is to be understood that, in the embodiments of the present disclosure, since the index of each point in the prediction point set is determined based on the Morton code information of the point, the Morton code information corresponding to the reference point is the index corresponding to the reference point in the prediction point set.

That is to say, in the embodiments of the present disclosure, regardless of the node set of the current frame or the first set corresponding to the LOD M of the current frame, since the index of each point in the prediction point set is determined by the Morton code corresponding to the point in the set, i.e., the index of the point in the set is the Morton code of the point, when the reference point is searched for, the points in the prediction point set may be sequentially traversed directly according to the Morton code of the node to be processed, and the first one of the points with a Morton code (index) greater than or equal to the Morton code of the node to be processed is determined as the corresponding reference point.

Exemplarily, in some embodiments, when the attribute inter prediction is performed, firstly, the first Morton code information corresponding to the node to be processed is obtained by using the geometric coordinates of the node to be processed. Here, it is assumed that the first Morton code information is i. Secondly, a first one of points with the Morton code information greater than or equal to the first Morton code information of the node to be processed is searched from the prediction point set of the reference frames based on i, and the first one of points is used as the reference point. Here, the Morton code of the reference point, i.e., the index of the reference point in the prediction point set, is j, and j is the index of a first point greater than or equal to i.

In operation 202, a search range is determined based on the second Morton code information corresponding to the reference point, and a nearest neighbor node corresponding to the node to be processed is determined according to the search range.

In the embodiments of the present disclosure, for the node to be processed in the LOD M of the current frame, after the reference point is determined from a prediction point set of a reference frame for the current frame according to first Morton code information corresponding to the node to be processed, the search range corresponding to the nearest-neighbor search for the node to be processed may be further determined based on the second Morton code information corresponding to the reference point, and then the nearest neighbor node corresponding to the node to be processed may be further determined based on the search range.

It is to be understood that, in the embodiments of the present disclosure, since the index of each point in the prediction point set is determined based on the Morton code information of the point, the second Morton code information corresponding to the reference point is the index corresponding to the reference point in the prediction point set.

It is to be noted that, in the embodiments of the present disclosure, when the search range is determined, a search step may be determined firstly; and then, the search range is further determined according to the second Morton code information and the search step.

Exemplarily, in some embodiments, it is assumed that the search step is searchRange and the second Morton code information corresponding to the reference point is j, i.e., the index of the reference point is j, the corresponding search range may be determined to be [j−searchRange, j+searchRange] according to the second Morton code information and the search step, and then the nearest-neighbor search may be performed within the search range of [j-searchRange, j+searchRange].

Exemplarily, in some embodiments, when the nearest-neighbor search is performed, a block-based neighborhood search may be selected. Firstly, the points in the reference frame may be partitioned into P (P=3) levels according to the Morton codes, and the specific partitioning algorithm is as follows.
For a first level, it is assumed that the points in the reference frame are numPoints, and every Q (Q=2⁵=32) points among the points in the reference frame may be firstly partitioned into one block.
For a second level, based the first level, similarly, every Q (Q=2⁵=32) blocks among the blocks of the first level is also partitioned into one block in the order of the Morton code.
For a third level, based the second level, similarly, every Q (Q=2⁵=32) blocks among the blocks of the first level is also partitioned into one block in the order of the Morton code.

It is assumed that the Morton code of the node to be processed is i, firstly, the first one of the points with the Morton code greater than or equal to the Morton code of the node to be processed is obtained from the reference frame, and the index of the first one of the points is j. Secondly, the block index of the reference point is calculated based on j, and the specific calculation method is as follows:
For the first level, BucketSize_0=2⁵=32.
For the second level, BucketSize_1=2⁵=32×BucketSize_0=1024.
For the third level, BucketSize_2=2⁵=32×BucketSize_1=32768.

The reference range determined according to the index (Morton code) of the reference point is [j−searchRange, j+searchRange], the starting index of the third level is calculated by j−searchRange, and the termination index of the third level is calculated by j+searchRange. It is firstly determined whether the nearest-neighbor search is required to be performed on the blocks of the third level for some blocks of the second level; and secondly, at the second level, it is determined whether the search is required to be performed for each block of the first level. If the nearest-neighbor search is required to be performed for some blocks of the first level, the determination may be performed on each point in some block of the first level to update the nearest neighbor points.

For the algorithm of calculating a block based on an index, it is assumed that the Morton code index corresponding to the current point is index, then the index of the corresponding block in the third level is: idx_2=index/BucketSize_2. After the block index idx_2 of the third level is obtained, the starting index is startIdx1=idx_2×BucketSize_1 and the end index is endIdx=idx_2×BucketSize_1+BucketSize_1-1 of the block corresponding to the current block in the second level may be obtained by using idx_2. Similarly, the index of block in the first level is obtained based on the index of the block in the second level.

When nearest-neighbor search is performed based on blocks, it will firstly determine whether the nearest-neighbor search is required to be performed for the current block, i.e., the nearest-neighbor search of the block is filtered. Each spatial block may be obtained by two variables: minPos and maxPos. minPos represents the minimum value of the block, and maxPos represents the maximum value of the block.

It is assumed that the searched farthest point among nearest neighbor points has a distance Dist, the coordinates of the point to be processed are (x, y, z), and the current block is expressed as (minPos, maxPos), wherein minPos is the minimum value of the bounding box in three dimensions and maxPos is the maximum value of the bounding box in three dimensions, then, the distance D between the current point and the bounding box is calculated as follows:

$$int dx = int ( std \text{::} max ( std \text{::} max ( min Pos [ 0 ] - point [ 0 ] , 0 , point [ 0 ] - max Po s [ 0 ] ) ) ;$$

$$int dy = int ( std \text{::} max ( std \text{::} max ( inPos [ 1 ] - point [ 1 ] , 0 ) , point [ 1 ] - max Pos [ 1 ] ) ) ;$$

$$int dz = int ( std \text{::} max ( std \text{::} max ( min Pos [ 2 ] - point [ 2 ] , 0 ) , point [ 2 ] - max Pos [ 2 ] ) ) ;$$

$$D = dx + dy + dz ;$$

When D is less than or equal to Dist, the points in the current block will be traversed.

It is to be understood that in the embodiments of the present disclosure, for a node to be processed in the LOD 1 of the current frame, after the reference point is determined, the search range corresponding to the nearest-neighbor search for the node to be processed may be further determined based on the second Morton code information corresponding to the reference point, and then the nearest neighbor node corresponding to the node to be processed may be further determined based on the search range.

Furthermore, in the embodiments of the present disclosure, after the nearest-neighbor search is performed according to the search range, one or more nearest neighbor nodes corresponding to the node to be processed may be determined, i.e., the number of nearest neighbor nodes after the nearest-neighbor search may be any number, which is not limited in the present disclosure.

In operation 203, a predicted attribute value corresponding to the node to be processed is determined based on a reconstructed value of the nearest neighbor node.

In the embodiments of the present disclosure, after the search range is determined based on the second Morton code information corresponding to the reference point, and the nearest neighbor node corresponding to the node to be processed is determined according to the search range, and a predicted attribute value corresponding to the node to be processed may be determined based on a reconstructed value of the nearest neighbor node.

It is to be noted that, in the embodiments of the present disclosure, after the nearest-neighbor search is performed according to the search range, since any number of nearest neighbor nodes corresponding to the node to be processed may be determined, different processing manners may be used to perform the prediction processing when the predicted attribute value corresponding to the node to be processed is determined by using the reconstructed value of the nearest neighbor node.

Exemplarily, in some embodiments, if one nearest neighbor node is obtained by searching, a reconstructed value of the one nearest neighbor node is determined as the predicted attribute value corresponding to the node to be processed.

Exemplarily, in some embodiments, if two or more nearest neighbor nodes are obtained by searching, weighted prediction processing may be performed on the reconstructed values of the two or more nearest neighbor nodes, and the result of the weighted prediction may be determined as the predicted attribute value corresponding to the node to be processed.

Exemplarily, in some embodiments, if two or more nearest neighbor nodes are obtained by searching, a target nearest neighbor node may be firstly determined among the multiple nearest neighbor nodes according to the rate-distortion optimization algorithm, and then a reconstructed value of the target nearest neighbor node may be determined as the predicted attribute value corresponding to the node to be processed.

That is to say, in the embodiments of the present disclosure, the attributes of multiple nearest neighbor nodes selected by using the rate-distortion optimization algorithm may be used to perform the weighted prediction, or an attribute of a selected single nearest neighbor point may be used to perform the prediction; and finally, the predicted value of the attribute information of the node to be processed may be obtained.

Exemplarily, in some embodiments, the determination of the predicted attribute value of the node to be processed (current point) may be performed using the formula (22).

K represents the number of prediction points in the nearest neighbor point set of point i, Pi represents the set of K nearest neighbor points of the point i, Dm represents the spatial geometric distance from the nearest neighbor point m to the current point i, Attrm represents the reconstructed attribute value of the nearest neighbor point m, Attrᵢ′ represents the predicted attribute value of the current point i, and the number K of points is a preset value in advance.

Furthermore, in the embodiments of the present disclosure, a prediction residual corresponding to the node to be processed may be determined; and a reconstructed attribute value of the node to be processed is determined according to the prediction residual and the predicted attribute value.

It is to be understood that, in the embodiments of the present disclosure, after the predicted attribute value corresponding to the node to be processed is determined, reconstruction processing may be performed on the attribute information of the node to be processed by using the predicted attribute value. The reconstructed attribute value of the node to be processed is determined according to the prediction residual and the predicted attribute value corresponding to the node to be processed.

Exemplarily, in some embodiments, summation may be performed on the prediction residual and the predicted attribute value corresponding to the node to be processed, and then the reconstructed attribute value corresponding to the node to be processed may be obtained.

Furthermore, in the embodiments of the present disclosure, before the prediction residual of the node to be processed is determined, the initial value of the attribute corresponding to the node to be processed may be determined firstly. Then, according to the initial attribute value and the predicted attribute value, a prediction residual corresponding to the node to be processed is determined, and the prediction residual is signalled and transmitted to the decoding end, so that the decoding end is able to reconstruct the attribute information of the node to be processed according to the prediction residual corresponding to the node to be processed.

Exemplarily, in some embodiments, a difference between the prediction residual and the predicted attribute value corresponding to the node to be processed may be calculated, and then the prediction residual corresponding to the node to be processed may be obtained.

To sum up, in the encoding and decoding methods proposed in the embodiments of the present disclosure, when the attribute nearest-neighbor search is performed, although it is also necessary to update each set storing inter prediction points after the nearest-neighbor search is performed on each level, in the set storing inter points (i.e., the prediction point set, e.g. the node set of the reference frame or the first set of the LOD M), it is ensured that the index corresponding to each point is the index of a Morton code of the inter prediction point, instead of the initial index of the point. In this way, it can be ensures that the nearest neighbor point in space can be searched for each point when the subsequent nearest-neighbor search is performed, thereby effectively removing the redundancy between adjacent frames in the time domain and improving the attribute encoding efficiency.

Furthermore, in the embodiments of the present disclosure, when the attribute inter prediction is performed, it is ensured that the index of each point in the inter prediction point set is stored as an index of a Morton code, i.e., the index of the point is determined by the Morton code of the point, so that when the attribute inter prediction is performed, the subsequent nearest-neighbor search is performed based on the Morton code, the nearest neighborhood may be found within a certain inter search range, thereby improving the encoding efficiency for attributes of the point cloud.

Exemplarily, in some embodiments, when the encoding performance of the algorithm is measured, BD-rate is used as an indicator, and the test results are shown in Table 2 and Table 3. Here, the BD-rate is an objective metric indicator used in the video compression, and is used to compare the rate distortion performance or compression efficiency of two different video codecs or different settings of the same video codec within a range of bit rate or the quality value. Since the BD-rate represents the rate increase amount of the optimized algorithm compared with the original algorithm under the same objective quality of video, negative BD-rate represents that the encoding performance of the optimized algorithm is improved.

Exemplarily, as shown in Table 2, under the condition of C1_ai, for the test conditions of lossless geometric position and lossy attribute, the encoding performance can be improved by −9.8%, i.e., the encoding and decoding methods proposed in the embodiments of the present disclosure effectively improve the codec performance.

Exemplarily, as shown in Table 2, under the condition of C2_ai, for the test conditions of lossless geometric position and lossy attribute, the encoding performance can be improved by −12.4%, i.e., the encoding and decoding methods proposed in the embodiments of the present disclosure effectively improve the codec performance.

As can be seen that, in the encoding and decoding methods proposed in the embodiments of the present disclosure, when the encoding end and the decoding end perform inter prediction on an attribute of a point cloud, the whole process of performing a nearest-neighbor search on the attribute is based on a Morton code. Therefore, it is necessary to ensure that an index of a neighborhood point searched for each point is an index of a Morton code when the nearest-neighbor search is performed on each LOD level, and then it is ensured that the nearest-neighbor search is performed based on the index of the Morton code point set in the subsequent nearest-neighbor search, so that the nearest neighbor points can be accurately searched when the inter attribute prediction is performed, and the attribute codec efficiency of the point cloud can be improved.

An encoding method is provided by the embodiments of the present disclosure, for the node to be processed in the LOD M of the current frame, the encoder may determine the reference point from the prediction point set of the reference frame for the current frame according to the first Morton code information corresponding to the node to be processed, where M is the integer greater than 1, and the index of the point in the prediction point set of the reference frame is determined based on the Morton code information of the point; determine the search range based on the second Morton code information corresponding to the reference point, and determine the nearest neighbor node corresponding to the node to be processed according to the search range; and determine the predicted attribute value corresponding to the node to be processed based on the reconstructed value of the nearest neighbor node. As can be seen that, in the embodiments of the present disclosure, each of the encoder and the decoder needs to determine the reference point from the prediction point set of the reference frame in the process of performing the inter prediction on the attribute information, the index of each point in the prediction point set of the reference frame is determined based on the Morton code information of the point, i.e., the index of the point in the prediction point set of the reference frame is the Morton code of the point, so that the corresponding reference point may be searched by using the Morton code, thereby ensuring that the nearest neighbor node is obtained by using the Morton code in the subsequent nearest-neighbor search process based on the reference point. That is to say, in the embodiments of the present disclosure, it is possible to ensure that the optimal nearest neighbor point can be accurately found by ensuring that the index of each point in the prediction point set of the reference frame is the Morton code of the point, thereby improving the prediction effect for the attribute information and improving the codec efficiency and performance.

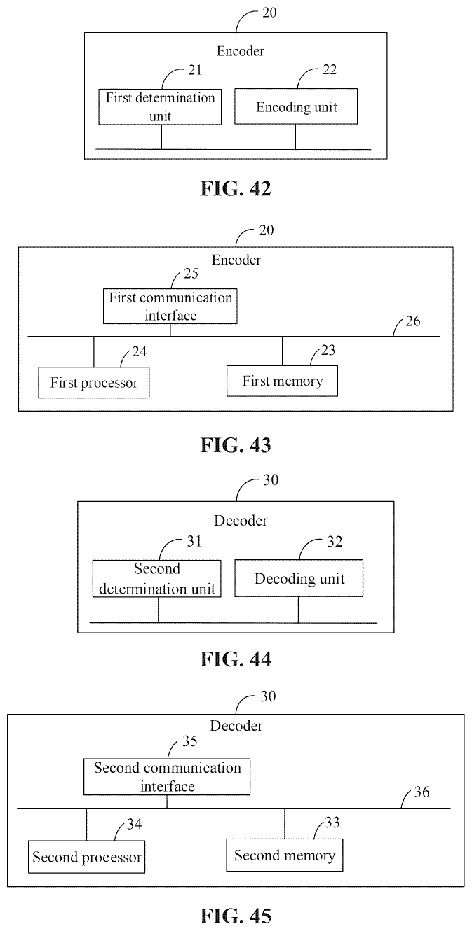

Based on the aforementioned embodiments, in another embodiment of the present disclosure, based on the same invention concept as the aforementioned embodiments, FIG. 42 is a first schematic diagram of a composition structure of an encoder. As shown in FIG. 42, the encoder 20 may include: a first determination unit 21 and an encoding unit 22.

The first determination unit 21 is configured to: for a node to be processed in a LOD M of a current frame, determine a reference point from a prediction point set of a reference frame for the current frame according to first Morton code information corresponding to the node to be processed, where M is an integer greater than 1, and an index of a point in the prediction point set of the reference frame is determined based on Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node.

In some embodiments, the first determination unit 21 is further configured to: determine the reference point from a first set corresponding to a LOD M of the reference frame according to the first Morton code information, where an index of a point in the first set corresponding to the LOD M of the reference frame is determined based on Morton code information of the point; and determine the reference point from a node set of the reference frame according to the first Morton code information, where an index of a point in the node set is determined based on Morton code information of the point.

In some embodiments, the first set corresponding to the LOD M of the reference frame is used to store input points corresponding to the LOD M of the reference frame; a second set corresponding to the LOD M of the reference frame is used to store sampling points corresponding to the LOD M of the reference frame; and a third set corresponding to the LOD M of the reference frame is used to store other points than points in the second set in the LOD M of the reference frame.

In some embodiments, the first determination unit 21 is further configured to: perform partitioning for the LOD M of the reference frame based on the first set corresponding to the LOD M of the reference frame, to determine the second set corresponding to the LOD M of the reference frame and the third set corresponding to the LOD M of the reference frame.

In some embodiments, the first determination unit 21 is further configured to: after the partitioning for the LOD M of the reference frame is performed, update a first set corresponding to a LOD (M+1) of the reference frame according to the second set corresponding to the LOD M of the reference frame.

In some embodiments, the first determination unit 21 is further configured to: before the partitioning for the LOD M of the reference frame is performed, initialize the third set corresponding to the LOD M of the reference frame according to a third set corresponding to a LOD (M−1) of the reference frame; and initialize the second set corresponding to the LOD M of the reference frame as an empty set.

In some embodiments, the first determination unit 21 is further configured to: for a node to be processed in a LOD 1 of the current frame, determine the reference point from a LOD 1 of the reference frame according to the first Morton code information corresponding to the node to be processed.

In some embodiments, the first determination unit 21 is further configured to: before partitioning for the LOD 1 of the reference frame is performed, initialize a third set corresponding to the LOD 1 of the reference frame as an empty set; and after the partitioning for the LOD 1 of the reference frame is performed, update a first set corresponding to a 2^{nd} LOD level (LOD 2) of the reference frame according to a second set corresponding to the LOD 1 of the reference frame.

In some embodiments, the first determination unit 21 is further configured to: determine a reconstructed value of one nearest neighbor node as the predicted attribute value corresponding to the node to be processed; perform weighted prediction processing on reconstructed values of multiple nearest neighbor nodes to obtain the predicted attribute value corresponding to the node to be processed; determine a target nearest neighbor node among multiple nearest neighbor nodes according to a rate-distortion optimization algorithm, and determine a reconstructed value of the target nearest neighbor node as the predicted attribute value corresponding to the node to be processed.

In some embodiments, the first determination unit 21 is further configured to: determine an initial attribute value corresponding to the node to be processed; and determine a prediction residual corresponding to the node to be processed according to the initial attribute value and the predicted attribute value.

In some embodiments, the encoding unit 22 is further configured to: signal the prediction residual into a bitstream.

In some embodiments, the first determination unit 21 is further configured to: traverse points in the node set of the reference frame, and determine a first point with Morton code information greater than or equal to the first Morton code information as the reference point corresponding to the node to be processed; and traverse points in the first set corresponding to the LOD M of the reference frame, and determine a first point with Morton code information greater than or equal to the first Morton code information as the reference point corresponding to the node to be processed.

In some embodiments, the first determination unit 21 is further configured to: determining a search step, and determine the search range according to the second Morton code information and the search step.

In some embodiments, the first determination unit 21 is further configured to: determine the first Morton code information according to geometric coordinates of the node to be processed.

In some embodiments, the first determination unit 21 is further configured to: perform partitioning on nodes in the current frame according to Morton code information of the nodes in the current frame, to determine N LOD levels corresponding to the current frame, where N is an integer greater than or equal to M.

In some embodiments, the first determination unit 21 is further configured to: perform partitioning on nodes in the reference frame according to Morton code information of the nodes in the reference frame, to determine N LOD levels corresponding to the reference frame.

It is to be understood that in the embodiment, a “unit” may be a part of a circuit, a part of a processor, a part of programs or software, etc., it may also be a module, or it may be non-modular. Moreover, the various components in the embodiments of the present disclosure may be integrated in one processing unit, or each unit may exist physically alone, or two or more units may be integrated in one unit. The integrated unit can be implemented either in the form of hardware or in the form of software function module.

If the integrated unit is implemented in the form of software functional modules and sold or used as an independent product, it can be stored in a computer readable storage medium. Based on such understanding, the technical solution of the present disclosure, the technical solution of the embodiment of the present disclosure can be embodied in the form of software products in essence or the part that contributes to the prior art. The computer software product is stored in a storage medium, includes several instructions for making a computer device (which can be a personal computer, a server, a network device, etc.) or a processor to perform all or part of the steps of the method according to each embodiment of the present disclosure. The aforementioned storage media include: a U disk, a removable hard disk, a Read Only Memory (ROM), a Random Access Memory (RAM), a disk or an optical disk and other media that can store program codes.

Therefore, an embodiment of the present disclosure provides a computer-readable storage medium applied to the encoder 20, the computer-readable storage medium having stored therein a computer program that, when executed by a first processor, cause the first processor to implement the method of any of the aforementioned embodiments.

Based on the composition of the encoder 20 and the computer-readable storage medium described above, FIG. 43 is a second schematic diagram of a composition structure of an encoder. As shown in FIG. 43, the encoder 20 may include: a first memory 23 and a first processor 24, a first communication interface 25 and a first bus system 26. The first memory 23 and the first processor 24 and the first communication interface 25 are coupled together via the first bus system 26. It is to be understood that the first bus system 26 is configured to implement connection communication between these components. The first bus system 26 includes a power bus, a control bus and a status signal bus in addition to a data bus. However, for the sake of clarity, the various buses are designated as the first bus system 26.

The first communication interface 25 is configured to receive and send signal in the process of sending and receiving information to and from other external network elements.

The first memory 23 is configured to store a computer program executable on the first processor.

The first processor 24 is configured to: when executing the computer program, for a node to be processed in a LOD M of a current frame, determine a reference point from a prediction point set of a reference frame for the current frame according to first Morton code information corresponding to the node to be processed, where M is an integer greater than 1, and an index of a point in the prediction point set of the reference frame is determined based on Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node.

It may be understood that the first memory 23 in the embodiments of the disclosure may be a volatile memory or a non-volatile memory, or may include a volatile memory and a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), which is used as an external high-speed cache. By way of example but not restrictive description, many forms of RAMs may be used, for example, a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). The first memory 23 of the systems and methods described in this specification includes but is not limited to these and any other proper types of memories.

The first processor 24 of the embodiments of the disclosure may be an integrated circuit chip with signal processing capacity. In an implementation process, various steps of the above method embodiments may be completed by integrated logic circuits of hardware in the first processor 24 or instructions in the form of software. The above first processor 24 may be a general-purpose processor, a Digital Signal Processor (DSP), an Application Specific Integrated Circuit (ASIC), a Field Programmable Gate Array (FPGA), or other programmable logic devices, discrete gate or transistor logic devices, and discrete hardware components. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software modules may be located in a storage medium mature in the art, such as a random access memory, a flash memory, a read-only memory, a programmable read-only memory or electrically erasable programmable memory, or a register. The storage medium is located in the first memory 23, and the first processor 24 reads information in the first memory 23 and completes the steps in the foregoing methods in combination with hardware of the processor.

It will be appreciated that the embodiments described herein may be implemented in hardware, software, firmware, middleware, microcode or a combination thereof. For the hardware implementation, the processing unit may be implemented in one or more Application Specific Integrated Circuits (ASIC), Digital Signal Processors (DSPD), Digital Signal Processing Devices (DSPD), Programmable Logic Devices (PLD), Field-Programmable Gate Arrays (FPGA), general purpose processors, controllers, microcontrollers, microprocessors, other electronic units or combinations thereof for performing the functions described herein. For software implementations, the technology described herein may be implemented by modules (e.g. procedures, functions, etc.) that perform the functions described herein. The software codes may be stored in memory and executed by a processor. The memory can be implemented in the processor or outside the processor.

Optionally, as another embodiment, the first processor 24 is further configured to perform the method described in any one of the aforementioned embodiments when the computer program is executed.

An encoder is provided by the embodiment of the present disclosure, for a node to be processed in a LOD M of a current frame, the codec may determine a reference point from a prediction point set of a reference frame for the current frame according to first Morton code information corresponding to the node to be processed, where M is an integer greater than 1, and an index of a point in the prediction point set of the reference frame is determined based on Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node. As can be seen that, in the embodiments of the present disclosure, the codec needs to determine the reference point from the prediction point set of the reference frame in the process of performing inter prediction on the attribute information, the index of each point in the prediction point set of the reference frame is determined based on the Morton code information of the point, i.e., the index of the point in the prediction point set of the reference frame is the Morton code of the point, so that the corresponding reference point may be found using the Morton code, thereby ensuring that the nearest neighbor node is obtained by using the Morton code in the subsequent nearest-neighbor search process based on the reference point. That is to say, in the embodiments of the present disclosure, it is possible to ensure that the optimal nearest neighbor point can be accurately found by ensuring that the index of each point in the prediction point set of the reference frame is the Morton code of the point, thereby improving the prediction effect for the attribute information and improving the codec efficiency and performance.

FIG. 44 is a first schematic diagram of a composition structure of a decoder. As shown in FIG. 44, the decoder 30 may include: a second determination unit 31 and a decoding unit 32.

In some embodiments, the second determination unit 31 is configured to: for a node to be processed in a M-th LOD level (LOD M) of a current frame, determine a reference point from a prediction point set of a reference frame for the current frame according to first Morton code information corresponding to the node to be processed, where M is an integer greater than 1, and an index of a point in the prediction point set of the reference frame is determined based on Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node.

In some embodiments, the second determination unit 31 is further configured to: determine the reference point from a first set corresponding to a LOD M of the reference frame according to the first Morton code information, where an index of a point in the first set corresponding to the LOD M of the reference frame is determined based on Morton code information of the point; or determine the reference point from a node set of the reference frame according to the first Morton code information, where an index of a point in the node set is determined based on Morton code information of the point.

In some embodiments, the first set corresponding to the LOD M of the reference frame is used to store input points corresponding to the LOD M of the reference frame; a second set corresponding to the LOD M of the reference frame is used to store sampling points corresponding to the LOD M of the reference frame; and a third set corresponding to the LOD M of the reference frame is used to store other points than points in the second set in the LOD M of the reference frame.

In some embodiments, the second determination unit 31 is further configured to: perform partitioning for the LOD M of the reference frame based on the first set corresponding to the LOD M of the reference frame, to determine the second set corresponding to the LOD M of the reference frame and the third set corresponding to the LOD M of the reference frame.

In some embodiments, the second determination unit 31 is further configured to: after the partitioning for the LOD M of the reference frame is performed, update a first set corresponding to a (M+1)-th LOD level (LOD (M+1)) of the reference frame according to the second set corresponding to the LOD M of the reference frame.

In some embodiments, the second determination unit 31 is further configured to: before the partitioning for the LOD M of the reference frame is performed, initialize the third set corresponding to the LOD M of the reference frame according to a third set corresponding to a (M−1)-th LOD level (LOD (M−1)) of the reference frame; and initialize the second set corresponding to the LOD M of the reference frame as an empty set.

In some embodiments, the second determination unit 31 is further configured to: for a node to be processed in a 1^{st} LOD level (LOD 1) of the current frame, determine the reference point from a LOD 1 of the reference frame according to the first Morton code information corresponding to the node to be processed.

In some embodiments, the second determination unit 31 is further configured to: before partitioning for the LOD 1 of the reference frame is performed, initialize a third set corresponding to the LOD 1 of the reference frame as an empty set; and after the partitioning for the LOD 1 of the reference frame is performed, update a first set corresponding to a 2nd LOD level (LOD 2) of the reference frame according to a second set corresponding to the LOD 1 of the reference frame.

In some embodiments, the second determination unit 31 is further configured to: determine a reconstructed value of one nearest neighbor node as the predicted attribute value corresponding to the node to be processed; perform weighted prediction processing on reconstructed values of multiple nearest neighbor nodes to obtain the predicted attribute value corresponding to the node to be processed; determine a target nearest neighbor node among multiple nearest neighbor nodes, and determine a reconstructed value of the target nearest neighbor node as the predicted attribute value corresponding to the node to be processed.

In some embodiments, the decoding unit 32 is further configured to: decode a bitstream to determine a prediction residual corresponding to the node to be processed.

In some embodiments, the second determination unit 31 is further configured to: determine a reconstructed attribute value of the node to be processed according to the prediction residual and the predicted attribute value corresponding to the node to be processed.

In some embodiments, the second determination unit 31 is further configured to: traverse points in a node set of the reference frame, and determine a first point with Morton code information greater than or equal to the first Morton code information as the reference point corresponding to the node to be processed; or traverse points in the first set corresponding to the LOD M of the reference frame, and determine a first point with Morton code information greater than or equal to the first Morton code information as the reference point corresponding to the node to be processed.

In some embodiments, the second determination unit 31 is further configured to: determine a search step, and determine the search range according to the second Morton code information and the search step.

In some embodiments, the second determination unit 31 is further configured to: determine the first Morton code information according to geometric coordinates of the node to be processed.

In some embodiments, the second determination unit 31 is further configured to: perform partitioning on nodes in the current frame according to Morton code information of nodes in the current frame, to determine N LOD levels corresponding to the current frame, where N is an integer greater than or equal to M.

In some embodiments, the second determination unit 31 is further configured to: perform partitioning on nodes in the reference frame according to Morton code information of nodes in the reference frame, to determine N LOD levels corresponding to the reference frame.

It is to be understood that in the embodiment, a “unit” may be a part of a circuit, a part of a processor, a part of programs or software, etc., of course it may also be a module, or it may be non-modular. Moreover, the various components in the embodiments of the present disclosure may be integrated in one processing unit, or each unit may exist physically alone, or two or more units may be integrated in one unit. The integrated unit can be implemented either in the form of hardware or in the form of software function module.

If the integrated unit is implemented in the form of software functional modules and sold or used as an independent product, it can be stored in a computer readable storage medium. Based on such understanding, the technical solution of the present disclosure, the technical solution of the embodiment of the present disclosure can be embodied in the form of software products in essence or the part that contributes to the prior art. The computer software product is stored in a storage medium, includes several instructions for making a computer device (which can be a personal computer, a server, a network device, etc.) or a processor to perform all or part of the steps of the method according to each embodiment of the present disclosure. The aforementioned storage media include: a U disk, a removable hard disk, an ROM, an RAM, a disk or an optical disk and other media that can store program codes.

Therefore, an embodiment of the present disclosure provides a computer-readable storage medium applied to the decoder 30, the computer-readable storage medium having stored therein a computer program that, when executed by a first processor, cause the first processor to implement the method of any of the aforementioned embodiments.

Based on the composition of the decoder 30 and the computer-readable storage medium described above, FIG. 45 is a second schematic diagram of a composition structure of a decoder. As shown in FIG. 45, the decoder 30 may include a second memory 33, a second processor 34, a second communication interface 35, and a second bus system 36. The second memory 33, the second processor 34, and the second communication interface 35 are coupled together by the second bus system 36. It is to be understood that the second bus system 36 is configured to implement connection communication between these components. The second bus system 36 includes a power bus, a control bus and a status signal bus in addition to a data bus. However, for the sake of clarity, the various buses are designated as the second bus system 36.

The second communication interface 35 is configured to receive and send signal in the process of sending and receiving information to and from other external network elements.

The second memory 33 is configured to store a computer program executable on the second processor.

The second processor is configured to, when running the computer program: for a node to be processed in a LOD M of a current frame, determine a reference point from a prediction point set of a reference frame for the current frame according to first Morton code information corresponding to the node to be processed, where M is an integer greater than 1, and an index of a point in the prediction point set of the reference frame is determined based on Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node.

It may be understood that the second memory 33 in the embodiments of the disclosure may be a volatile memory or a non-volatile memory, or may include a volatile memory and a non-volatile memory. The non-volatile memory may be a RO, a PROM, an EPROM, an EEPROM, or a flash memory. The volatile memory may be an RAM, which is used as an external high-speed cache. By way of example but not restrictive description, many forms of RAMs may be used, for example, an SRAM, a DRAM, an SDRAM, a DDR SDRAM, an ESDRAM, an SLDRAM, and a DR RAM. The second memory 33 of the systems and methods described in this specification includes but is not limited to these and any other proper types of memories.

The second processor 34 of the embodiments of the disclosure may be an integrated circuit chip with signal processing capacity. In an implementation process, various steps of the above method embodiments may be completed by integrated logic circuits of hardware in the second processor 34 or instructions in the form of software. The above second processor 34 may be a general-purpose processor, a DSP, an ASIC, a FPGA, or other programmable logic devices, discrete gate or transistor logic devices, and discrete hardware components. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software modules may be located in a storage medium mature in the art, such as a random access memory, a flash memory, a read-only memory, a programmable read-only memory or electrically erasable programmable memory, or a register. The storage medium is located in the second memory 33, and the second processor 34 reads information in the second memory 33 and completes the steps in the foregoing methods in combination with hardware of the processor.

It will be appreciated that the embodiments described herein may be implemented in hardware, software, firmware, middleware, microcode or a combination thereof. For the hardware implementation, the processing unit may be implemented in one or more ASICs, DSPDs, DSPDs, PLDs, FPGAs, general purpose processors, controllers, microcontrollers, microprocessors, other electronic units or combinations thereof for performing the functions described herein. For software implementations, the technology described herein may be implemented by modules (e.g, procedures, functions, etc.) that perform the functions described herein. The software codes may be stored in memory and executed by a processor. The memory can be implemented in the processor or outside the processor.

A decoder is provided by an embodiment of the present disclosure, for a node to be processed in a LOD M of a current frame, the codec may determine a reference point from a prediction point set of a reference frame for the current frame according to first Morton code information corresponding to the node to be processed, where M is an integer greater than 1, and an index of a point in the prediction point set of the reference frame is determined based on Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node. As can be seen that, in the embodiments of the present disclosure, the codec needs to determine the reference point from the prediction point set of the reference frame in the process of performing inter prediction on the attribute information, the index of each point in the prediction point set of the reference frame is determined based on the Morton code information of the point, i.e., the index of the point in the prediction point set of the reference frame is the Morton code of the point, so that the corresponding reference point may be found using the Morton code, thereby ensuring that the nearest neighbor node is obtained by using the Morton code in the subsequent nearest-neighbor search process based on the reference point. That is to say, in the embodiments of the present disclosure, it is possible to ensure that the optimal nearest neighbor point can be accurately found by ensuring that the index of each point in the prediction point set of the reference frame is the Morton code of the point, thereby improving the prediction effect for the attribute information and improving the codec efficiency and performance.

In another embodiment of the present disclosure, an embodiment of the present disclosure provides a bitstream. The bitstream is generated by bit encoding according to information to be encoded, and the information to be encoded at least includes a prediction residual.

It is to be noted that, in this disclosure, the terms “include”, “contain” or any other variation thereof, are intended to cover a non-exclusive inclusion, such that a process, method, article, or device that includes a list of elements includes not only those elements but also other elements not expressly listed, or also includes elements inherent to such process, method, article, or device. Without more limitations, an element is defined by the statement “including a . . . ” that does not rule out there are additional identical elements in a process, method, article, or apparatus that includes the element.

The aforementioned serial numbers of embodiments of the present disclosure are for the purpose of description only and do not represent the advantages or disadvantages of the embodiments.

The methods disclosed in several method embodiments provided in the present disclosure can be arbitrarily combined without conflict to obtain new method embodiments.

The features disclosed in several product embodiments provided in the present disclosure can be arbitrarily combined without conflict to obtain new product embodiments.

The features disclosed in several methods or device embodiments provided in the present disclosure can be arbitrarily combined without conflict to obtain new method embodiments or device embodiments.

The above descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure is defined by the scope of protection of the claims.

### INDUSTRIAL APPLICABILITY

The embodiments of the present disclosure provide the encoding and decoding methods, the encoder, the decoder, the bitstream and the storage medium. For a node to be processed in a LOD M of a current frame, the encoder and the decoder may determine the reference point from a prediction point set of a reference frame for the current frame according to first Morton code information corresponding to the node to be processed, where M is the integer greater than 1, and the index of the point in the prediction point set of the reference frame is determined based on the Morton code information of the point; determine a search range based on second Morton code information corresponding to the reference point, and determine a nearest neighbor node corresponding to the node to be processed according to the search range; and determine a predicted attribute value corresponding to the node to be processed based on a reconstructed value of the nearest neighbor node. As can be seen that, in the embodiments of the present disclosure, each of the encoder and the decoder needs to determine the reference point from the prediction point set of the reference frame in the process of performing inter prediction on the attribute information, the index of each point in the prediction point set of the reference frame is determined based on the Morton code information of the point, i.e., the index of the point in the prediction point set of the reference frame is the Morton code of the point, so that the corresponding reference point may be found using the Morton code, thereby ensuring that the nearest neighbor node is obtained by using the Morton code in the subsequent nearest-neighbor search process based on the reference point. That is to say, in the embodiments of the present disclosure, it is possible to ensure that the optimal nearest neighbor point can be accurately found by ensuring that the index of each point in the prediction point set of the reference frame is the Morton code of the point, thereby improving the prediction effect for the attribute information and improving the codec efficiency and performance.

1. A decoding method, applied to a decoder, the method comprising:
for a node to be processed in an M-th Level of Detail (LOD) level (LOD M) of a current frame, determining a reference point from a prediction point set of a reference frame for the current frame according to first Morton code information corresponding to the node to be processed, where M is an integer greater than 1, and an index of a point in the prediction point set of the reference frame is determined based on Morton code information of the point;
determining a search range based on second Morton code information corresponding to the reference point, and determining, according to the search range, a nearest neighbor node corresponding to the node to be processed; and
determining a predicted attribute value corresponding to the node to be processed based on a reconstructed value of the nearest neighbor node.

2. The method of claim 1, wherein determining the reference point from the prediction point set of the reference frame for the current frame according to the first Morton code information corresponding to the node to be processed comprises:
determining the reference point from a first set corresponding to a LOD M of the reference frame according to the first Morton code information, wherein an index of a point in the first set corresponding to the LOD M of the reference frame is determined based on Morton code information of the point;
or,
determining the reference point from a node set of the reference frame according to the first Morton code information, wherein an index of a point in the node set is determined based on Morton code information of the point.

3. The method of claim 2, further comprising:
for a node to be processed in a 1st LOD level (LOD 1) of the current frame, determining the reference point from a LOD 1 of the reference frame according to the first Morton code information corresponding to the node to be processed.

4. The method of claim 1, wherein determining the predicted attribute value corresponding to the node to be processed based on the reconstructed value of the nearest neighbor node comprises:
determining a reconstructed value of one nearest neighbor node as the predicted attribute value corresponding to the node to be processed;
or,
performing weighted prediction processing on reconstructed values of a plurality of nearest neighbor nodes to obtain the predicted attribute value corresponding to the node to be processed;
or,
determining a target nearest neighbor node among a plurality of nearest neighbor nodes, and determining a reconstructed value of the target nearest neighbor node as the predicted attribute value corresponding to the node to be processed.

5. The method of claim 4, further comprising:
decoding a bitstream and determining a prediction residual corresponding to the node to be processed; and
determining a reconstructed attribute value of the node to be processed according to the prediction residual and the predicted attribute value corresponding to the node to be processed.

6. The method of claim 2, wherein determining the reference point from the prediction point set of the reference frame of the current frame according to the first Morton code information corresponding to the node to be processed comprises:
traversing points in the node set of the reference frame, and determining a first point with Morton code information greater than or equal to the first Morton code information as the reference point corresponding to the node to be processed;
or,
traversing points in the first set corresponding to the LOD M of the reference frame, and determining a first point with Morton code information greater than or equal to the first Morton code information as the reference point corresponding to the node to be processed.

7. The method of claim 2, wherein determining the search range based on the second Morton code information corresponding to the reference point comprises:
determining a search step; and
determining the search range according to the second Morton code information and the search step.

8. The method of claim 2, further comprising
determining the first Morton code information according to geometric coordinates of the node to be processed.

9. The method of claim 2, further comprising:
performing partitioning on nodes in the current frame according to Morton code information of the nodes in the current frame, to determine N LOD levels corresponding to the current frame, where N is an integer greater than or equal to M.

10. An encoding method, applied to an encoder, the method comprising:
for a node to be processed in an M-th Level of Detail (LOD) level (LOD M) of a current frame, determining a reference point from a prediction set of a reference frame for the current frame according to first Morton code information corresponding to the node to be processed, where M is an integer greater than 1, and an index of a point in the prediction point set of the reference frame is determined based on Morton code information of the point;
determining a search range based on second Morton code information corresponding to the reference point, and determining, according to the search range, a nearest neighbor node corresponding to the node to be processed; and
determining a predicted attribute value corresponding to the node to be processed based on a reconstructed value of the nearest neighbor node.

11. The method of claim 10, wherein determining the reference point from the prediction point set of the reference frame for the current frame according to the first Morton code information corresponding to the node to be processed comprises:
determining the reference point from a first set corresponding to a LOD M of the reference frame according to the first Morton code information, wherein an index of a point in the first set corresponding to the LOD M of the reference frame is determined based on Morton code information of the point;
or,
determining the reference point from a node set of the reference frame according to the first Morton code information, wherein an index of a point in the node set is determined based on Morton code information of the point.

12. The method of claim 11, further comprising:
for a node to be processed in a 1st LOD level (LOD 1) of the current frame, determining the reference point from a LOD 1 of the reference frame according to the first Morton code information corresponding to the node to be processed.

13. The method of claim 10, wherein determining the predicted attribute value corresponding to the node to be processed based on the reconstructed value of the nearest neighbor node comprises:
determining a reconstructed value of one nearest neighbor node as the predicted attribute value corresponding to the node to be processed;
or,
performing weighted prediction processing on reconstructed values of a plurality of nearest neighbor nodes to obtain the predicted attribute value corresponding to the node to be processed;
or,
determining a target nearest neighbor node among a plurality of nearest neighbor nodes according to a rate-distortion optimization algorithm, and determining a reconstructed value of the target nearest neighbor node as the predicted attribute value corresponding to the node to be processed.

14. The method of claim 13, further comprising:
determining an initial attribute value corresponding to the node to be processed; and
determining a prediction residual corresponding to the node to be processed according to the initial attribute value and the predicted attribute value, and signalling the prediction residual into a bitstream.

15. The method of claim 11, wherein determining the reference point from the prediction point set of the reference frame for the current frame according to the first Morton code information corresponding to the node to be processed comprises:
traversing points in the node set of the reference frame, and determining a first point with Morton code information greater than or equal to the first Morton code information as the reference point corresponding to the node to be processed;
or,
traversing points in the first set corresponding to the LOD M of the reference frame, and determining a first point with Morton code information greater than or equal to the first Morton code information as the reference point corresponding to the node to be processed.

16. The method of claim 11, wherein determining the search range based on the second Morton code information corresponding to the reference point comprises:
determining a search step; and
determining the search range according to the second Morton code information and the search step.

17. The method of claim 11, further comprising:
determining the first Morton code information according to geometric coordinates of the node to be processed.

18. The method of claim 11, further comprising:
performing partitioning on nodes in the current frame according to Morton code information of the nodes in the current frame, to determine N LOD levels corresponding to the current frame, where N is an integer greater than or equal to M.

19. A bitstream, wherein the bitstream is generated through bit encoding according to information to be encoded, and the information to be encoded at least comprises a prediction residual.

20. A non-transitory computer-readable storage medium, having a computer program and a bitstream stored thereon, wherein the computer program, when executed by a processor, enables the processor to perform the steps of the encoding method of claim 10 to generate the bitstream.
